(19) United States
(12) Patent Application Publication
(10) Pub. No.: US 2007/0282759 A1
(43) Pub. Date: Dec. 6, 2007

(54) Method of reporting and analyzing financial and investment data and information

(76) Inventors: Scott Devries, Ottawa (CA); Mark Harold Sherboneau, Ottawa (CA)

Correspondence Address: SCHMEISER, OLSEN & WATTS, 22 CENTURY HILL DRIVE, SUITE 302, LATHAM, NY, 12110, US

(21) Appl. No.: 11/442,183

(22) Filed: May 26, 2006

(51) Int. Cl. G06Q 40/00

(52) U.S. Cl. 705/36 R

(57) ABSTRACT

The present invention relates to analyzing and reporting of data and information, and particularly to analyzing and reporting of financial and investment data and information. More specifically, the present invention provides a method for the reporting of financial data comprising the steps of receiving first data from a first data source which contains data relating to a least one investment, receiving second data from a second data source which contains data relating to at least one client transaction relating to the at least one investment, calculating at least one element of financial data utilizing first data and second data, and reporting the calculated financial data. In this manner, investors, and their advisers, can be provided with timely information and analysis in relation to the investor's overall investment position and portfolio statistics.

### FIELD OF THE INVENTION

The present invention relates to analyzing and reporting of data and information, and particularly to analyzing and reporting of financial and investment data and information.

### BACKGROUND OF THE INVENTION

During the past 30 years, financial investments through, for example mutual funds, have grown in popularity, as a means of permitting individuals (referred to herein as “investor” or “investors” or “client” or “clients”) to easily diversify their investment portfolio. For example, a single mutual fund may contain a broad range of a variety of stocks, bonds, treasury bills, currencies or other investments or instruments (or any combination of these). In this example, the mutual fund issuer (often a bank or large financial institution, and referred to herein as an “issuer”) may make available for purchase by the public, “units” of the mutual fund, each “unit” of the mutual fund representing a small percentage of that mutual fund, and the individual investor, by purchasing even a single “unit” in that mutual fund, can effectively invest in those various stocks, bonds, treasury bills, currencies or other investments or instruments to thereby diversify his or her portfolio.

Furthermore, segregated funds and other similar investment vehicles have been created in which the investment vehicle includes a conglomerate of other investments.

Typically, price, type, performance, relative risk, price to earning ratios, and other historic data relating to mutual funds, segregated funds and other similar investment vehicles (all of these investment vehicles are hereinafter collectively referred to as “investments”) are calculated and available from the issuer or from other publicly available sources, including, for example, FUNDATA, MORNINGSTAR, BELL GLOBE, and other sources known to a person skilled in the art. However, as some investors will invest in a variety of different investment vehicles, it is desirable to have additional information relating to the overall investment position of an investor across their entire portfolio, not merely in respect of a particular investment.

There is a need for a financial analysis and reporting tool which provides investors, and their advisers, with timely information and analysis in relation to the investor's overall investment position and portfolio statistics, including, for example, overall portfolio analyses (number of units of each investment vehicle, pricing information, book value, market value, rate of return, the portfolio's performance, correlation amongst funds, total holdings of particular stocks within the combined investment vehicles held by the investor, the percentage of the investor's investments in various foreign jurisdictions, (“geographical allocation”), sector allocation, fund correlations, security allocation (overall relative weighting of common stock, cash equivalents, mortgages etc.) risk versus return, equity style (value blend or growth, large medium or small capitalization), fixed income style (credit quality and duration), applicability of foreign content entitlement, and overall portfolio growth, amongst other things.

### SUMMARY OF THE INVENTION

The object of the present invention is to provide an improved financial analysis and reporting tool which provides investors, and their advisers, with timely information and analysis in relation to the investor's overall investment position and portfolio statistics.

It is a still further object of the present invention to provide an improved financial analysis and reporting tool which provides investors, and their advisers, with timely information and analysis in relation to the investor's overall investment position and portfolio statistics, including, for example, overall portfolio analyses (number of units of each investment vehicle, pricing information, book value, market value, rate of return, the portfolio's performance, correlation amongst funds, total holdings of particular stocks within the combined investment vehicles held by the investor, the percentage of the investor's investments in various foreign jurisdictions, (“geographical allocation”), sector allocation, fund correlations, security allocation (overall relative weighting of common stock, cash equivalents, mortgages etc.) risk versus return, equity style (value blend or growth, large medium or small capitalization), fixed income style (credit quality and duration), applicability of foreign content entitlement, and overall portfolio growth, amongst other things.

According to one aspect of the present invention, there is provided a method for the reporting of financial data comprising the steps of (a) receiving first data from a first data source which contains data relating to a least one investment; (b) receiving second data from a second data source which contains data relating to at least one client transaction relating to the at least one investment; (c) calculating at least one element of financial data utilizing first data and second data; and (d) reporting the calculated financial data.

The advantage of the present invention is that it provides an improved financial analysis and reporting tool which provides investors, and their advisers, with timely information and analysis in relation to the investor's overall investment position and portfolio statistics.

A further advantage of the present invention is that it provides an improved financial analysis and reporting tool which provides investors, and their advisers, with timely information and analysis in relation to the investor's overall investment position and portfolio statistics, including, for example, overall portfolio analyses (number of units of each investment vehicle, pricing information, book value, market value, rate of return, the portfolio's performance, correlation amongst funds, total holdings of particular stocks within the combined investment vehicles held by the investor, the percentage of the investor's investments in various foreign jurisdictions, (“geographical allocation”), sector allocation, fund correlations, security allocation (overall relative weighting of common stock, cash equivalents, mortgages etc.) risk versus return, equity style (value blend or growth, large medium or small capitalization), fixed income style (credit quality and duration), applicability of foreign content entitlement, and overall portfolio growth, amongst other things.

### BRIEF DESCRIPTION OF THE DRAWINGS

A preferred embodiment of the present invention is described below with reference to the accompanying drawings, in which:

FIG. 1 is a screen shot of the USER LOGIN screen of one embodiment of the present invention;

FIG. 1A is a screen shot of a LOGIN ERROR message screen of one embodiment of the present invention;

FIG. 2 is a screen shot of the ADVISOR PORTFOLIO screen of one embodiment of the present invention;

FIG. 2A is a file of data in XML format providing certain personal information in relation to clients;

FIG. 3 is a screen shot of one embodiment of the ACCOUNT SUMMARY screen of one embodiment of the present invention;

FIG. 3A is a file of data in XML format providing certain detailed information in relation to a specified investor's current and previous investments;

FIG. 4 is a screen shot of the DETAILED ACCOUNT SUMMARY screen of one embodiment of the present invention;

FIG. 4A is a screen shot of the DETAILED ACCOUNT SUMMARY screen and the opened TRANSACTION HISTORY window of one embodiment of the present invention;

FIGS. 4A1, 4A2 and 4A3 are screen shots of investment information displayed in one embodiment of the present invention;

FIG. 4B is a file of data in XML format relating to a particular investor's transaction history;

FIG. 5 is a screen shot of the PORTFOLIO GROWTH screen of one embodiment of the present invention;

FIG. 5A is an alternative screen shot of the PORTFOLIO GROWTH screen of one embodiment of the present invention;

FIG. 6 is a screen shot which illustrates the STATISTICS “drop-down” menu;

FIG. 6A is a screen shot of the PORTFOLIO PERFORMANCE screen of one embodiment of the present invention;

FIG. 6A1 is a screen shot of the PORTFOLIO PERFORMANCE screen of one embodiment of the present invention illustrating the detailed information window;

FIG. 6A2 is a screen shot of the PORTFOLIO PERFORMANCE screen of one embodiment of the present invention illustrating the investments within a particular time-frame;

FIG. 6B is a screen shot of the FUND CORRELATION screen of one embodiment of the present invention;

FIG. 6B1 is a screen shot of the FUND CORRELATION screen of one embodiment of the present invention illustrating a details window;

FIG. 6B2 are selected excerpts of a file of data in XML format providing certain correlation data;

FIG. 6C is a screen shot of the RISK VERSUS RETURN screen of one embodiment of the present invention;

FIG. 6C1 is a screen shot of the RISK VERSUS RETURN screen of one embodiment of the present invention illustrating a details window;

FIG. 6D is a screen shot of the TOP HOLDINGS screen of one embodiment of the present invention;

FIG. 6D1 is a screen shot of the TOP HOLDINGS screen of one embodiment of the present invention illustrating the expansion of one of the top holdings;

FIG. 7 is a screen shot of the GEOGRAPHY screen of one embodiment of the present invention;

FIG. 7A is a screen shot of the GEOGRAPHY screen of one embodiment of the present invention with a detail information window;

FIG. 8 is a screen shot of the SECTOR ALLOCATION screen of one embodiment of the present invention;

FIG. 8A is a screen shot of the SECTOR ALLOCATION screen of one embodiment of the present invention with a detail window;

FIG. 9 is a screen shot displaying the drop-down menu associated with the Allocation button;

FIG. 9A is a screen shot of the SECURITY ALLOCATION screen of one embodiment of the present invention;

FIG. 9B is a screen shot of the SECURITY ALLOCATION screen of one embodiment of the present invention with a detail window;

FIG. 9C is a screen shot of the EQUITY STYLE screen of one embodiment of the present invention;

FIG. 9C1 is a screen shot of the EQUITY STYLE screen of one embodiment of the present invention with a definition window;

FIG. 9D is a screen shot of the FIXED INCOME STYLE screen of one embodiment of the present invention;

FIG. 9D1 is a screen shot of the FIXED INCOME STYLE screen of one embodiment of the present invention with a definition window open;

FIG. 9E is a screen shot of the FUND ALLOCATION screen of one embodiment of the present invention;

FIG. 9F is a screen shot of the FUND ALLOCATION screen of one embodiment of the present invention with a detail information window open; and

FIG. 10 is a file of data in XML format providing certain personal information in relation to the history of each of the investments.

### DESCRIPTION OF THE PREFERRED EMBODIMENT

### Availability of Mutual Fund and Investor Data

In the preferred embodiment, data relating to mutual funds or other investment vehicles (hereinafter referred to as an “investment”) is stored in a database, table or other data structure, which contains, amongst other things, data in relation to the investment, such as, for example, the investment's: name, symbol, fund type, voting, minimum investment, asset value, performance data, volatility, valuation frequency, alpha data, beta data, sharpe data, objective, strategy, fund manager details, price, price change, current geographic allocation information, current security allocation, the top 10 securities within the investment, and historical performance information. This data may be created and stored locally, or remotely, and it may be, for example, created and stored by an organization for its own internal use, or made available to other organizations. In one embodiment, one organization, such as FUNDATA, MORNINGSTAR, BELL GLOBE, and other sources known to a person skilled in the art which collect, organize and store this data, and make it available to others, by means of, for example, a computer network, or the Internet, it being understood that there are wide variety of methods for collecting, maintaining and distributing this data/information which are known to a person skilled in the art. For the purposes of the description of the invention provided herein, this database, table or other data structure will be referred to as the General Investment Database.

Additionally, in the preferred embodiment, a database, table or other data structure is created and maintained, containing data/information in relation to investors, such as the investor's name, title, gender, marital status, date of birth, citizenship, address, telephone number, fax number, along with information identifying their current investments, along with transaction data in relation thereto, which data may be collected, organized and stored for internal use, or made available to other organizations. In one embodiment, one organization such as WEALTHSERV REPVISOR, UNIVERIS and WINFUND and RPM POWERREP, and other third party organizations known to persons skilled in the art will collect, organize and store this data, and make it available to others, by means of, for example, a computer network, or the Internet, it being understood that there are a wide variety of methods for collecting, maintaining and distributing this data/information which are known to persons skilled in the art. For the purposes of the description of the invention provided herein, this database, table or other data structure will be referred to as the Client Investment Database.

### The Reporting Application

In the preferred embodiment, a software application (hereinafter “the Application”) is installed on a computer or other digital processor (both of which are hereinafter referred to as “computer” or “computers”). In the preferred embodiment, the Macromedia Flash™ playback software is installed on the user's computer, and the Application opens or initializes the Macromedia Flash playback software and the Application is thereafter run upon or utilizing the Macromedia Flash playback software to present to the user (in the present description of the invention, the user includes any individual who may access the Application, including, for example, investment advisers, individuals who advise clients on their investment selection, and clients) of the installed Application with a set of screens and a graphical user interface as more specifically described herein, it being understood that a wide variety of different software products may be utilized to implement the present invention.

In the preferred embodiment, the Application of the present invention may be accessible by means of the Internet or other suitable network and when installed on a computer, presents to the user, by way of a computer, with a set of data/information screens and a graphical user interface which provides, amongst other things, navigational and information/data display tools, the data screens and a graphical user interface being displayed by the Application, by way of the computer or other processor's video display device (for example, a CRT screen, LCD screen or other similar device). It is understood that in an alternative embodiment, the Application may be installed directly onto a computer or other processor.

### Setting Up the Application

In the preferred embodiment, in respect of each user entitled to access the installed Application, the installed Application receives and stores a combined Dealer and Representative Code (which code is formed by combining a Dealer Code and a Representative Code) and the name of the Advisor or User authorized to access the Application, and information in relation to the current access status of the user and the dealer and representative (for example, information relating to whether or not the user or dealer or representative is currently entitled to access the Application). This information may be stored by the installed Application, in a table, database, or other suitable data structure, known to a person skilled in the art. In an alternative embodiment, a password is also received and stored in the table, database or other suitable data structure by the installed Application.

### Accessing the Application

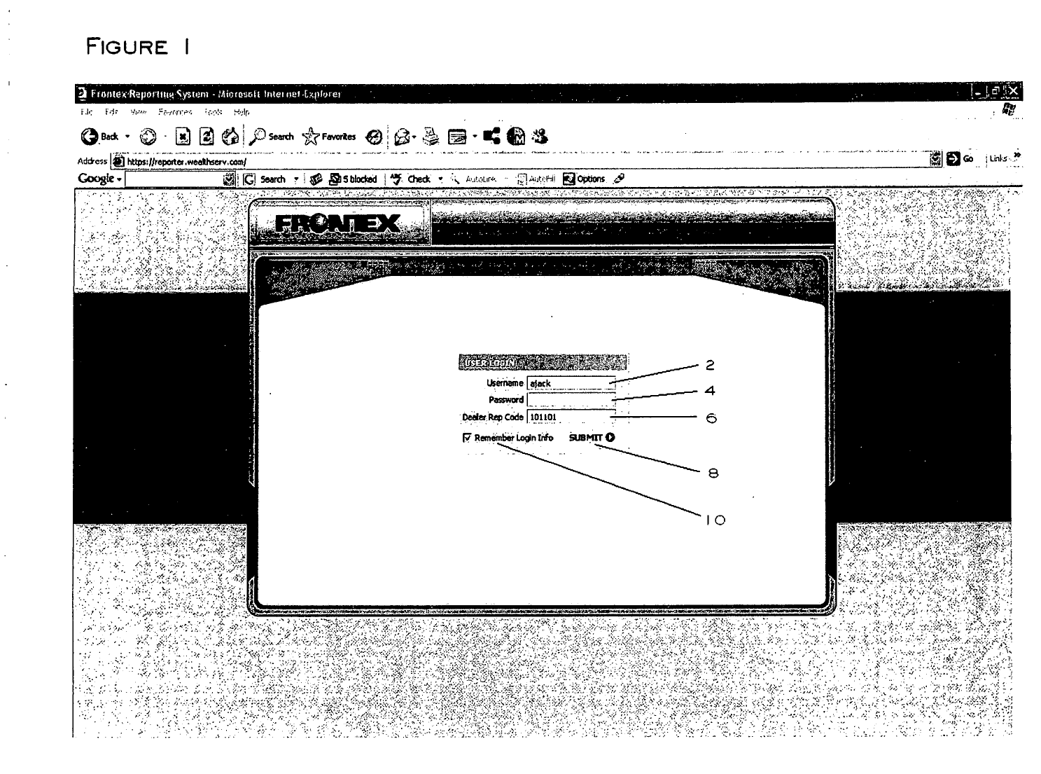

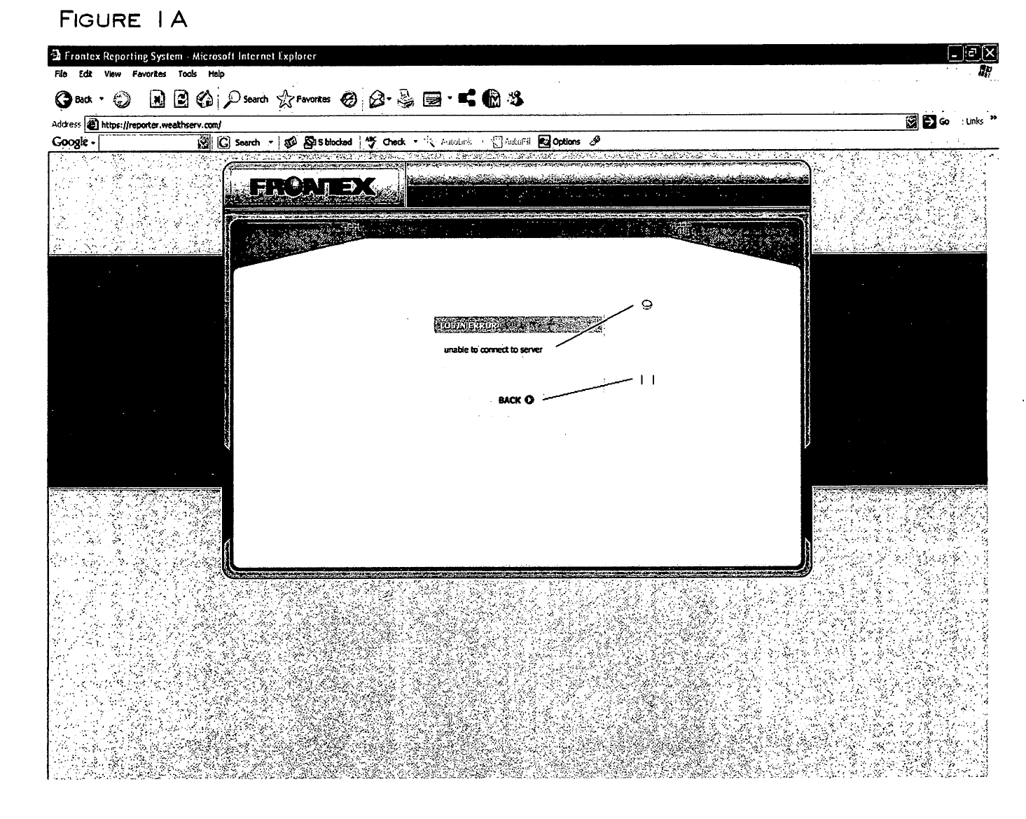

Referring to FIG. 1, in the preferred embodiment, after installing and loading the Application, the user is provided with an opportunity to gain access to the installed Application through a “User Login” process, the user providing a username in the username box 2, a password in the password box 4 and a dealer representative code in the dealer representative code box 6 by means of a User Login interface such as the one illustrated in FIG. 1, it being understood that a variety of different login protocols may be utilized which are known to persons skilled in the art.

In the preferred embodiment, upon the user selecting and activating the “SUBMIT” button 8, the Dealer Representative Code 6 is verified by the installed Application to confirm that the dealer code and the representative code 6 and username are valid, and that the dealer and representative and user rare currently entitled to access the installed Application. If the dealer and representative and username codes are valid and the dealer and representative and user are currently entitled to access the installed Application, the installed Application sends the username and password, and other identifying indicia to, in the case of the preferred embodiment, the third party organization providing access to the Client Investment Database, which third party organization either verifies the username and password, in which case, limited access is provided to the Client Investment Database (the access being limited to data specifically relevant to the user), or in the event that the third party organization fails to verify the username and password, the user is denied access to the Client Investment Database, and the third party organization provides a signal to the installed Application that access is being denied, whereupon the Application presents the prospective user with a “LOGIN ERROR” message 9 such as the one illustrated in FIG. 1A and, upon the user selecting and activating the “BACK” button 11, is redirected back, in a manner known to a person skilled in the art, to the previously referred to USER LOGIN interface of FIG. 1, and given the opportunity to re-enter a username and password, but is otherwise denied further access to the Application. In a preferred embodiment, the user may select the “Remember Login Info” checkbox 10, whereupon the Application will store data relating to the specific computer then being utilized by the user, and whenever that computer is subsequently utilized to access the Application, the username and dealer representative code will automatically be supplied by the Application from a database of stored within the Application.

### Advisor Portfolio

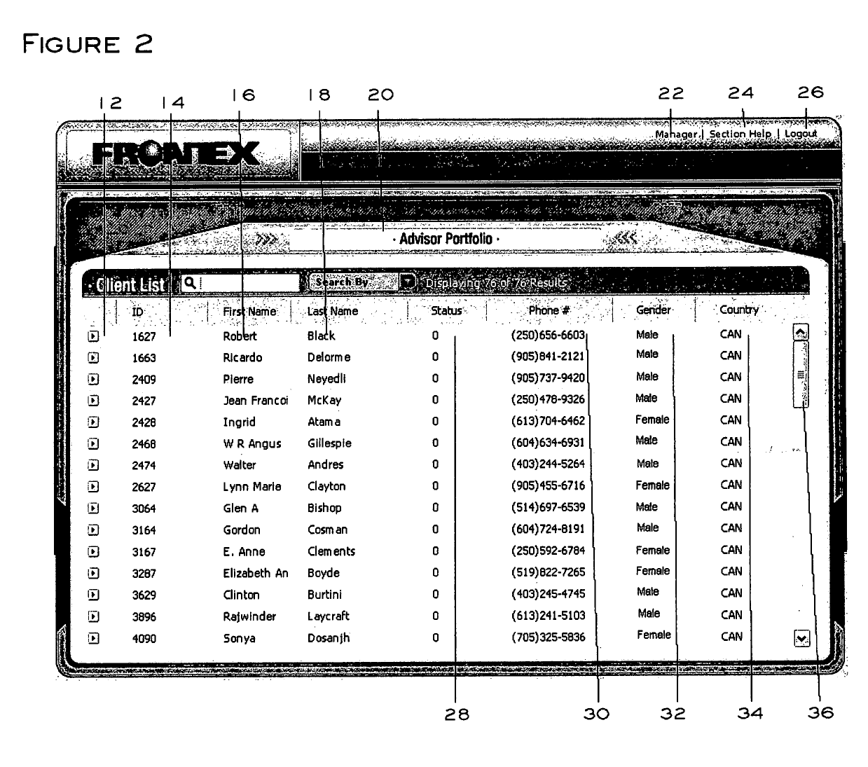

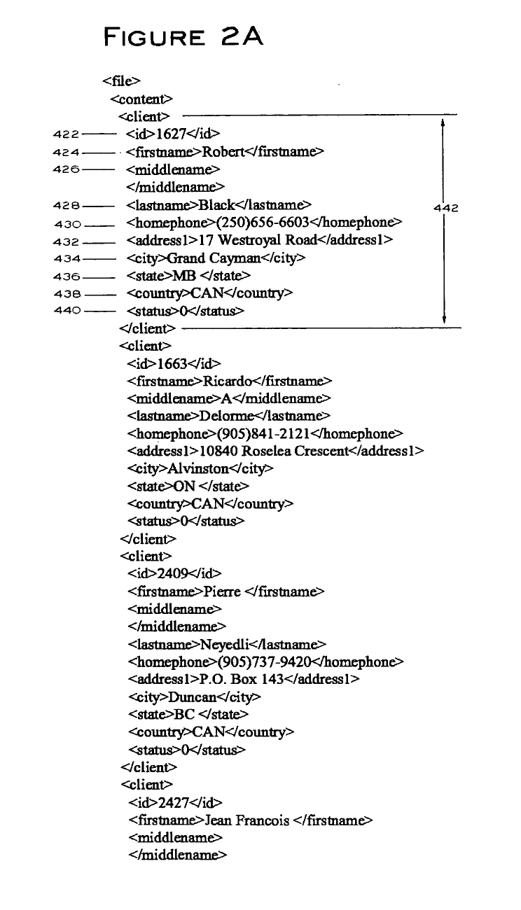

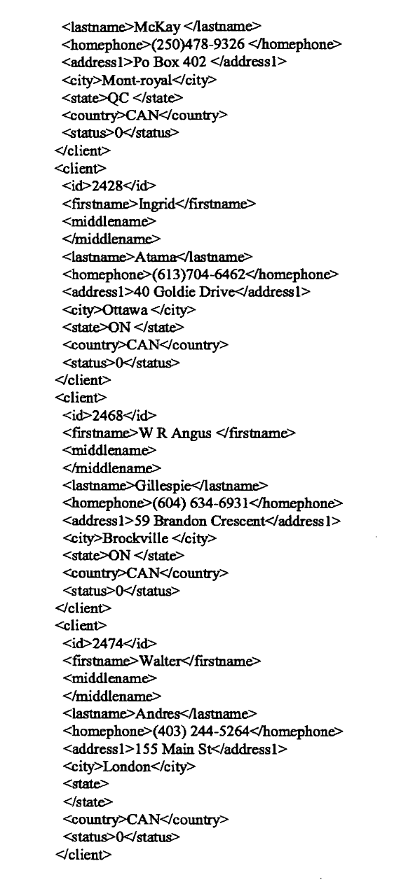

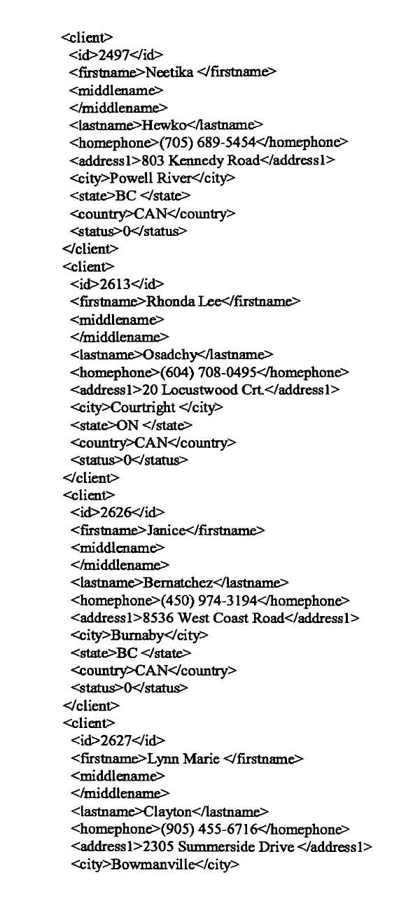

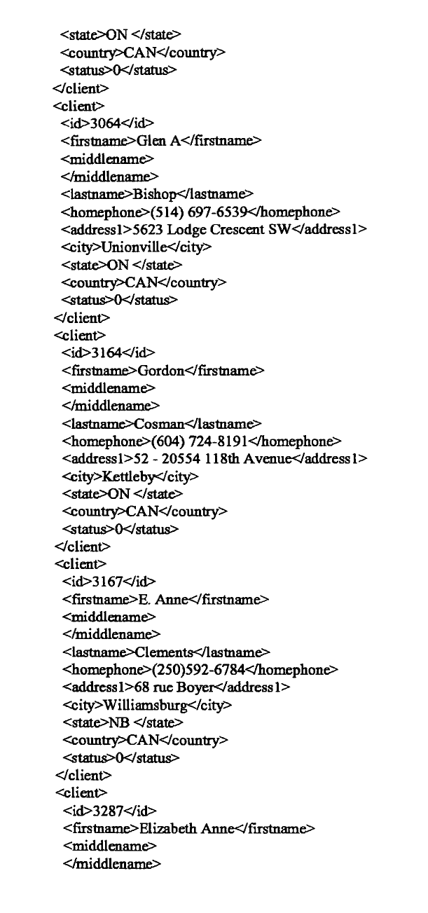

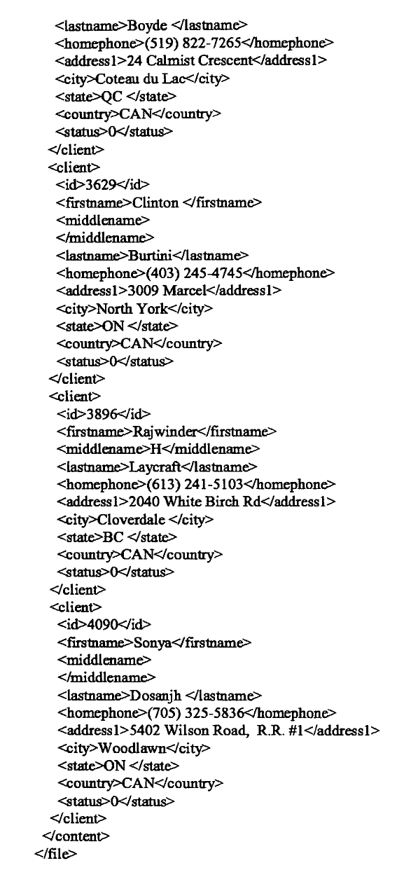

Upon successfully logging into the Application, in the preferred embodiment, the user is presented with an “Adviser Portfolio” screen such as illustrated in FIG. 2. In the Adviser Portfolio screen, the user is presented with a screen-name window 20 identifying the name of the screen, and with navigation buttons including, for example, general navigation buttons, such as, “Manager” 22, “Section Help” 24, and “Logout” 26, which navigation buttons are generally available throughout the Application, to assist the user in the case of the Manager button 22, by directing the user and Application back to the “Adviser Portfolio” screen in a manner known to a person skilled in the art, in the case of the Section Help 24 button, by directing the user and Application to the a series of one or more context-sensitive help screens which are displayed and made available to the user in a manner known to a person skilled in the art, and in the case of the Logout button 26, by directing the user and Application to the User Login interface such as the one illustrated in FIG. 1 in a manner known to a person skilled in the art.

Additionally, the Advisor Portfolio screen of FIG. 2 presents a table of data which may be scrolled in a manner known to a person skilled in the art, or by means of the scroll button or arrows 36 provided, the table providing specific data/information regarding clients of the user, on a client by client basis, each client's data being the subject of a row in the table, including the client's ID number 14, first name 16, last name 18, status 28 (for use in tracking, for example, whether or not the client currently has active business with the user/adviser), telephone number 30, and country of residency 34 (where the user is not an adviser, but rather an investor, the user will not be directed by the installed Application to the Adviser Portfolio screen, but rather will be directed to the Account Summary Screen referred to hereinafter). In the preferred embodiment, the data/information presented in the Advisor Portfolio screen is obtained by the Application in the following manner:
1. the Application forwards a query to the now accessible Client Information Database (or forwards, by means of the Internet or other network connection, to another computer on which such a database is stored), to locate and provide to the installed Application certain information in relation to the clients of the logged-in user (as identified by the user during the above-referenced Login procedure) including, in a preferred embodiment, the following information:
   a. Client identification number
   b. Client first name
   c. Client middle name
   d. Client last name
   e. Client home phone number
   f. Client address
   g. Client city
   h. Client state/province
   i. Client country
   j. Client status
2. the above-referenced data/information for each of the user's clients is forwarded to and made available to the installed Application in the form of, in the preferred embodiment, an XML data file such as the one illustrated in FIG. 2A, the data file providing a table, each client's data being provided in a row in the table, and the following details being provided in the table's columns, namely:
   a. client identification number 422
   b. client first name 424
   c. client middle name 426
   d. client last name 428
   e. client home phone number 430
   f. client address 432
   g. client city 434
   h. client state or province 436
   i. client country 438 and
   j. client status 440,
3. in a manner known to a person skilled in the art, the data from this XML data file of FIG. 2A, is parsed and presented to the user in the advisor portfolio table illustrated FIG. 2.

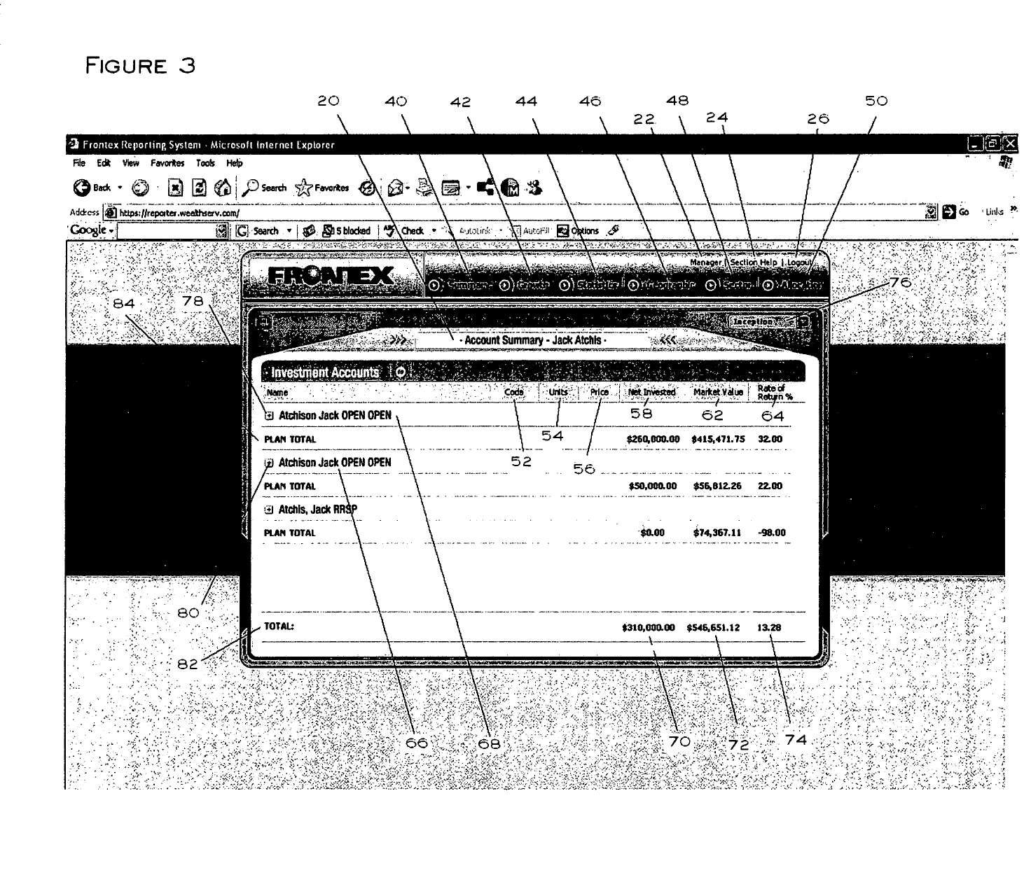

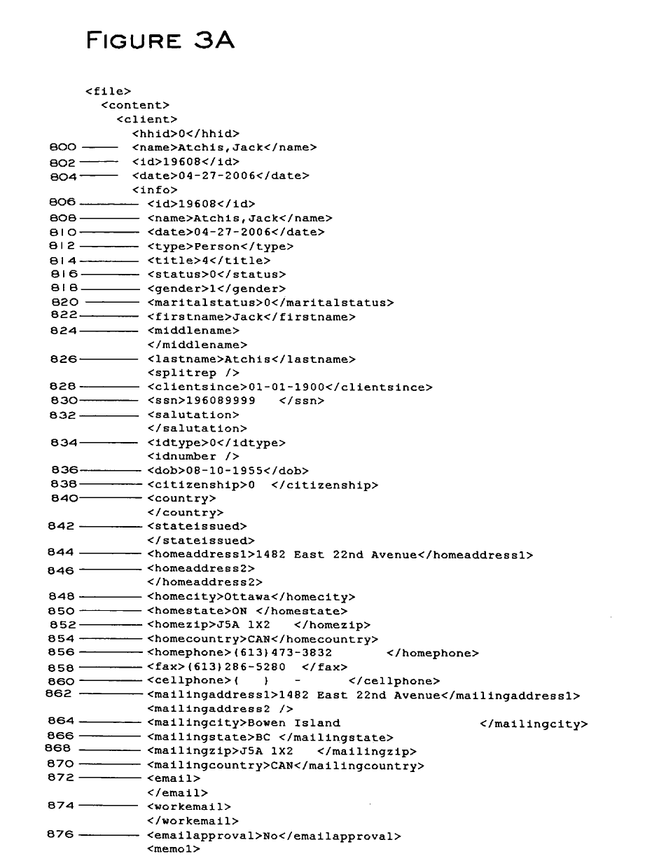

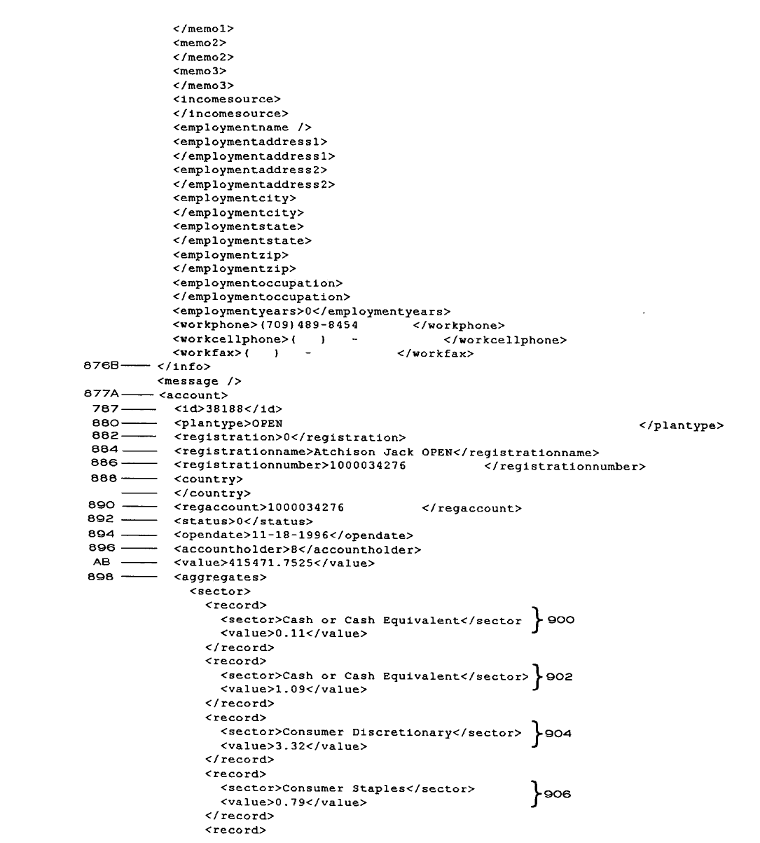

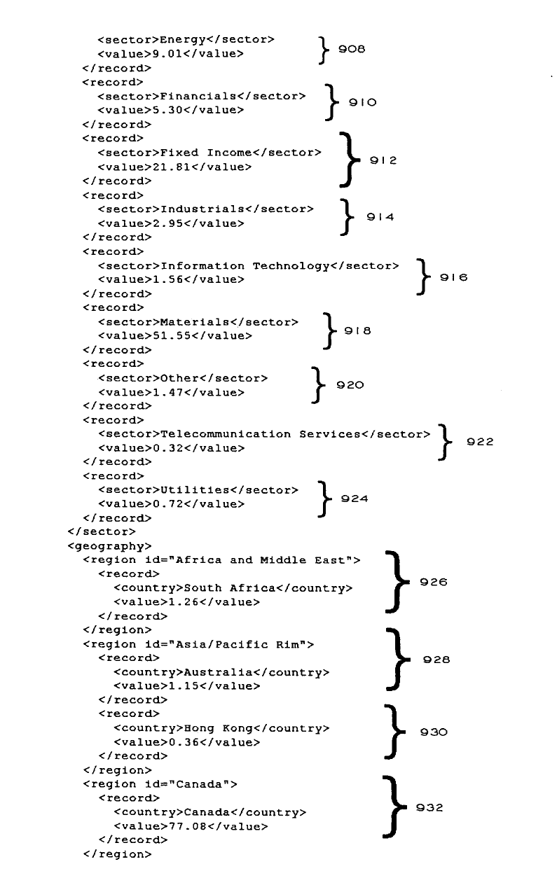

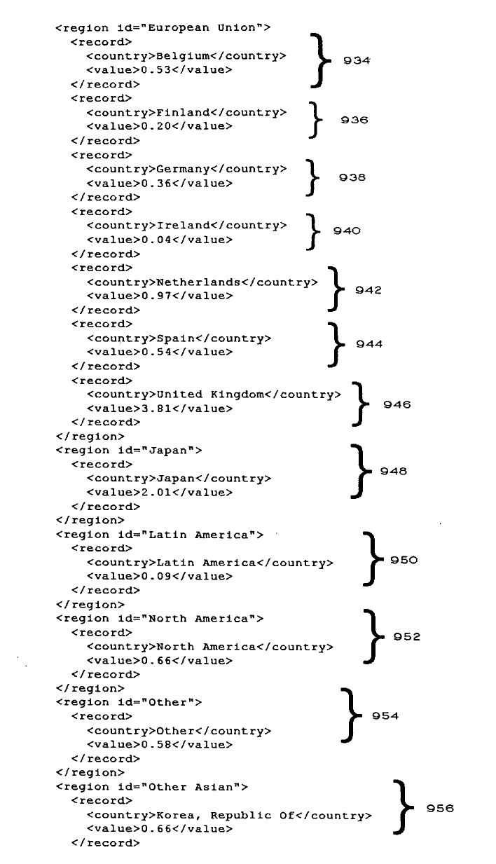

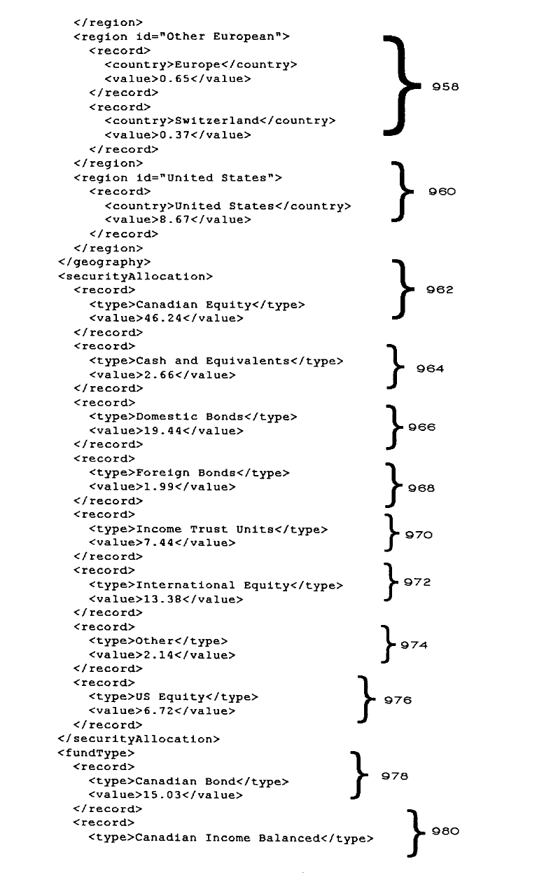

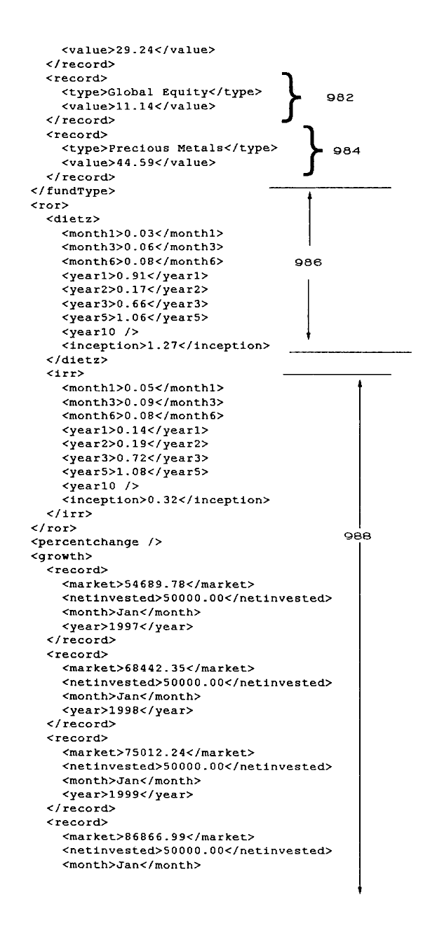

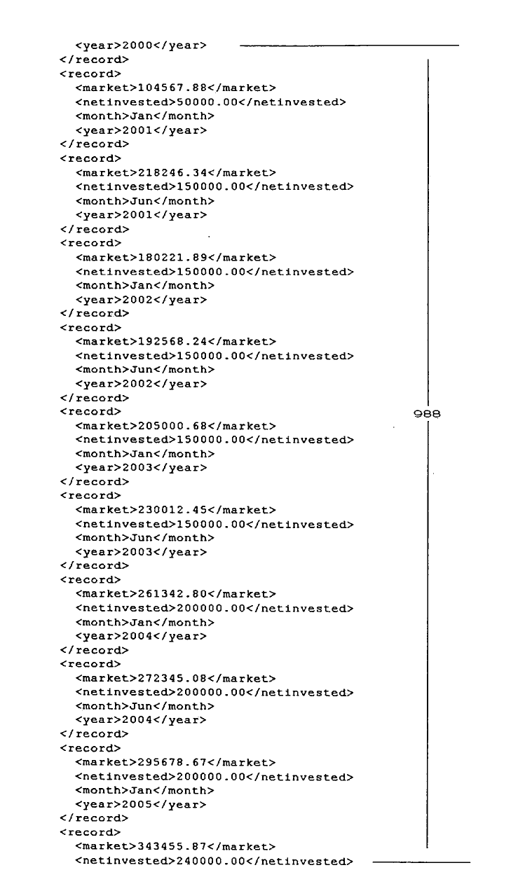

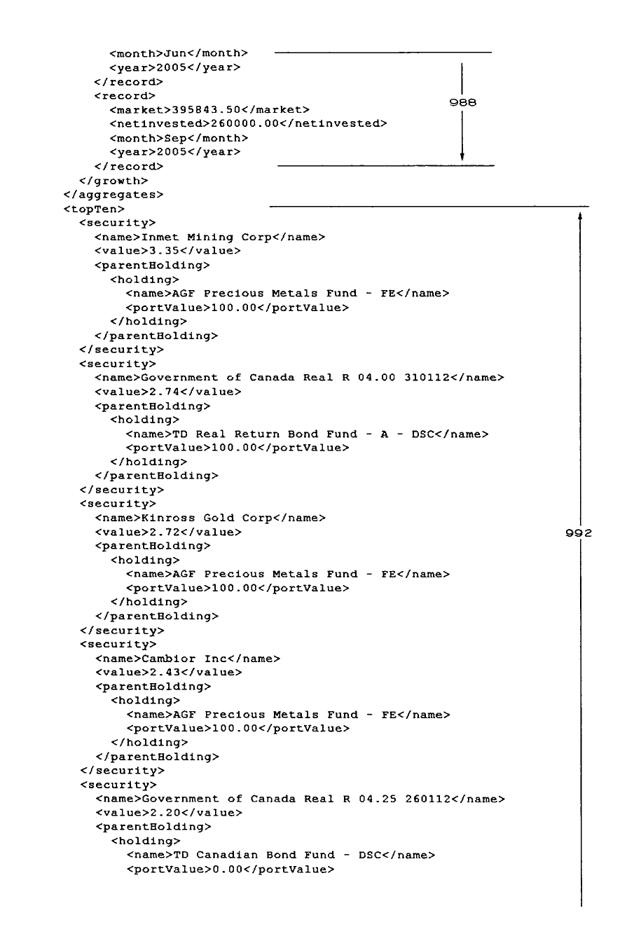

With respect to the XML data files illustrated in FIG. 2A (and similarly those XML data files which form FIGS. 3A, 4B, 6B2, and 10), the format of the data illustrated in FIG. 2A is known to persons skilled in the art (in XML format, the data being placed between paired codes, in the general form of “<code> data </code>”), the data in the XML data file illustrated in FIG. 2A being in the form of a table, and each row of the table 442 and thereafter represents a client and is bracketed by the opening code <client> and closing code </client>, and each cell in a row is bracketed by the appropriate table column/cell codes. For example, in the first row (that is, the row 442 containing data for the first client in the table), the first column/cell 422 is the client identification number “1627”, which appears in the first cell 422 bracketed between the <id> and the </id> codes. Similarly, the second column/cell in the first row 442 is the client's first name “Robert”, which appears in the second cell 424, bracketed by the codes <firstname> and </firstname>. Similarly, the data in each column/cell in the first row 442 is bracketed by a pair of codes in the form of an opening code, having a format of <code> and a closing code, having a format of </code>. The second and following rows in the table are similarly arranged in the XML data file of FIG. 2A, each row of client data being bracketed by the codes <client> and </client>.

The table of FIG. 2 may be searched by the user who may select a search criteria from the drop-down box “Search By’ 17, which allows the user to search by any field or column criteria, such as ID Number, First Name, Last Name, Status, Phone Number, Gender, Country and entering a search term in the adjacent data entry window 15, in a manner known to a person skilled in the art.

### Account Summary

Additionally, by selecting/activating the client selection button 12 corresponding to a particular client, or by selecting/activating the row in which a client's data is presented, the Application presents to the user the “Account Summary” screen relating to that particular client as is illustrated in FIG. 3. The Account Summary screen re-presents the Manager button 22, Section Help button 24 and the Logout button 26 which function in the manner as previously described. In this screen, the screen name window 20 is populated with the screen name, and the selected client's name in a manner known to person skilled in the art. Additionally, a Summary button 40, Growth button 42, Statistics button 44, Geographic button 46, Sector button 48 and Allocation button 50 are presented to the user to navigate further within the Application in relation to the selected client's investments as more fully described below.

Additionally, in the “Account Summary” screen, a table is provided which displays certain specific information regarding the selected client's one or more investment accounts or plans (in the context of the description provided herein, and the Figures, the word “accounts” and “plans” are used interchangeably to refer to a client's particular set of investments). In the preferred embodiment, the data/information presented in the “Account Summary” screen is obtained by the Application in the following manner:
1. the Application forwards to a query to the Client Investment Database, which query includes a unique identifier relating to the client (such as the client identification number) of the client whose detailed personal and investment information is being sought (or forwards by means of the Internet or other network connection), which information/data is used to query the Client Investment Database to locate and report certain data/information relating to the selected client and that client's accounts and the investments within that client's accounts, which information (and certain additional calculated information as more fully described herein) is reported back to the Application, in the preferred embodiment, in the form of an XML data file such as illustrated in FIG. 3A;
2. referring to the XML data file such as illustrated in FIG. 3A, in a preferred embodiment, as a result of the above-referenced query, detailed information in relation to the client (800 through 876B), and detailed information in relation to each of that client's accounts, and the investments therein (in the example illustrated in FIG. 3A, the selected client has 3 accounts, the information for the first account being located at 877A through 877B, for the second account at 879A through 879B and for the third account at 881A through 881B) is provided to the Application;
3. in respect of the information in relation to the client (800 through 876B), in the preferred embodiment, the following information is provided in the file of FIG. 3A:
   a. Client's identification number 806 (bracketed by the codes <id> and </id>)
   b. Client's name 808 (bracketed by the codes <name> and </name>)
   c. Date that the information was provided by the Client Investment Database 810, (bracketed by the codes <date> and </date>);
   d. Type of entity 812 (bracketed by the codes <type> and </type>);
   e. Title 814 (bracketed by the codes <title> and </title>);
   f. Status 816 (bracketed by the codes <status> and </status>);
   g. Gender 818 (bracketed by the codes <gender> and </gender>);
   h. Marital status 820 (bracketed by the codes <maritalstatus> and </maritalstatus>);
   i. First name 822 (bracketed by the codes <firstname> and </firstname>);
   j. Middle name 824 (bracketed by the codes <middlename> and </middlename>);
   k. Last name 826 (bracketed by the codes <lastname> and </lastname>);
   l. Client since date 828 (bracketed by the codes <clientsince> and </clientsince>);
   m. Social Security Number 830 (bracketed by the codes <ssn> and </ssn>);
   n. Salutation 832 (bracketed by the codes <salutation> and </salutation>);
   o. Date of birth 836 (bracketed by the codes <dob> and </dob>);
   p. Citizenship 838 (bracketed by the codes <citizenship> and </citizenship>);
   q. Country issued 840 (bracketed by the codes <country> and </country>);
   r. State issued 842 (bracketed by the codes <stateissued> and </stateissued>);
   s. Home address 844 and 846 (bracketed by the codes <homeaddress1> and </home address1>, and <homeaddress2> and </home address2> respectively);
   t. Home city 848 (bracketed by the codes <homecity> and </homecity>);
   u. Home state 850 (bracketed by the codes <homestate> and </homestate>);
   v. Home zip code or postal code 852 (bracketed by the codes <homezip> and </homezip>);
   w. Home country 854 (bracketed by the codes <homecountry> and </homecountry>);
   x. Home phone number 856 (bracketed by the codes <homephone> and </homephone>);
   y. Facsimile number 858 (bracketed by the codes <fax> and </fax>);
   z. Cell phone number 860 (bracketed by the codes <cellphone> and </cellphone>);
   aa. Mailing address 862 (bracketed by the codes <mailingaddress1> and </mailing address1>);
   bb. Mailing city 864 (bracketed by the codes <mailingcity> and </mailingcity>);
   cc. Mailing state 866 (bracketed by the codes <mailingstate> and </mailingstate>);
   dd. Mailing ZIP or postal code 868 (bracketed by the codes <mailingzip> and </mailingzip>);
   ee. Mailing country 870 (bracketed by the codes <mailingcountry> and </mailingcountry>);
   ff. E-mail address 872 (bracketed by the codes <email> and </email>);
   gg. Work e-mail address 874 (bracketed by the codes <workemail> and </workemail>);
   hh. Other biographical data 876;
4. in respect of the information in relation to each account of the client, in the preferred embodiment, the following information is provided in the file of FIG. 3A (for the first account, at 877A through 877B, for the second account at 879A through 879B and for the third account at 881A through 881B):
   i. The account identification number 787
   ii. The account plan type 880
   iii. The account registration 882
   iv. The account registration name 884
   v. The account registration number 886
   vi. The account country 888
   vii. The account registration number 890
   viii. The account status 892
   ix. The account open date 894
   x. The account holder 896
   xi. The account current value 898
   xii. In respect of each of the sectors, the percentage of the clients investments which are:
      (1) in the form of cash or cash equivalents 900 and 902
      (2) are in the consumer discretionary sector 904
      (3) are in the consumer staples sector 906
      (4) are in the energy sector 908
      (5) are in the financial sector 910
      (6) are in the fixed income sector 912
      (7) are in the industrials sector 914
      (8) are in the information-technology sector 916
      (9) are in the materials sector 918
      (10) are in the “other” sector 920
      (11) are in the telecommunication services sector 922;
      (12) are in the utilities sector 924;
   xiii. In respect of each of the geographic regions, the percentage of the client's investments which are:
      (1) in the Africa and Middle East region, namely South Africa 926
      (2) in the Asia-Pacific rim region, namely Australia 928 and Hong Kong 930;
      (3) in the Canada region 932
      (4) in the European Union region, namely Belgium 934, Finland 936, Germany 938, Ireland 940, Netherlands 942, Spain 944, and United Kingdom 946
      (5) in the Japan region 948;
      (6) in the Latin America region 950
      (7) in the North America region 952
      (8) in the “other” region 954
      (9) in the “other Asian” region 956
      (10) in the “Other European” region including Europe and Switzerland
      (11) in the United States region
   xiv. In respect of each of the different security allocations, the percentage of the client's investments which are:
      (1) in Canadian equities 962
      (2) in cash and equivalents 964
      (3) in domestic bonds 966
      (4) in foreign bonds 968
      (5) in income trust units 970
      (6) in international equity 972
      (7) in other securities 974
      (8) in U.S. equities 976
   xv. In respect of each of the different types of funds, the percentage of the client's investments which are:
      (1) in Canadian bonds 978
      (2) in Canadian income balanced 980
      (3) in global equity 982
      (4) in precious metals 984
   xvi. The rate of return (referred to as “ROR”), either in the form of a modified Dietz calculation (referred to as “DEITZ”) 986 and the internal rate of return (referred to as “IRR”) 988
   xvii. In respect of each account of the client, the following information is provided 990, on a scheduled periodic basis (for example monthly):
      (1) for each year (as of January 1 or other specified date), the net amount of the client's investment;
      (2) the total market value for the account (as of January 1 or other specified date);
   xviii. The “Top 10” securities held in the client's combined investments within the account 992, as further described below;
   xix. Information relating to each of the investments held in that particular client account 994, including for example:
      (1) the identification number 1000
      (2) the plan account number 1002
      (3) the account number 1004
      (4) the name of the investment 1006
      (5) The CUSIP symbol 1008
      (6) The symbol 1010
      (7) the status 1012
      (8) the number of units held by the client 1014
      (9) the current price 1016
      (10) the current market value 1018
      (11) the net amount invested by the client 1020
      (12) the current book value 1022
      (13) information relating to the investment's equity style 1024
      (14) information relating to the investment's fixed income style 1026
      (15) information relating to the investment's risk, including standard deviation, beta, alpha, sharpe and return 1028
      (16) information relating to the investment's internal rate of return (irr) 1030
      (17) information relating to the investment's modified dietz rate of return 1032.

### Additional Calculated Information Included in the Data

As described above, in one embodiment of the present invention, the information reported back to the Application which is subject of the XML data file illustrated in FIG. 3A includes information/data which is stored in the Client Investment Database and information/data stored in the General Investment Database, and also additional information/data which is calculated using information/data which is stored in the Client Investment Database and information/data stored in the General Investment Database. With reference to the Sector data set out in paragraph 4(xii), the Geographic Regions data set in paragraph 4(xiii), the Security Allocations data set in paragraph 4(xiv), the Types of Funds data set out in paragraph 4(xv), and the Top Ten Securities data set in paragraph 4(xvii), in the preferred embodiment, this information/data is not stored in the Client Investment Database per se, but rather is calculated specifically for the Application, from data in the Client Investment Database and information/data stored in the General Investment Database, and in one embodiment, is provided to the Application by way of the XML data file such as illustrated in FIG. 3A, and an alternative embodiment, is calculated by the Application utilizing data from the XML data file such as illustrated in FIG. 3A (in the alternative embodiment, the XML data file includes that information and data required by the Application to perform those calculations, which calculations are more fully described herein). For example, if a client has an account in which there are three investments, the Client Investment Database does not provide information as to the client's top 10 securities in those combined three investments (that is, while the Client Investment Database does keep track of which investments the client currently holds, and does keep track of which securities are currently held in each of the client's investments, the database does not keep track of or record the combined number of the various specific securities held by the client in the client's multiple investments, and does not keep track of the combined value of these securities owned by the client in its multiple investments. So, for example, if in the client's first investment, the client owns 3 shares of a particular company, and in the client's second investment, the client owns 4 shares of that particular company, and in the client's third investment, the client owns 1 share of that particular company, the Client Investment Database does not record that the client has a total of 8 shares in that particular company (in the client's combined 3 investments), although this can be determined by calculation), and does not record the total value (combined) of these eight shares.

In the preferred embodiment of the present invention, a third party organization such as WINSOFT provides to the Application the data from the Client Investment Database and additionally performs certain specifically requested additional calculations to provide certain calculated data specifically for use by the Application, as follows:
1. With reference to the Sector data set out in paragraph 4(xii), for utilization by the Application, the following calculations are performed by the third party organization:
   For each Sector the following calculation is performed by the third party organization:

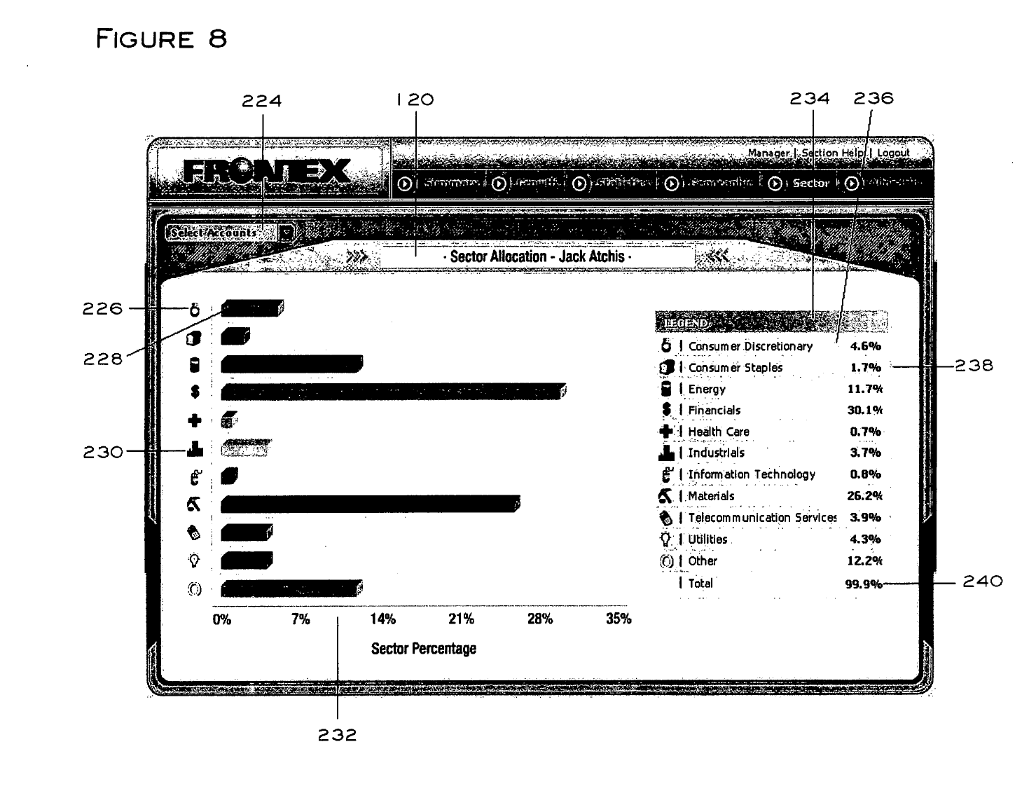

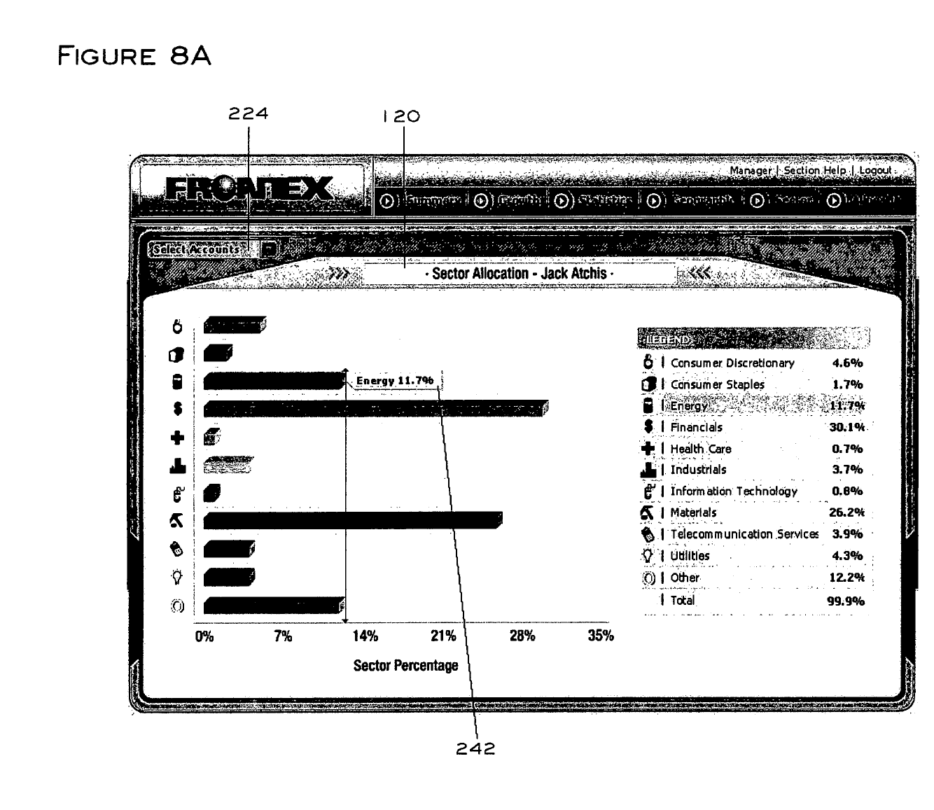

Σ[(Market value of the investment)/(market value of the account)]×(percentage weighting of the sector)
This calculation, which utilizes data from both the Client Investment Database and the General Investment Database gives the percentage weighting of each Sector in an account of the client.
This information is used to generate the chart shown in FIG. 8 and FIG. 8A.
2. With reference to the Geographic Regions data set in paragraph 4(xiii):
   For each country the following calculation is performed by the third party organization:

Σ[(Market value of the investment)/(market value of the account)]×(percentage weighting in the country)
This calculation, which utilizes data from both the Client Investment Database and the General Investment Database gives the percentage weighting of each country in an account of the client.
For each region the following calculation is performed by the third party organization:

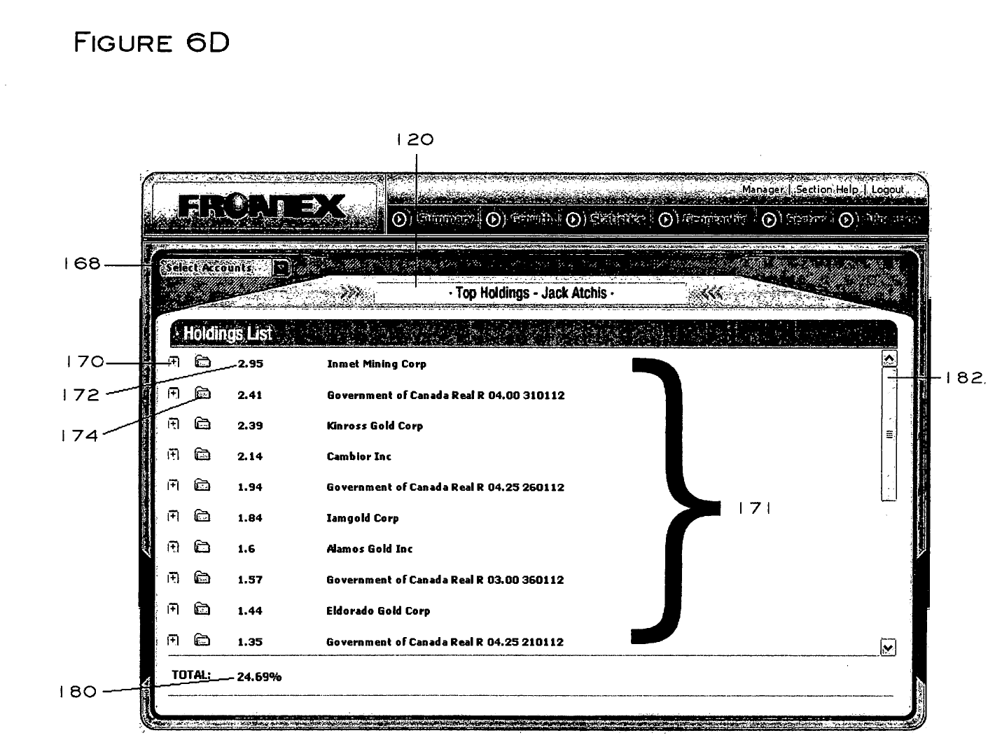

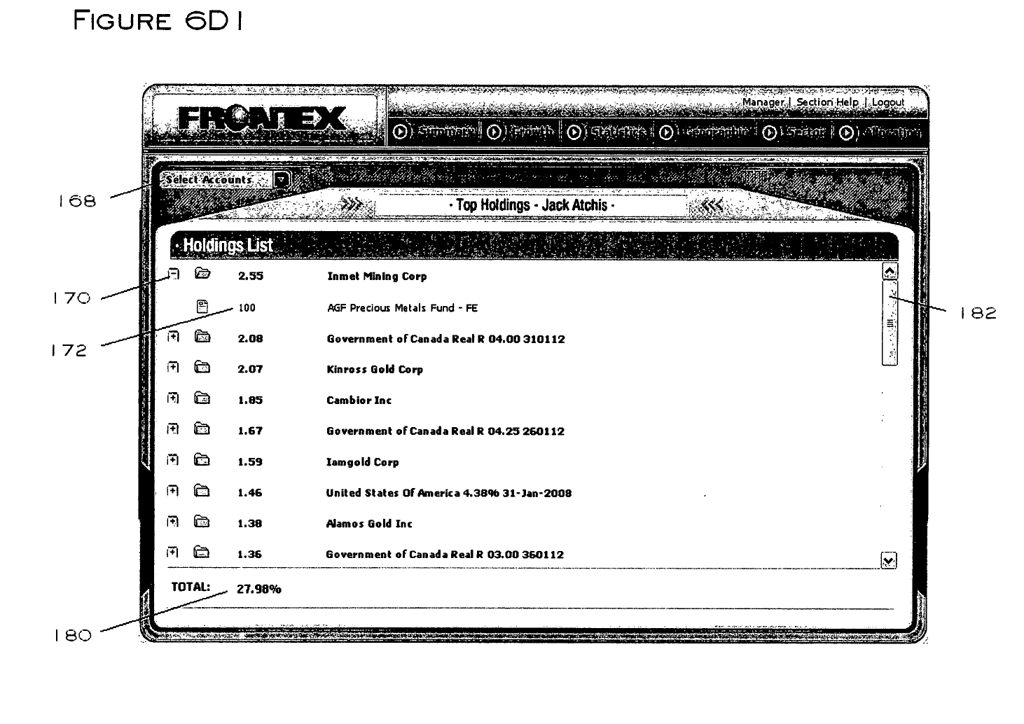

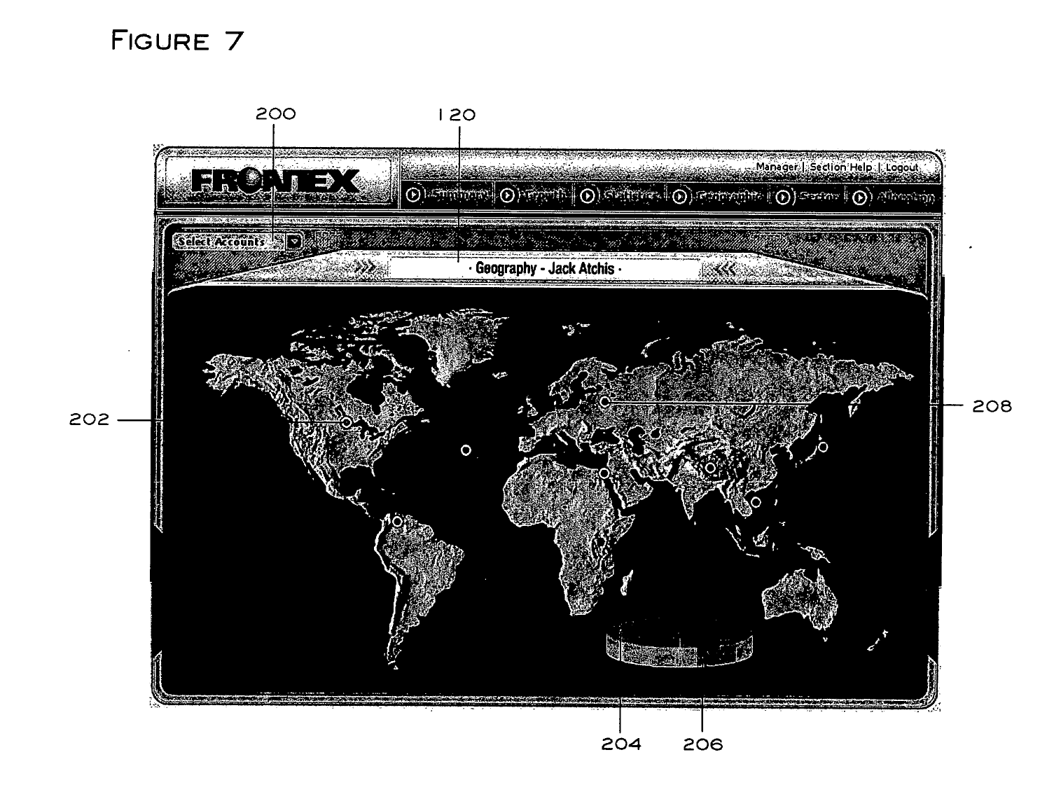

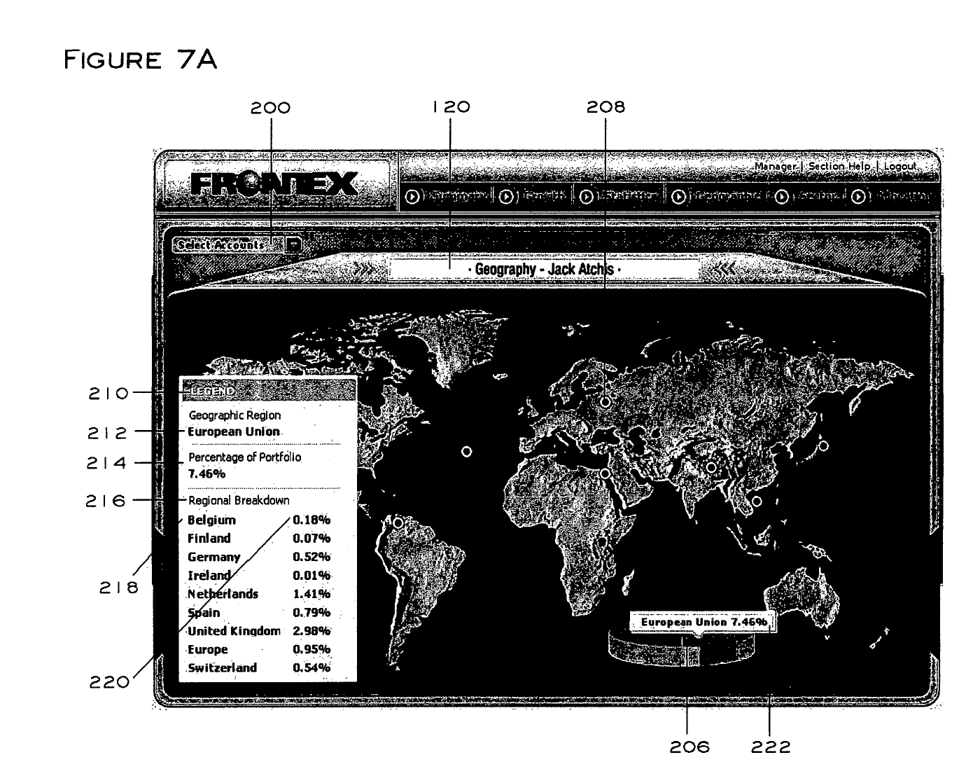

Σ[percentage weighting of each country in a region]
This calculation gives the percentage weighting in a region in an account of the client.
This information is used to generate the diagram data shown in FIG. 7 and FIG. 7A.
3. With reference to the security allocations data set in paragraph 4(xiv)
   For each security type the following calculation is performed by the third party organization:

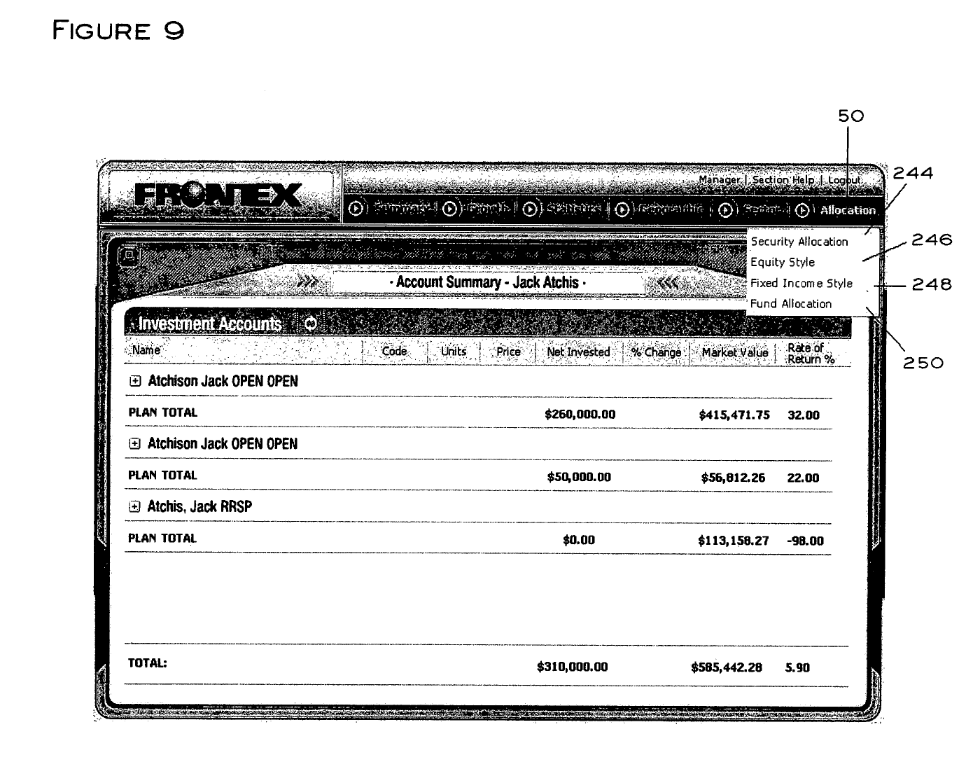

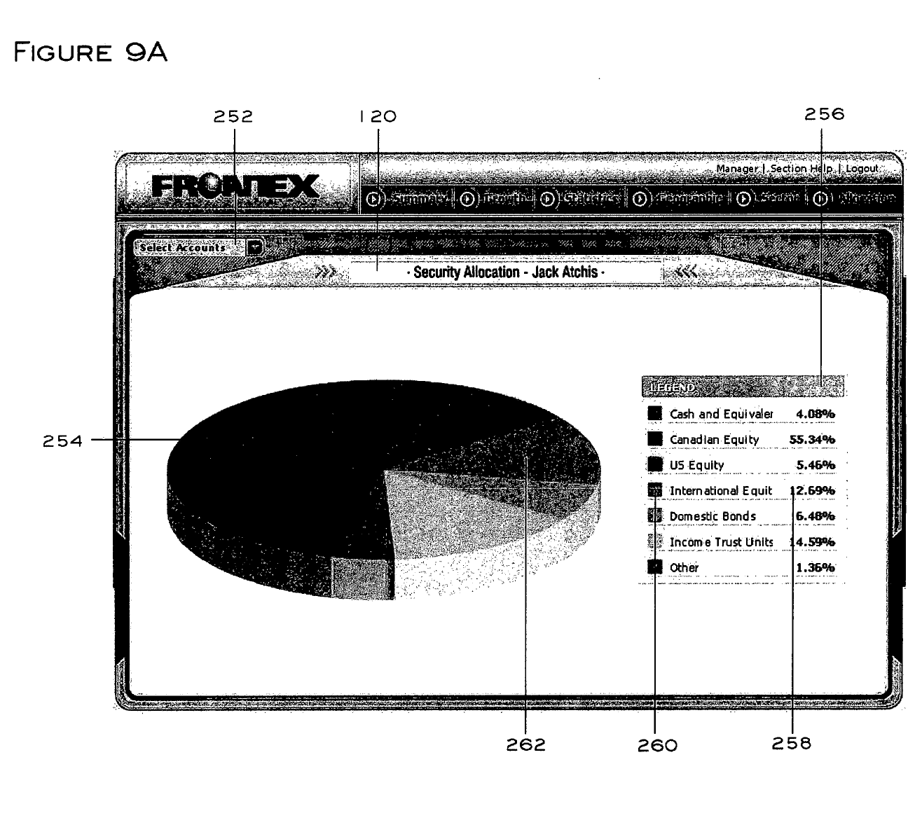

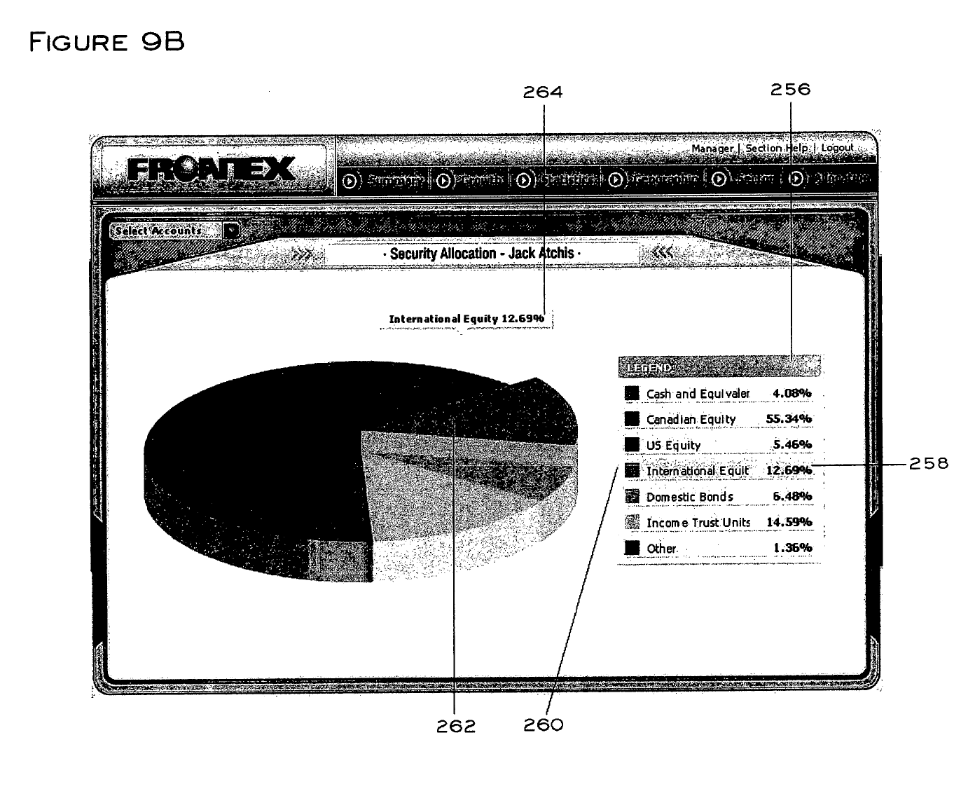

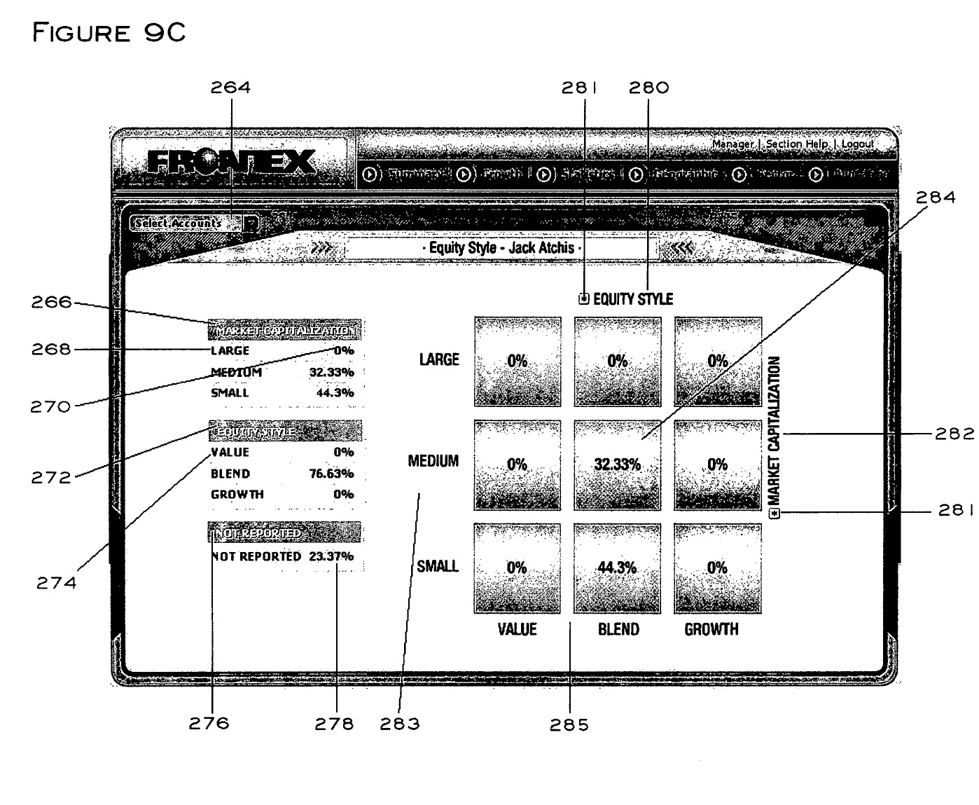

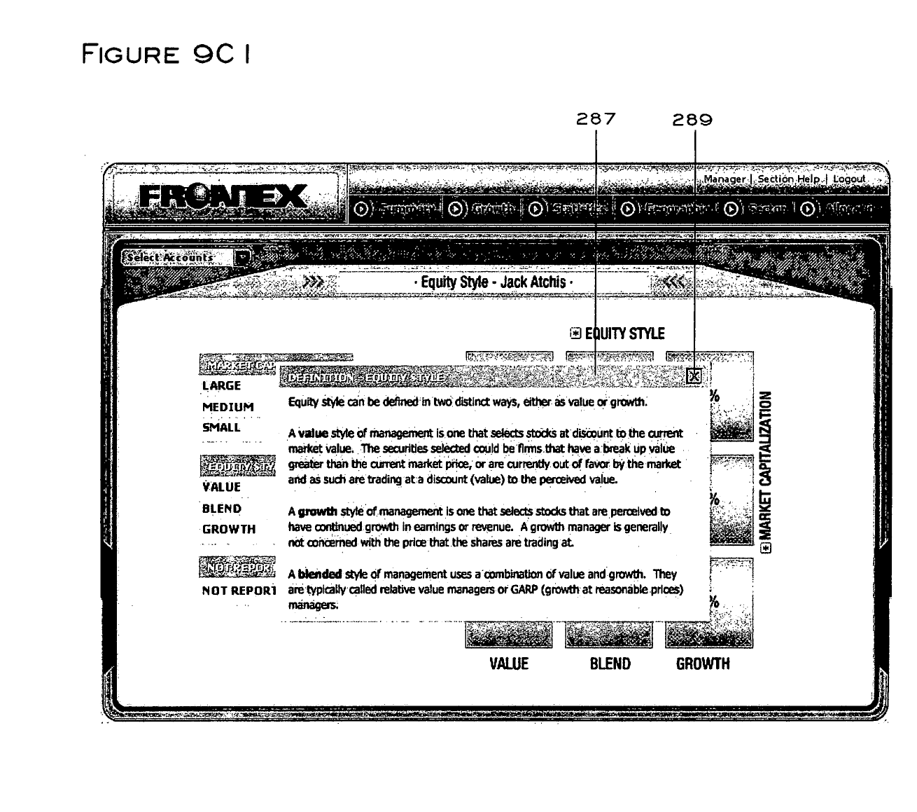

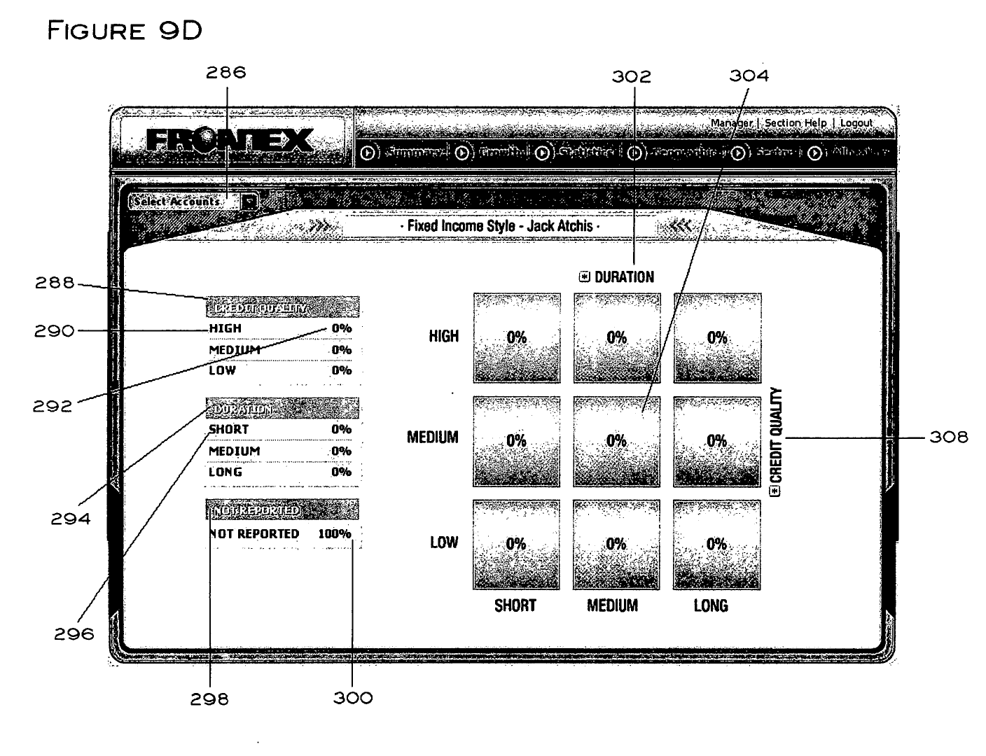

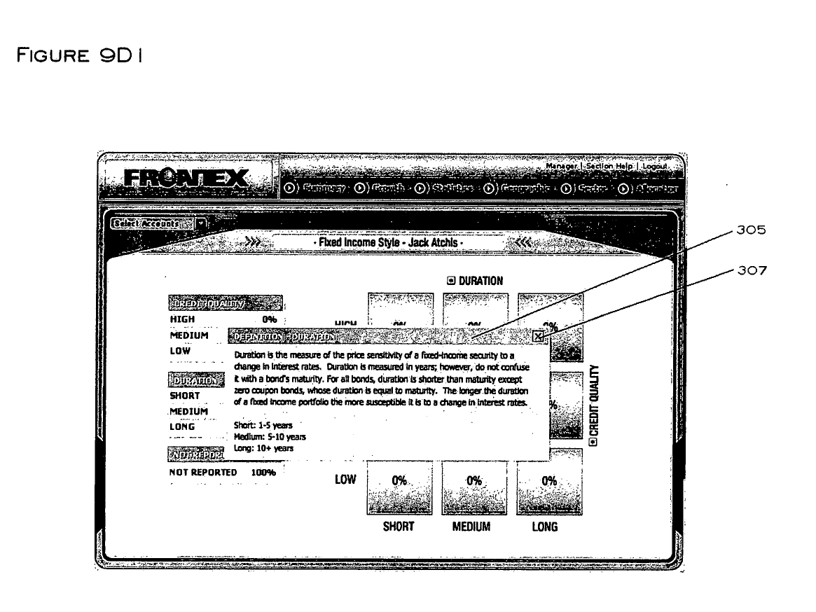

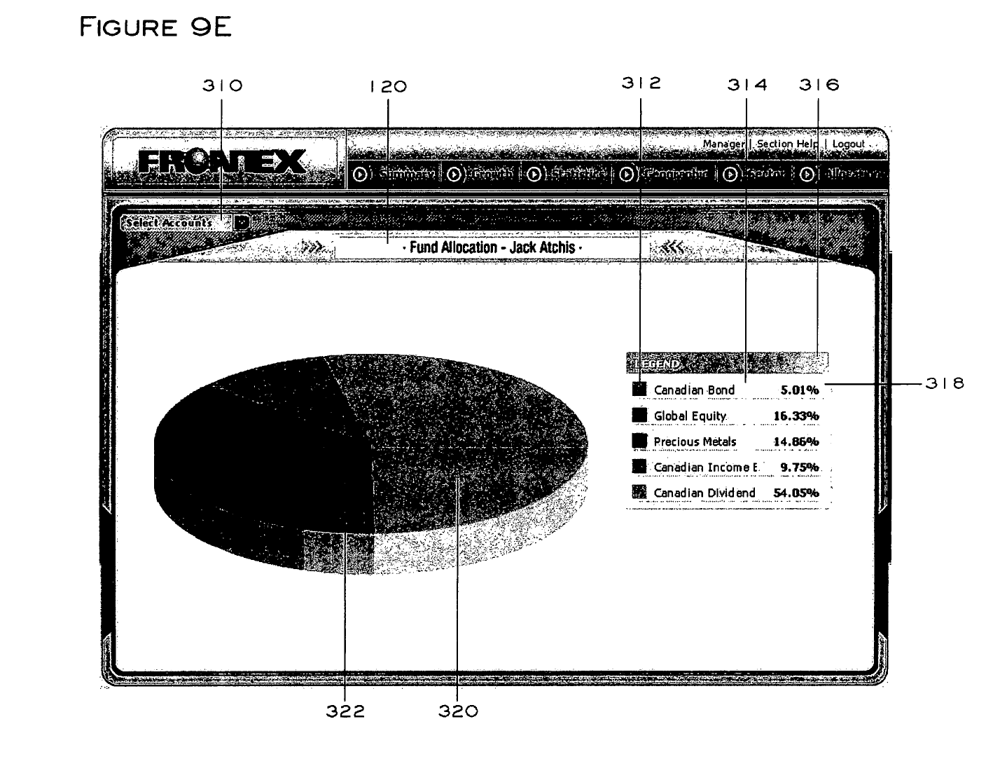

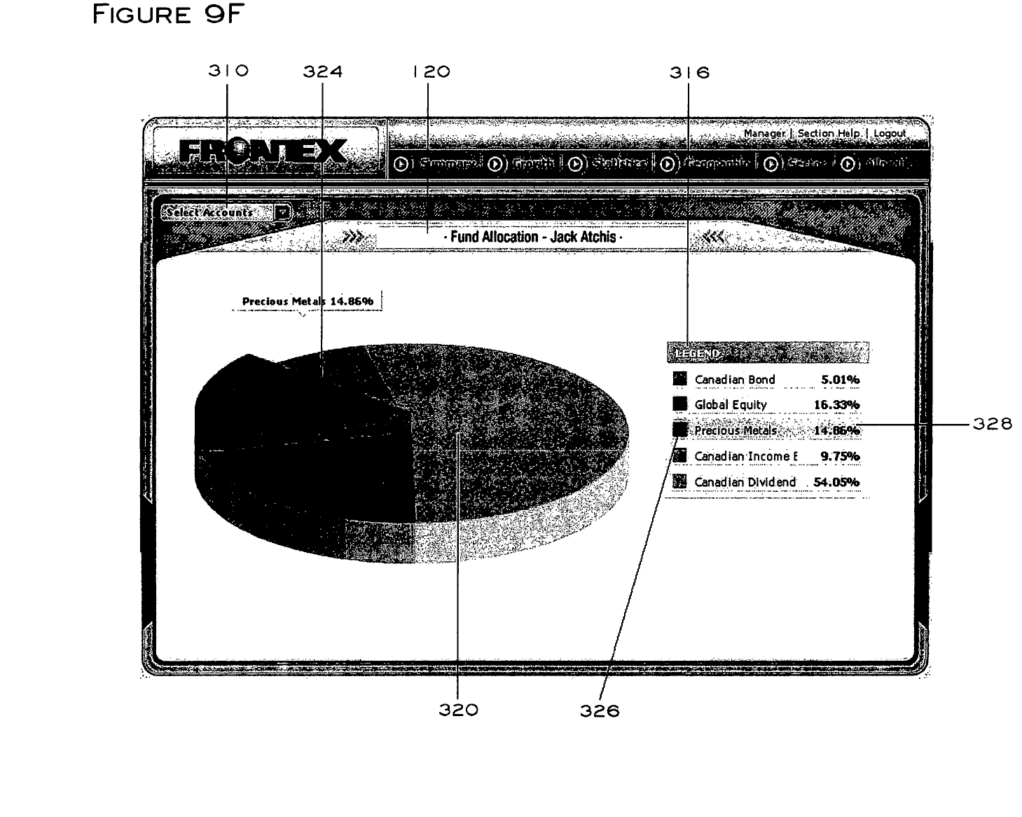

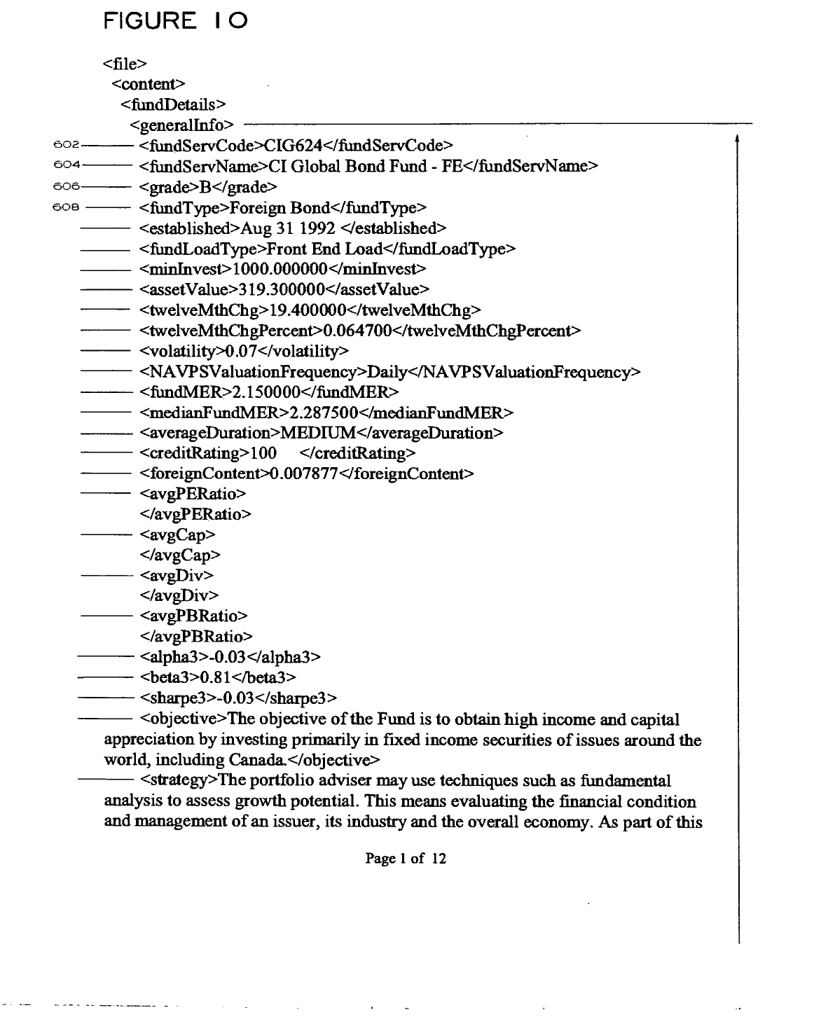

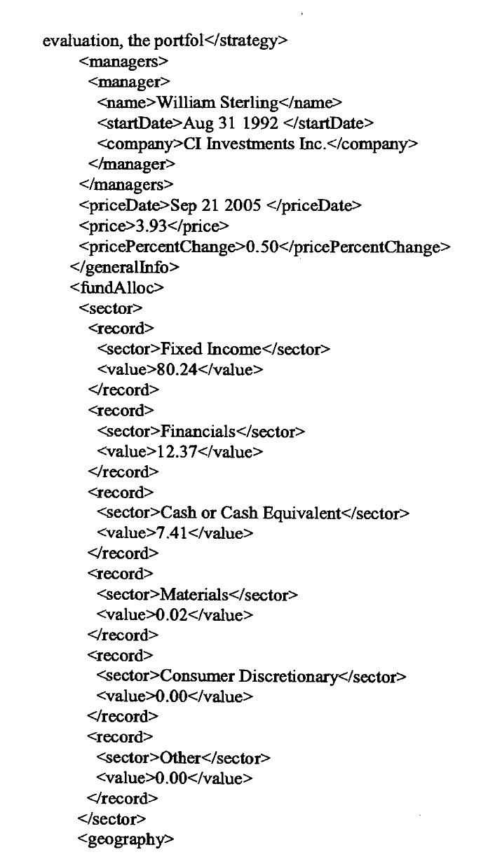

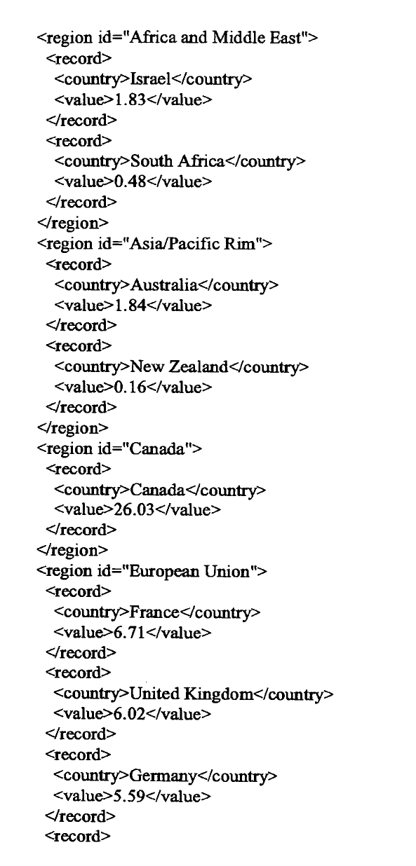

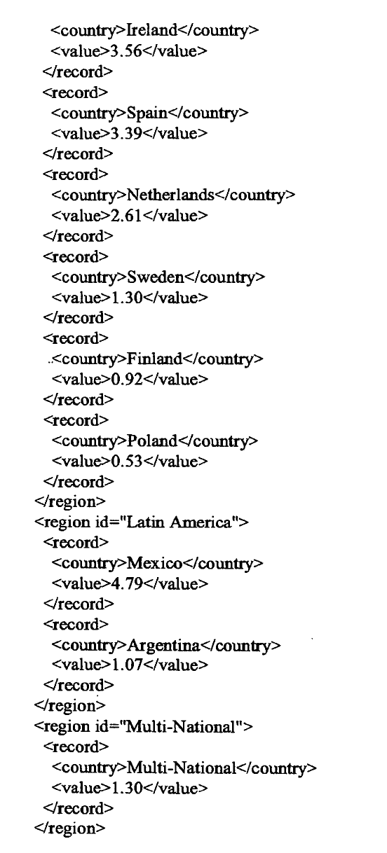

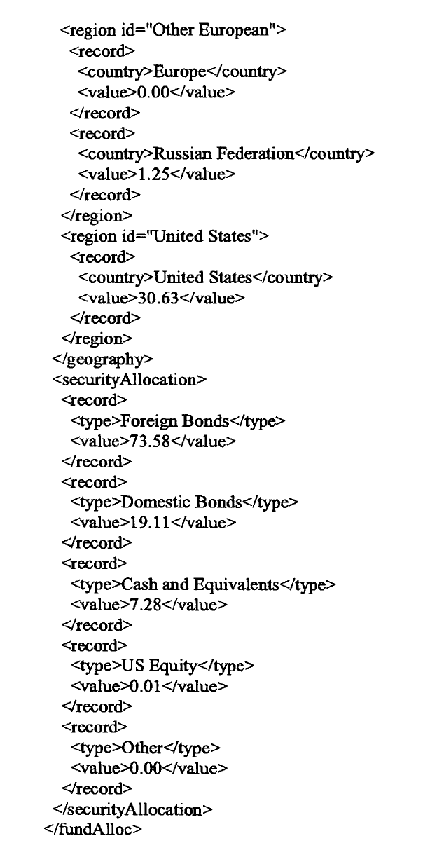

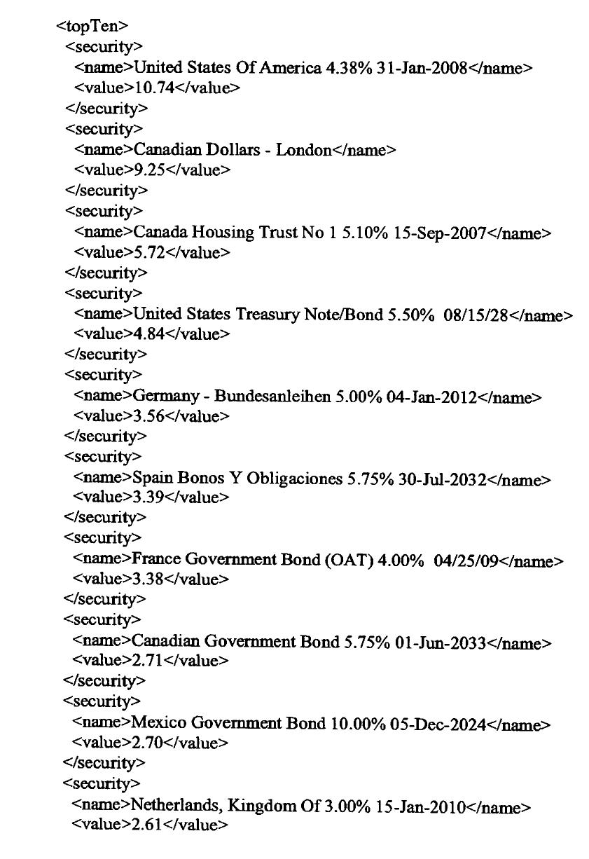

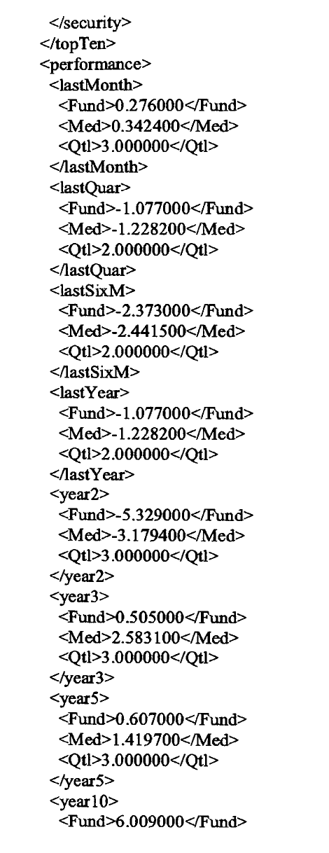

Σ[(Market value of the investment)/(market value of the account)]×(percentage weighting of the security type)
This calculation, which utilizes data from both the Client Investment Database and the General Investment Database, gives the percentage weighting of each security type in an account of the client.
This information is used to generate the diagram data shown in FIG. 9A and FIG. 9B.
4. With reference to the types of funds set out in paragraph 4(xv)
   For each type of fund, the following calculation is performed by the third party organization:

Σ[(Market value of the investment)/(market value of the account)]×(percentage weighting of the fund type)
This calculation, which utilizes data from both the Client Investment Database and the General Investment Database, gives the percentage weighting of each fund type in an account of the client.
This information is used to generate the diagram data shown in FIG. 9E and FIG. 9F.
5. With reference to the “Top Ten” securities data set in paragraph 4(xvii)
   The following calculation is performed by the third party organization:

Σ[(Market value of the investment)/(market value of the account)]×(percentage weighting of the security in the investment)
This calculation, which utilizes data from both the Client Investment Database and the General Investment Database, gives the percentage weighting of the security in an account of the client.
To calculate the percentage that a fund holds of a particular security, the following calculation is performed:

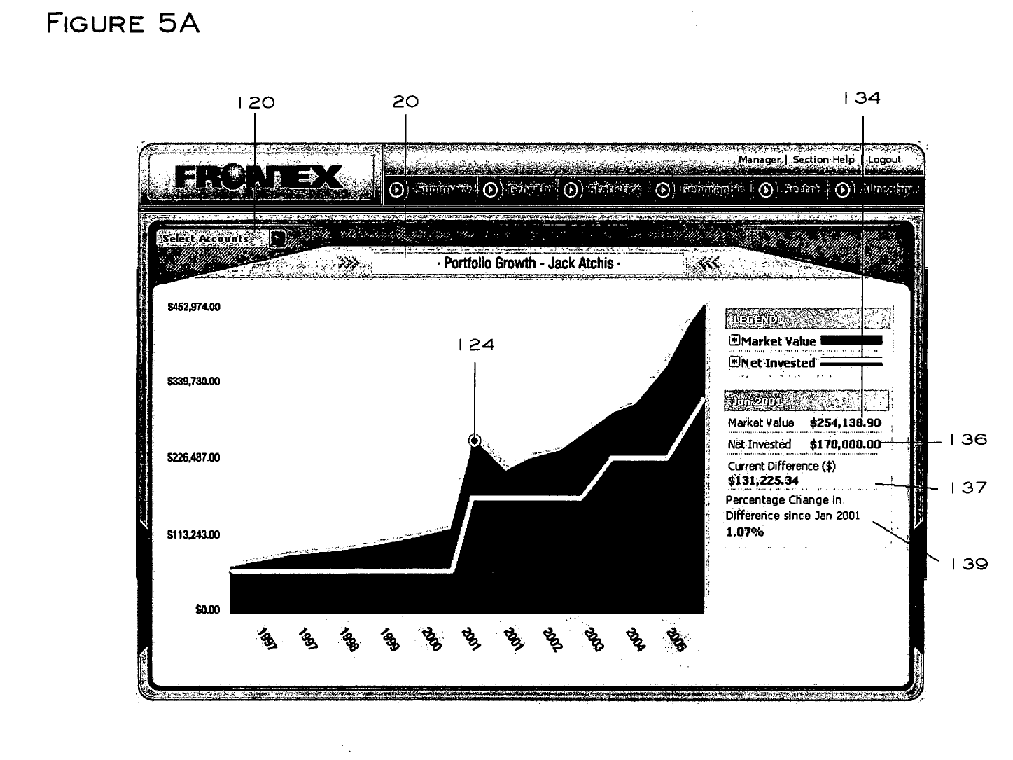

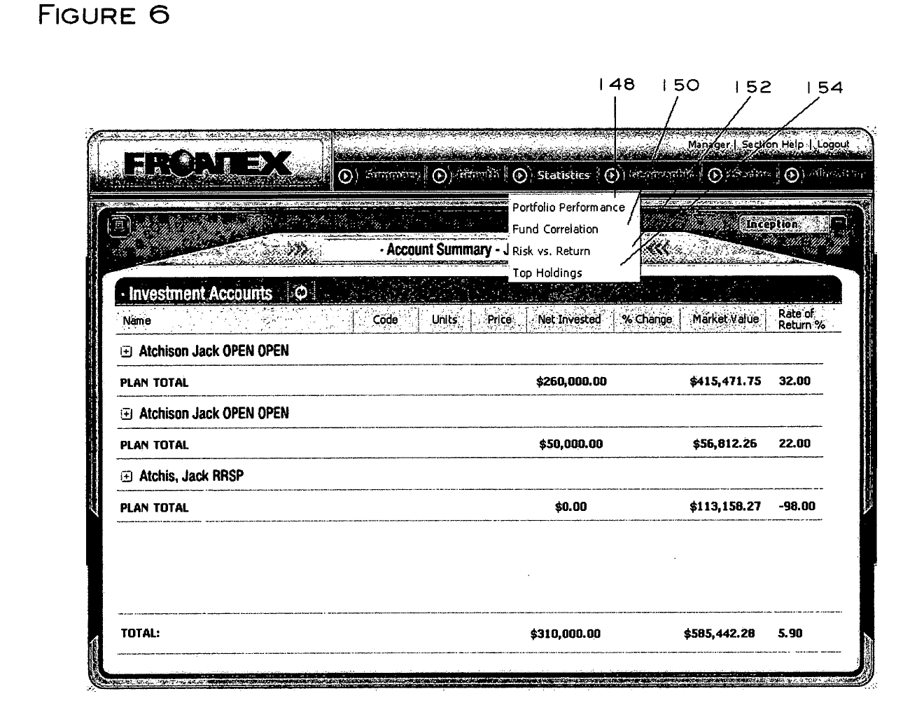

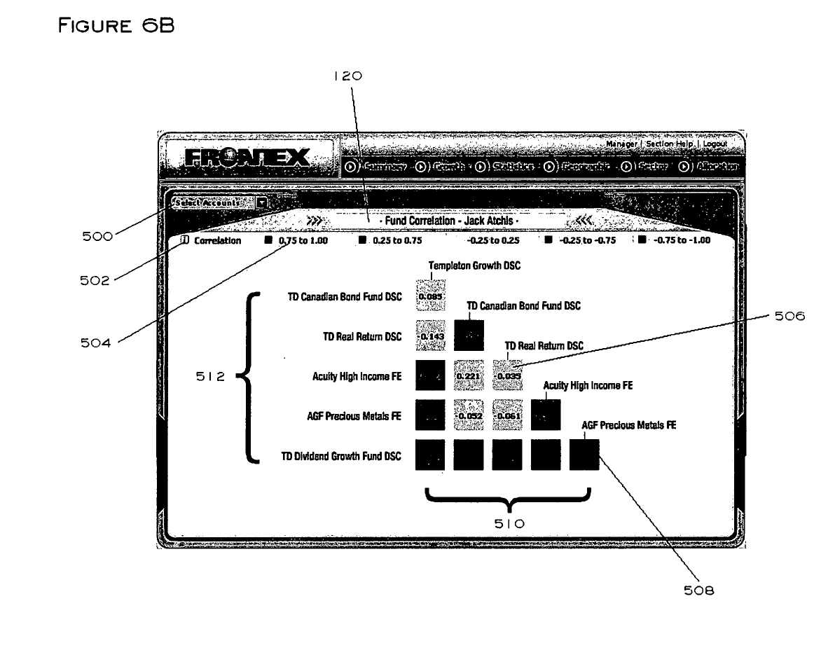

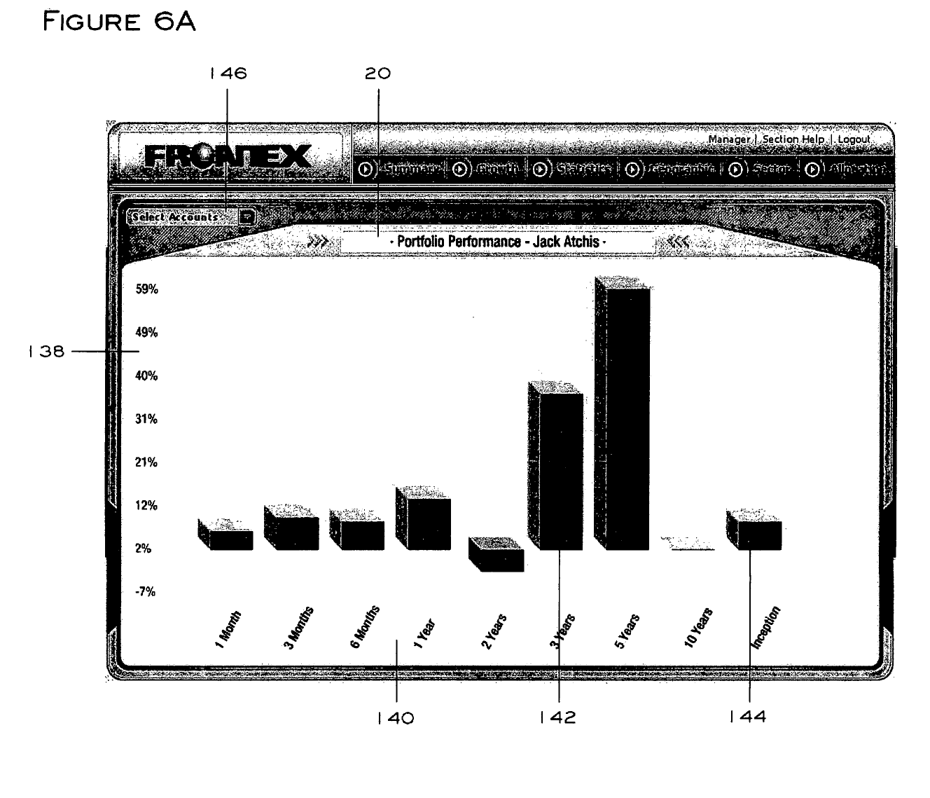

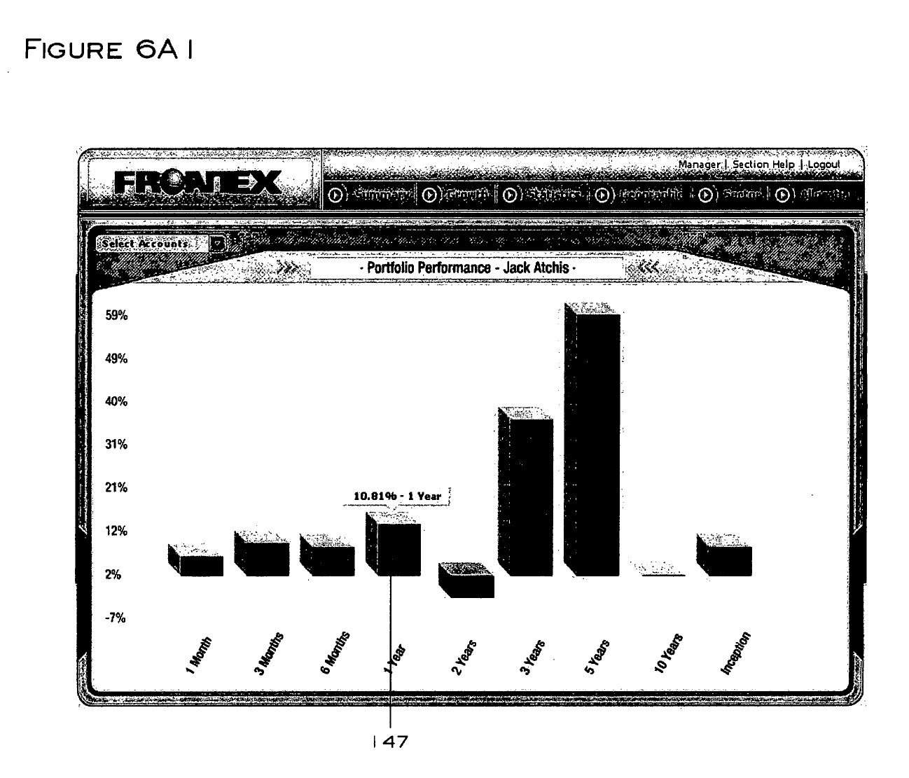

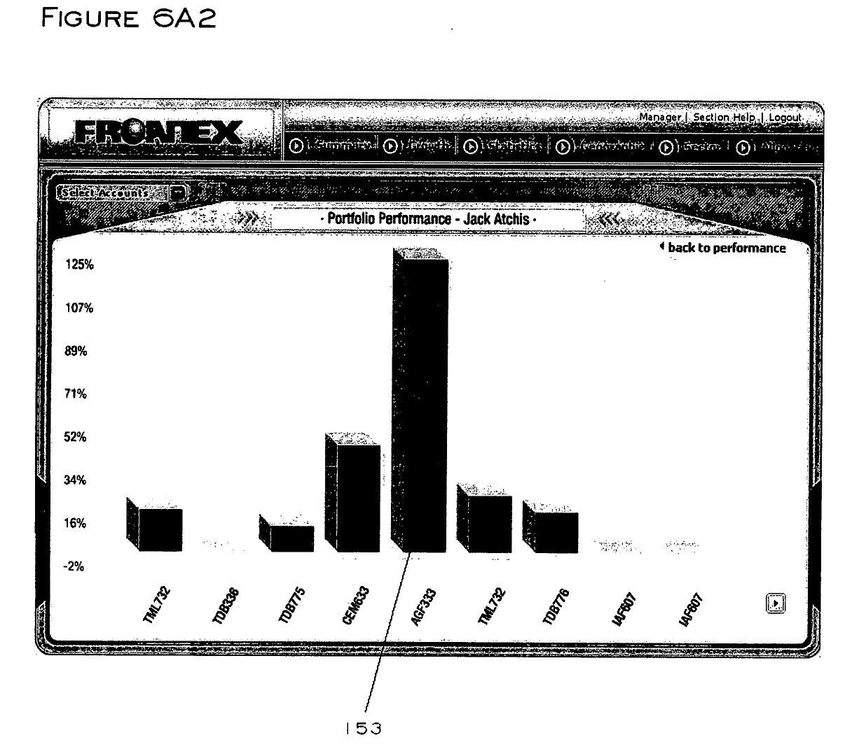

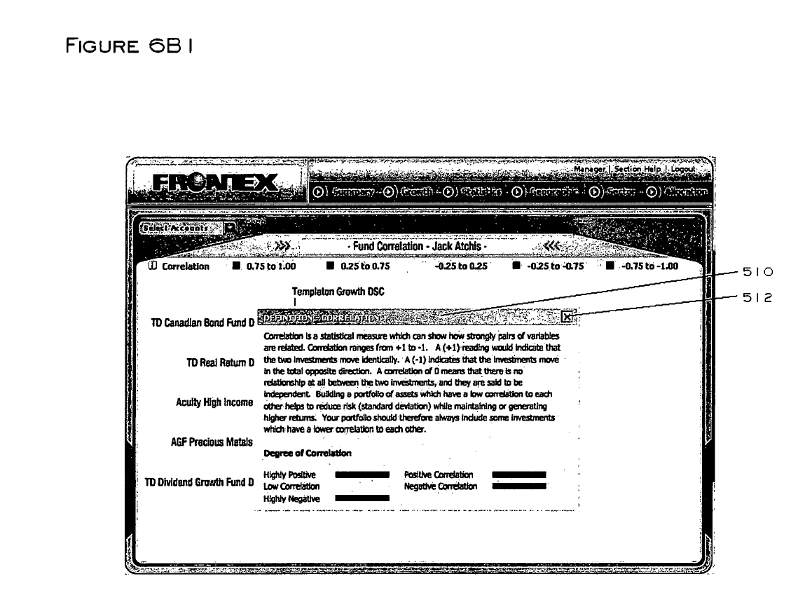

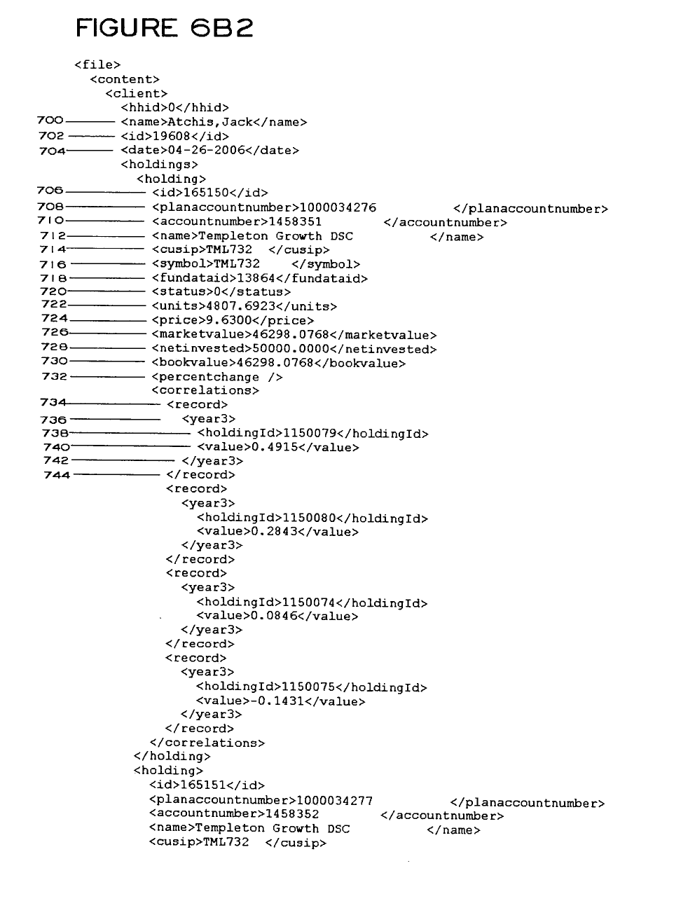

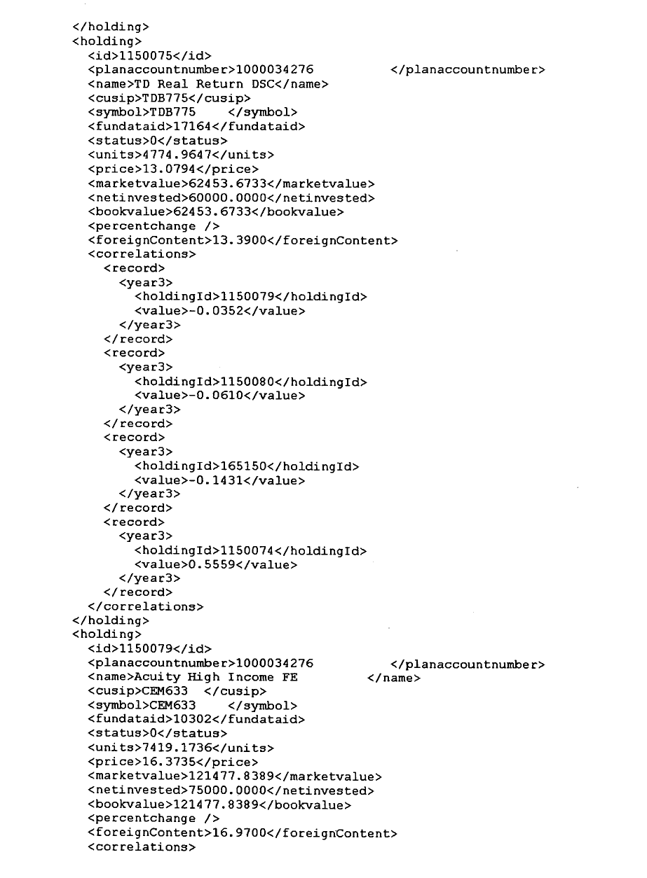

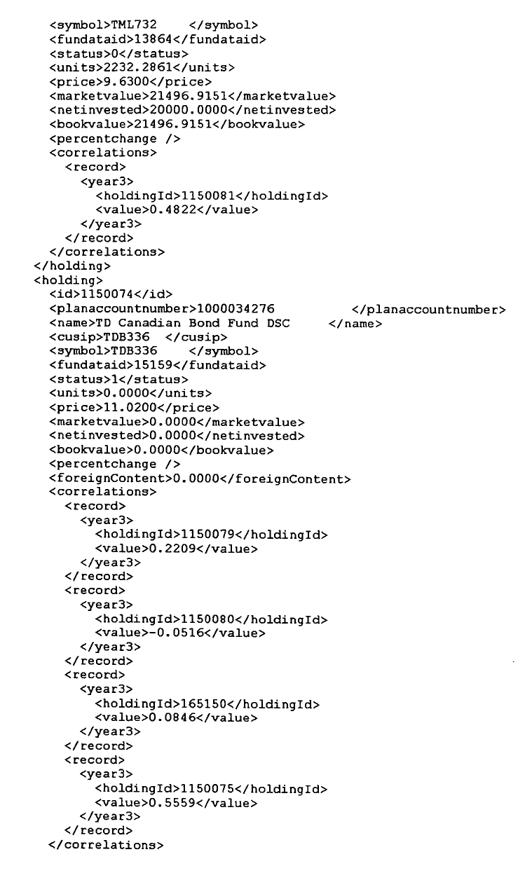

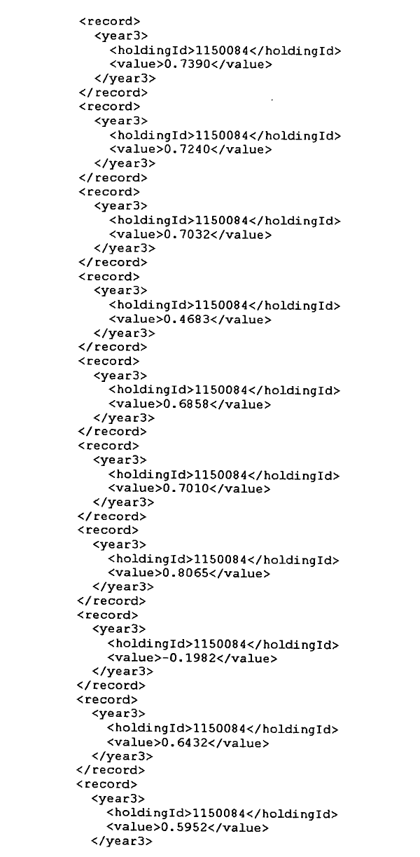

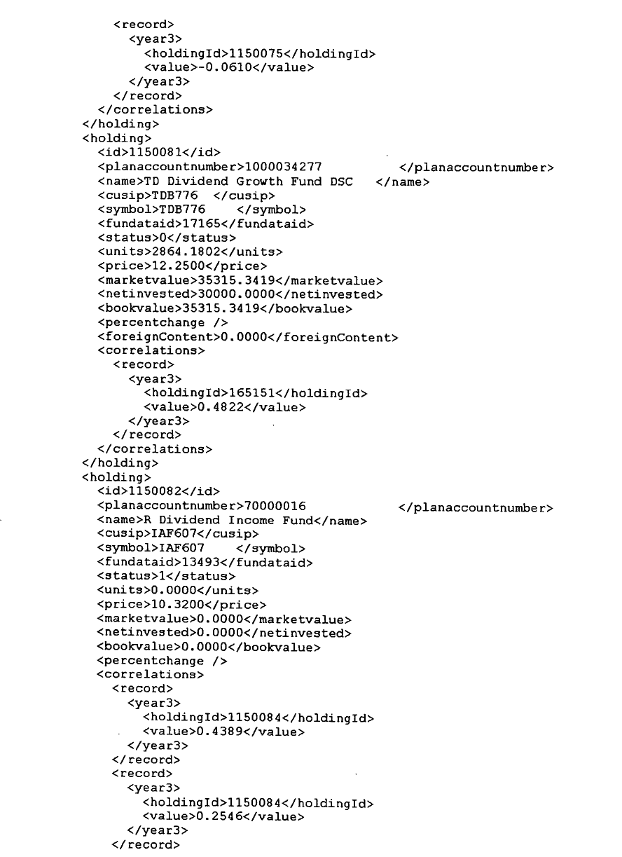

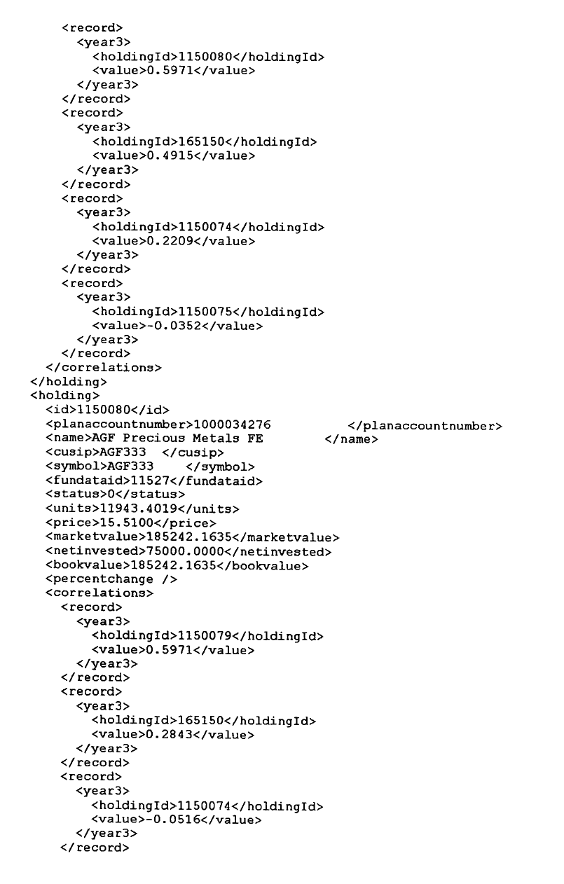

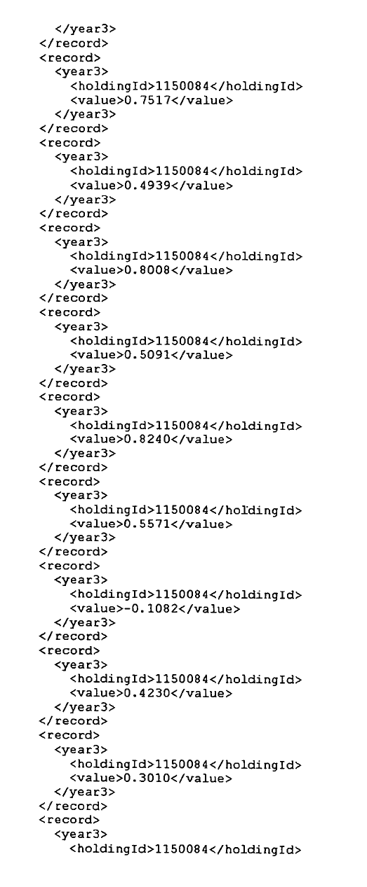

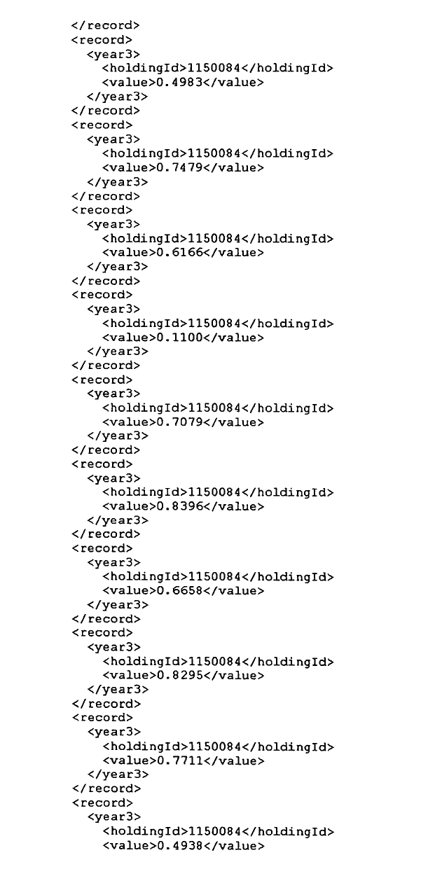

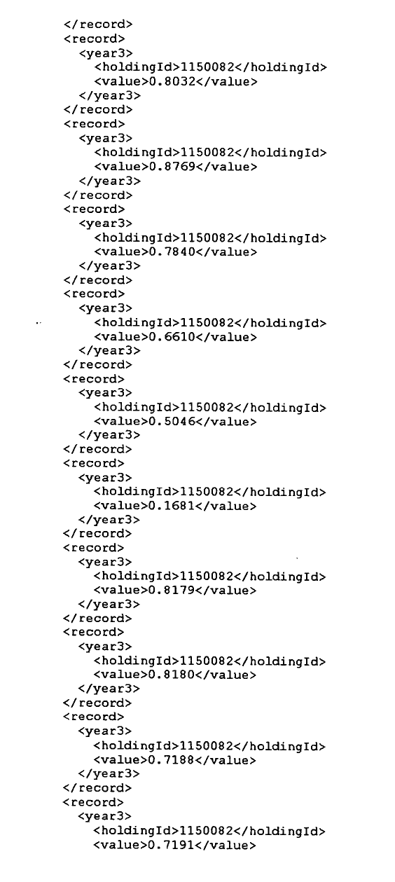

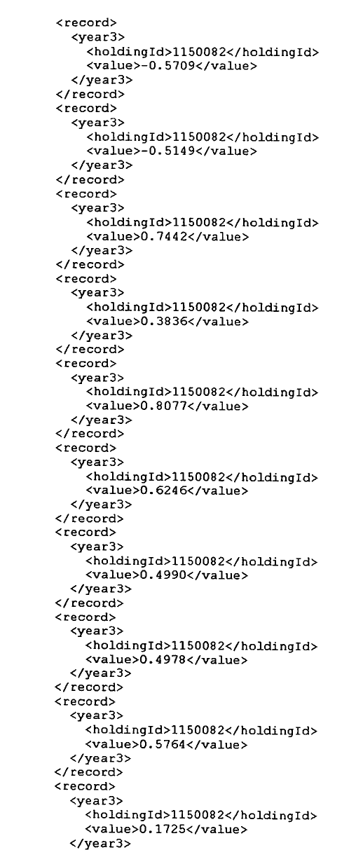

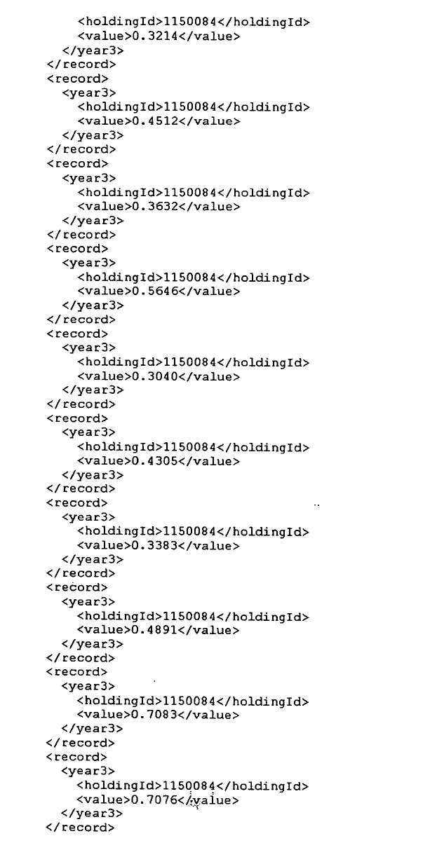

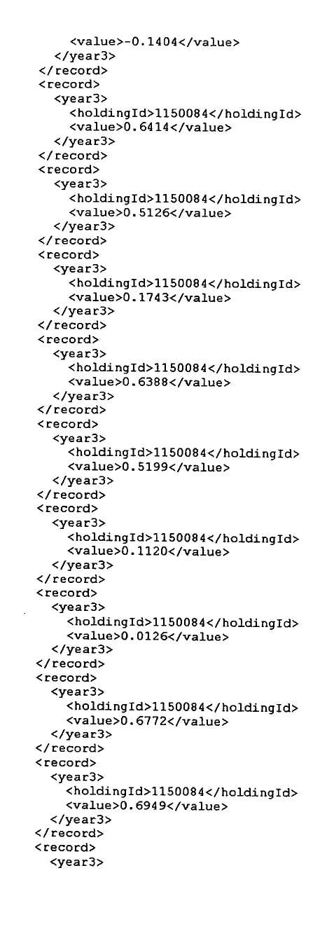

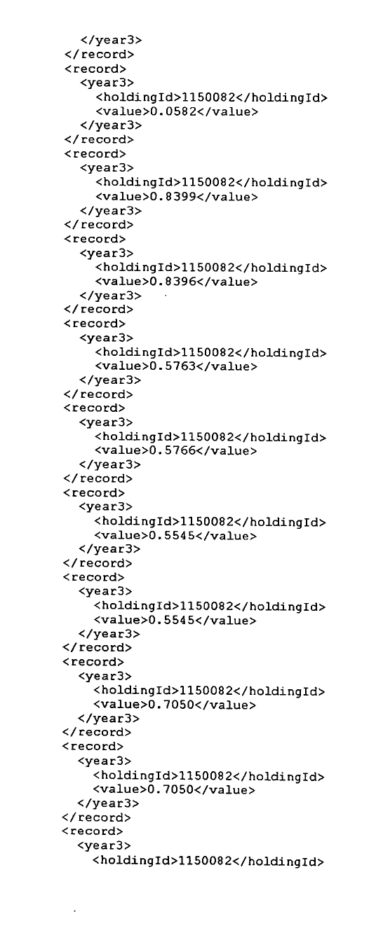

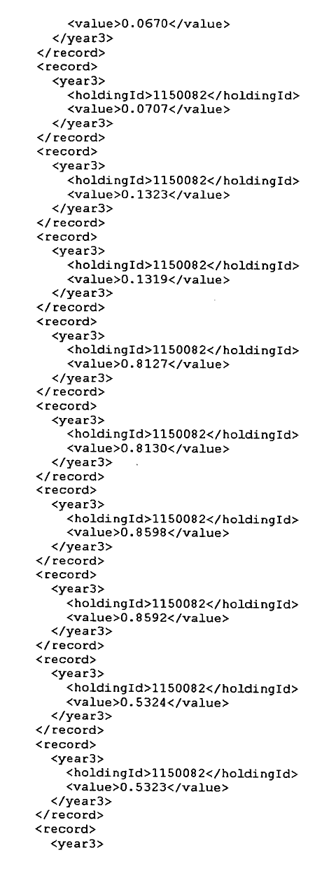

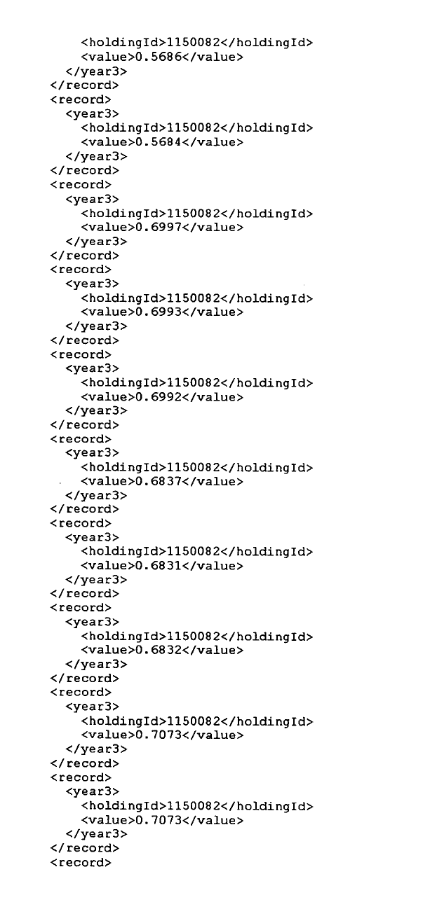

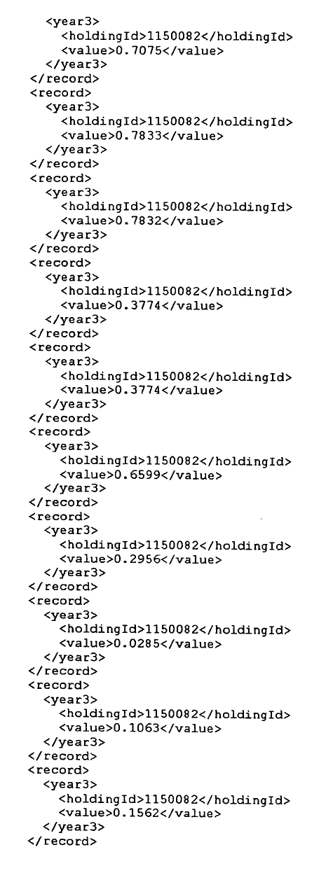

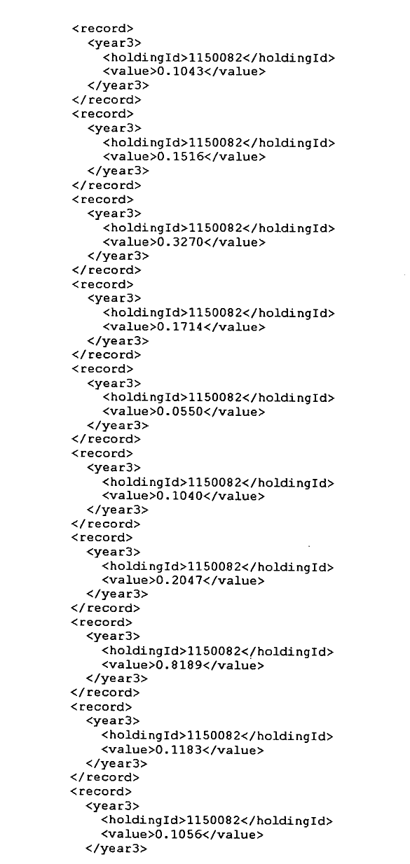

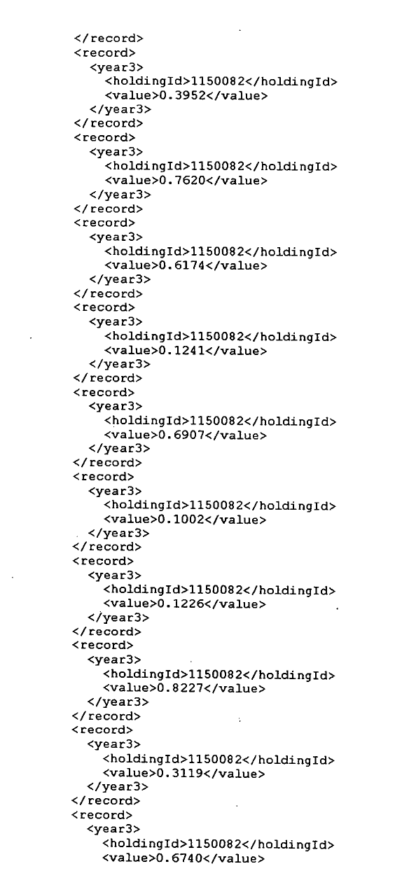

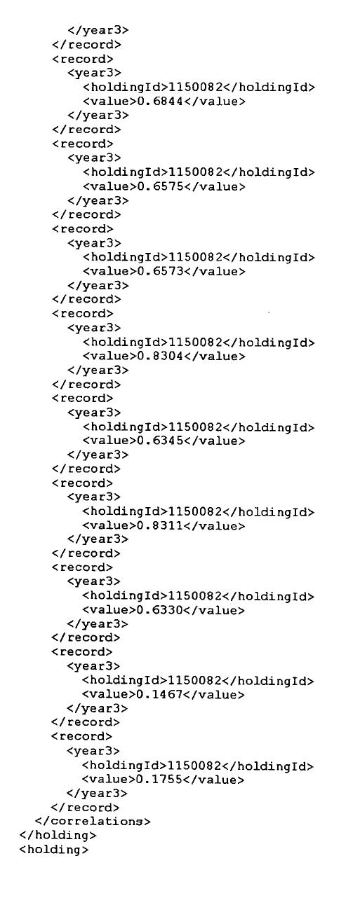

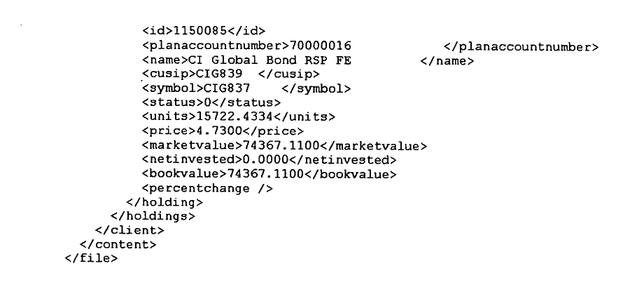

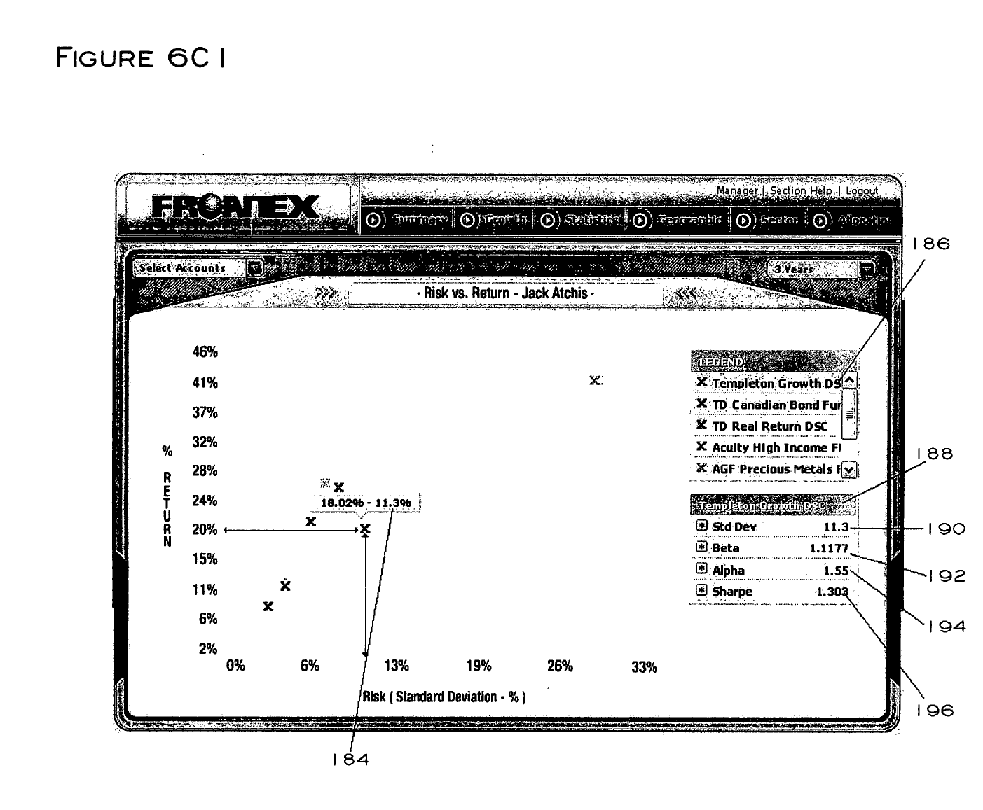

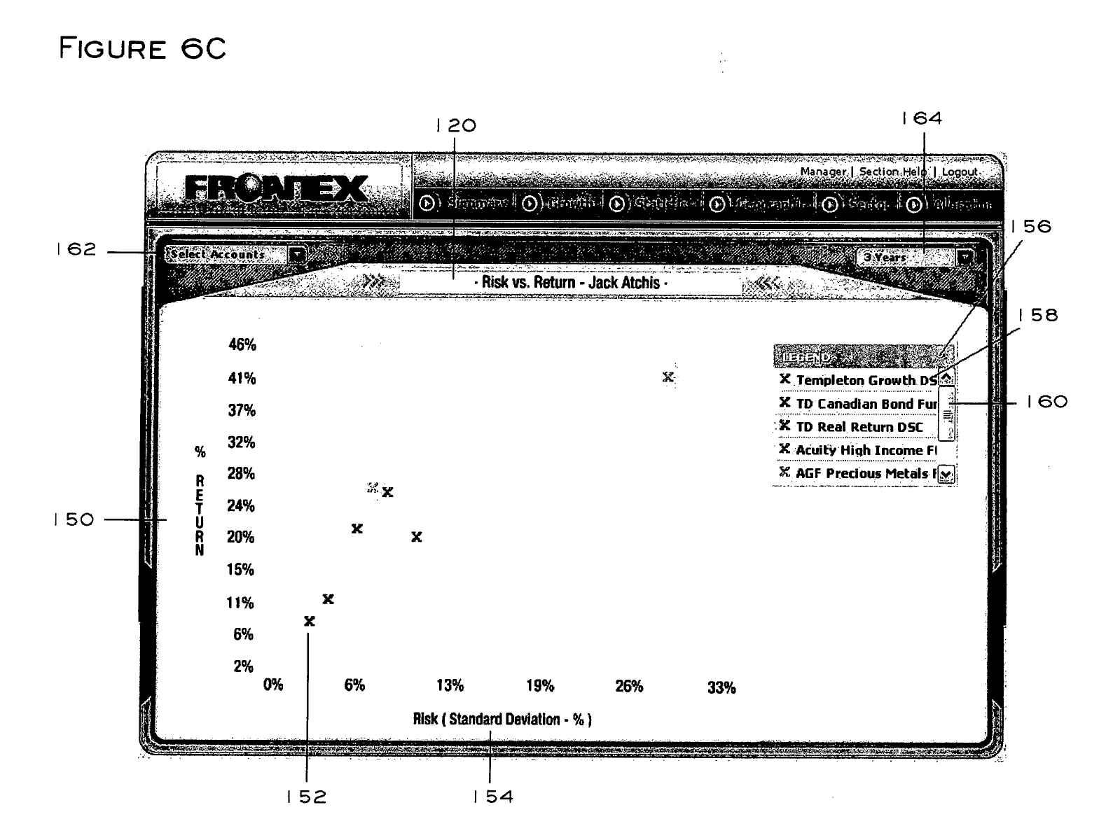

(Investment's percentage weighting in a security)/(total percentage weighting of the security)
This information is used to generate the data shown in FIG. 6D and FIG. 6D1.

The results of the above-referenced calculations are provided to the Application in the XML datafile of FIG. 3A, or in alternative embodiment are calculated by the Application utilizing data provided in an XML file such as the one illustrated in FIG. 3A (in the case of the alternative embodiment, the data required to perform the calculations are included in the XML file).

In addition, in the preferred embodiment, the Application, utilizing data from the XML datafile of FIG. 3A performs the following additional calculations to determine data relating to the Equity Style and Fixed Income Style:
In the case of the Equity Style, the following calculations are performed by the Application from the data provided from the XML datafile of FIG. 3A:
In the case of Market Capitalization:
   For large capitalization:

(ΣMarket value of the investments biased to large capitalization)/(total market value of the account)
This calculation gives the percentage weighting of the market capitalization weighted to large capitalization.
Corresponding calculations are performed for medium capitalization and small capitalization.
This information is used to generate the data shown in table 266 of FIG. 9C and FIG. 9C1.
In the case of Management of Equity Style:
   For value:

(ΣMarket value of the investments biased to value)/(total market value of the account)
This calculation gives the percentage weighting of the investments to value.
Corresponding calculations are performed for growth and blend.
This information is used to generate the data shown in table 272 of FIG. 9C and FIG. 9C1.
Additionally, the following calculation is performed:

(Σ(market values of the investments biased toward large cap and value)/(market value of the account)
This calculation gives the percentage weighting of the investments biased toward large cap and value.
Corresponding calculations are performed for each of the eight other combinations of capitalization and equity style.
This information is used to generate the data shown in table 280 of FIG. 9C and FIG. 9C1.
In the event that there is no bias reported for the investment, a “Not Reported” category would be assigned to that assessment and its calculation is reported in the box 276.
In the case of the Fixed Income Style, the following calculations are performed from the data provided from the XML datafile of FIG. 3A:
In the case of Credit Quality:
   For high credit quality:

(ΣMarket value of the investments biased to high credit quality)/(total market value of the account)
This calculation gives the percentage weighting of the credit quality biased to high quality credit.
Corresponding calculations are performed for medium and low credit quality.
This information is used to generate the data shown in table 288 of FIG. 9D.
In the case of Duration:
   For long term duration:

(ΣMarket value of the investments biased to long term duration)/(total market value of the account)
This calculation gives the percentage weighting of the investments to long term duration.
Corresponding calculations are performed for medium term and short term.
This information is used to generate the data shown in table 294 of FIG. 9D.
Additionally, the following calculation is performed:

(Σ(market values of the investments biased toward long term and high quality)/(market value of the account)
This calculation gives the percentage weighting of the investments biased toward long term and high quality.
Corresponding calculations are performed for each of the eight other combinations of quality and duration.
This information is used to generate the data shown in table 302 of FIG. 9D.
In the event that there is no bias reported for the investment, a “Not Reported” category would be assigned to that assessment and its calculation is reported in the box 298.

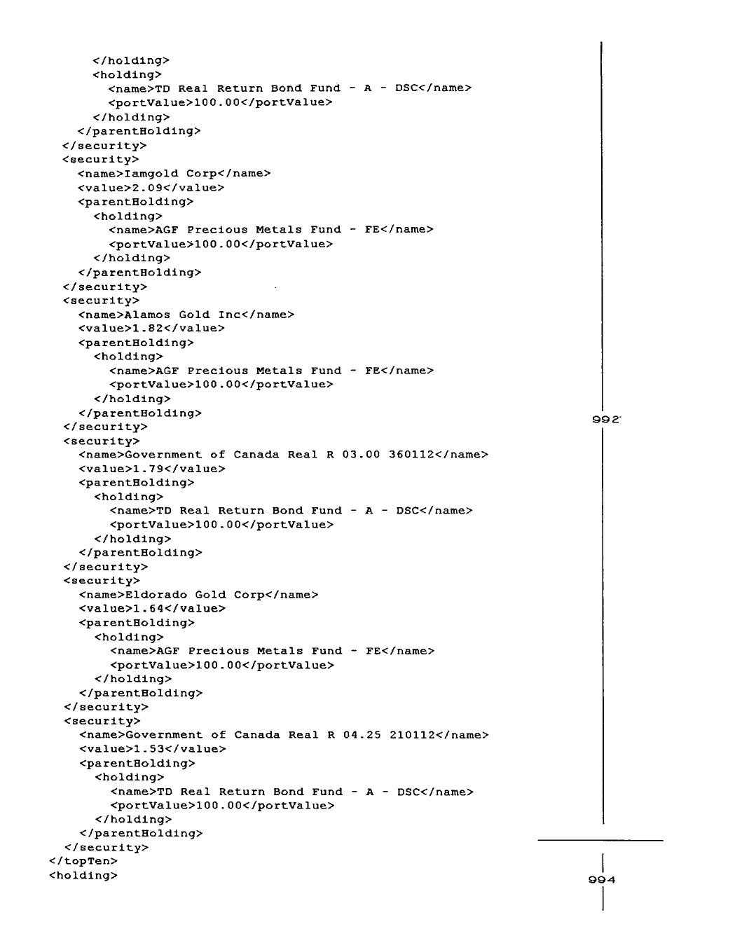

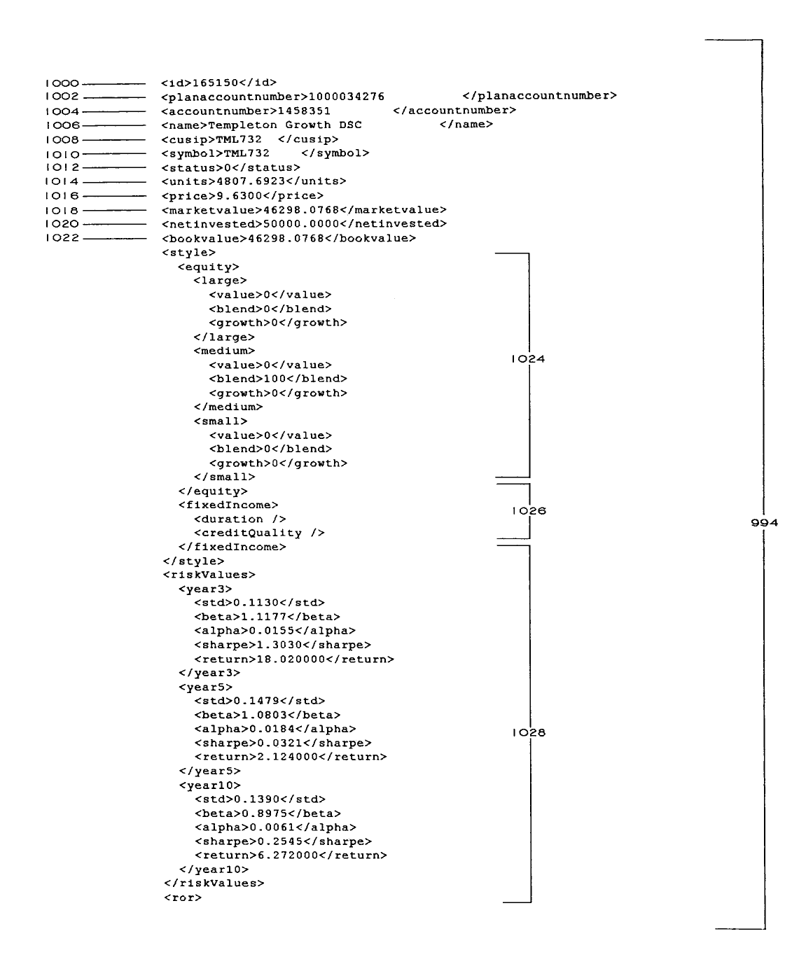

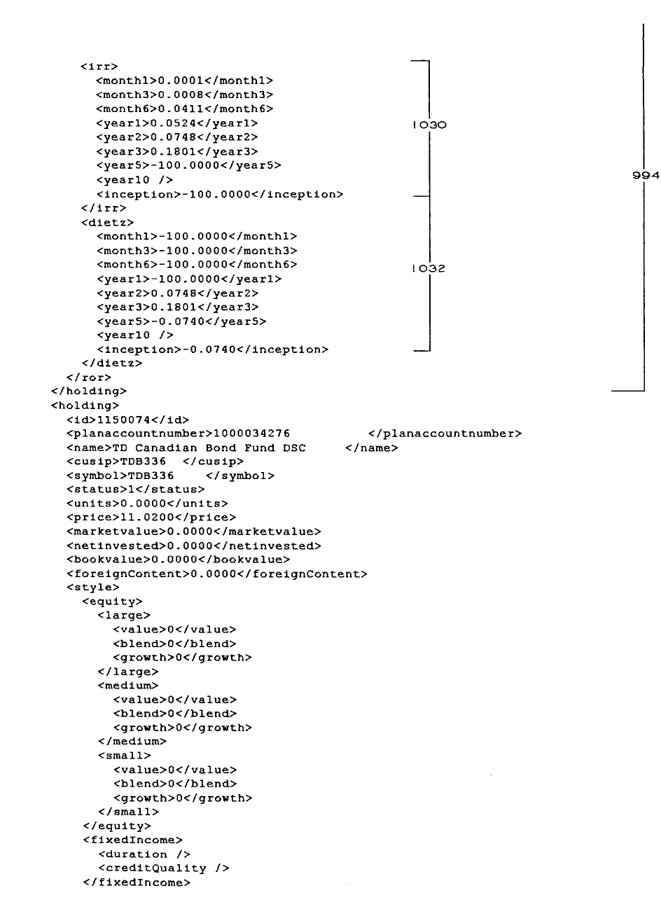

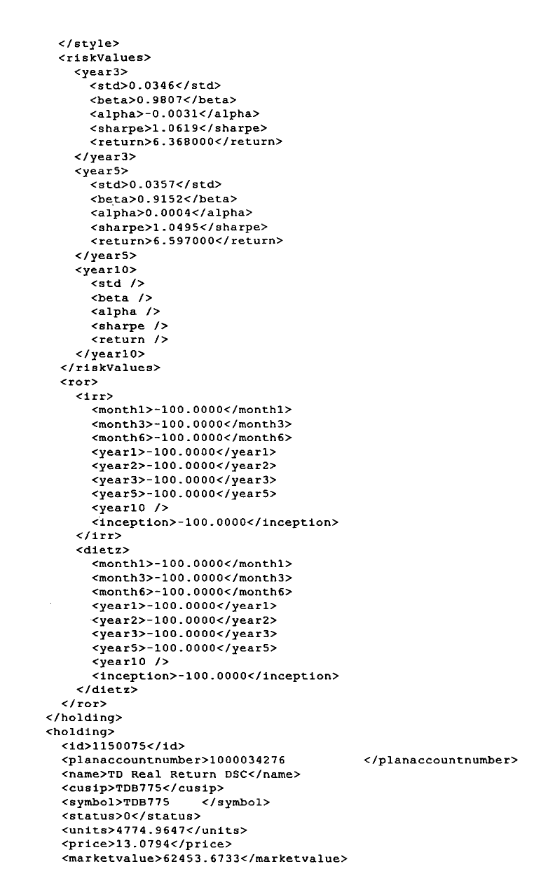

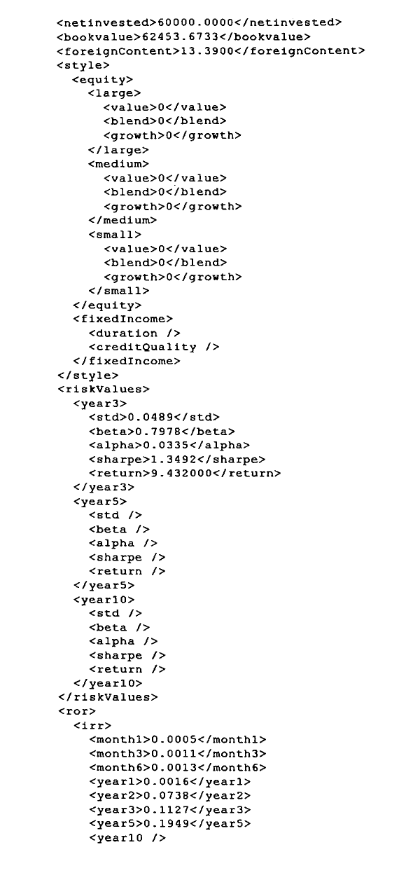

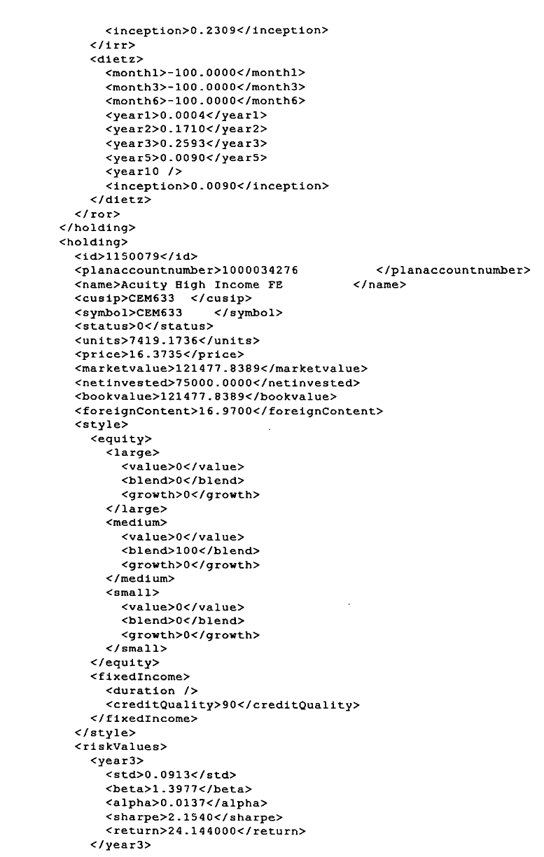

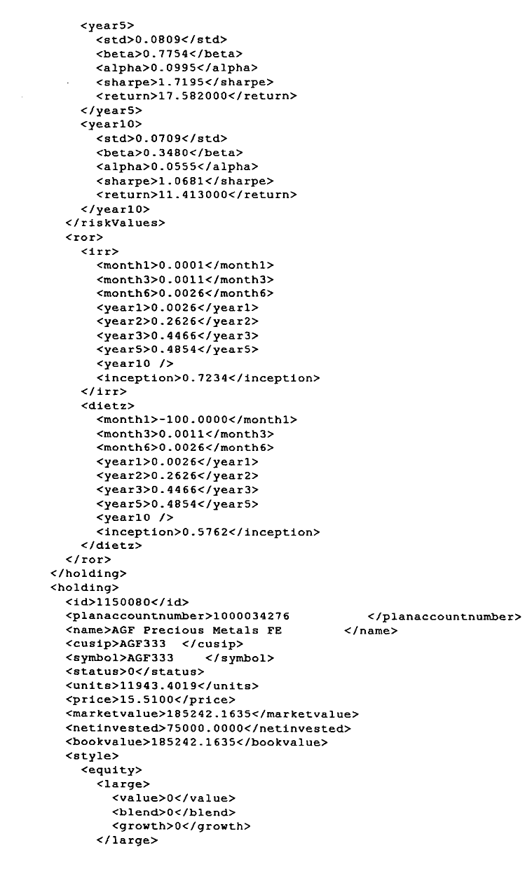

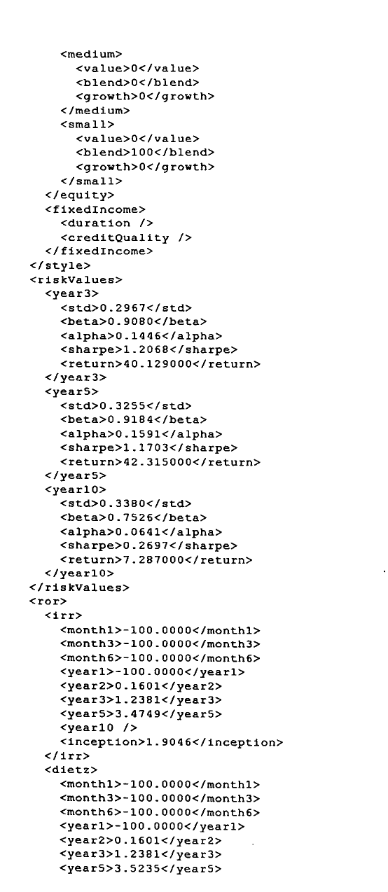

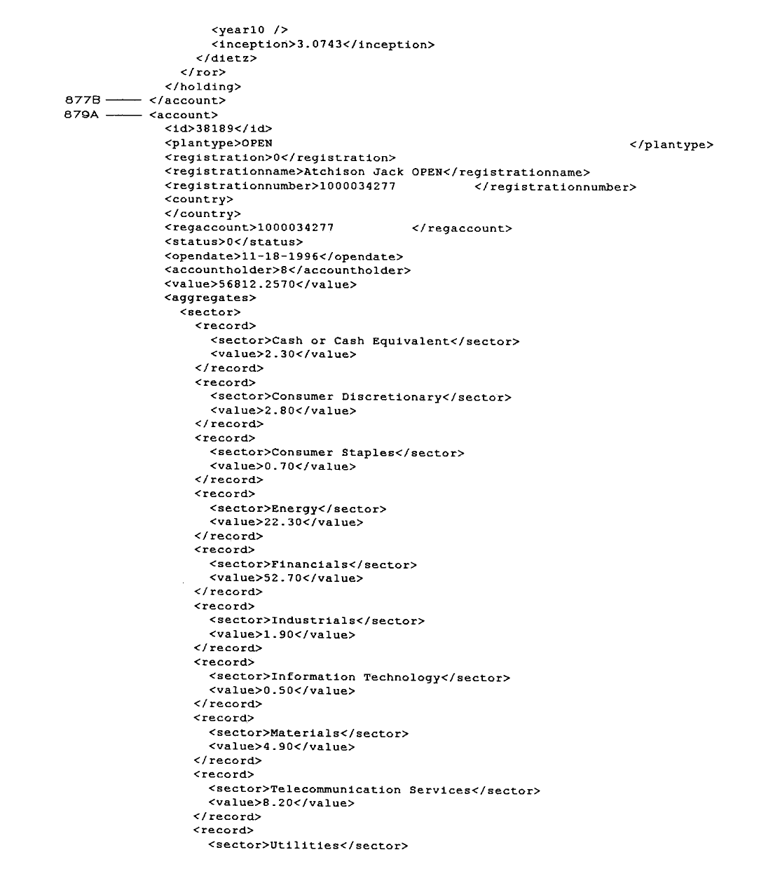

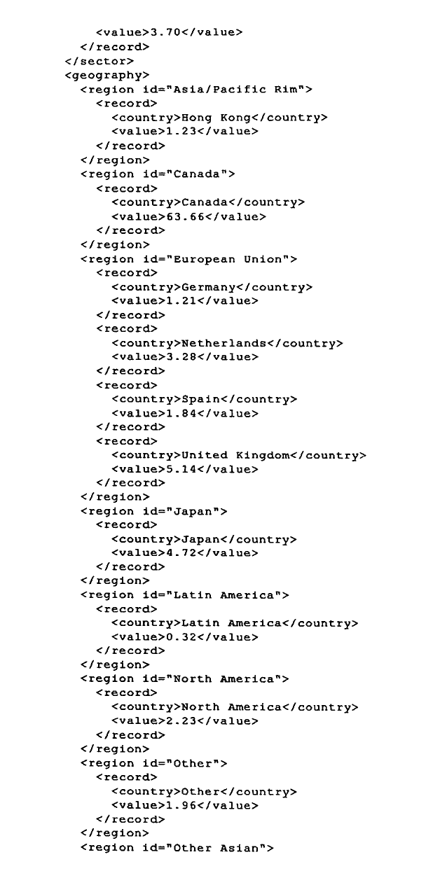

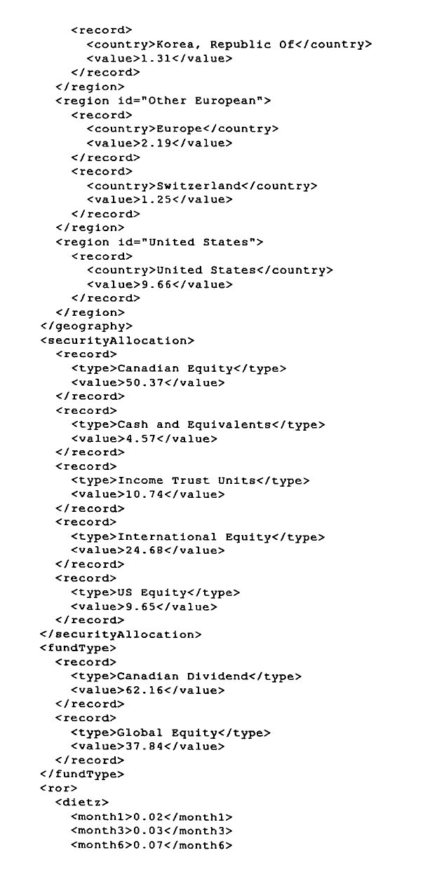

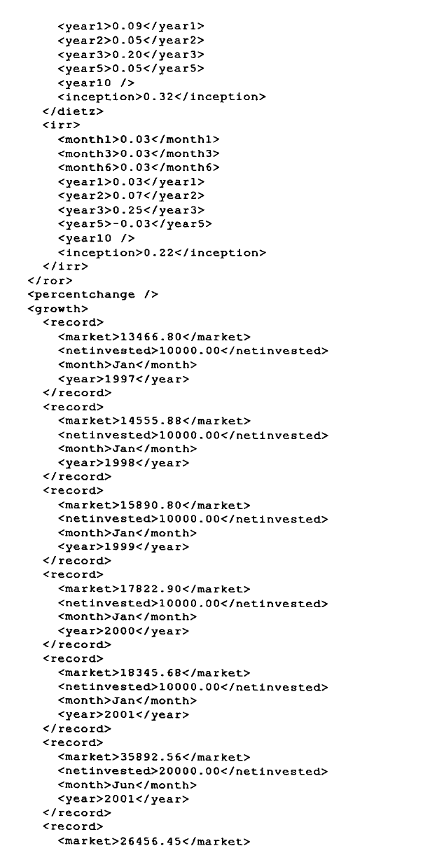

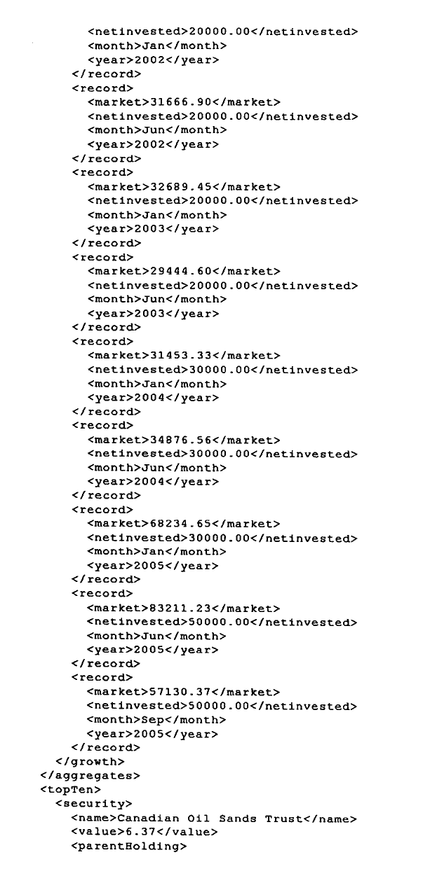

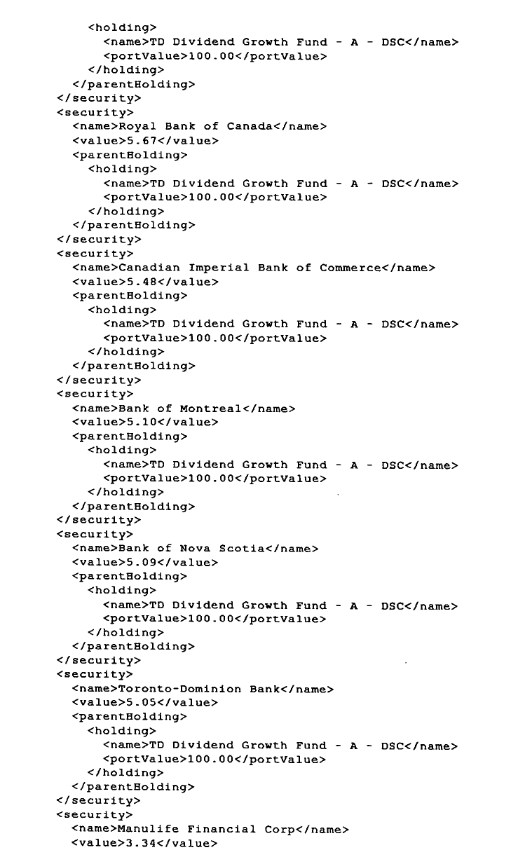

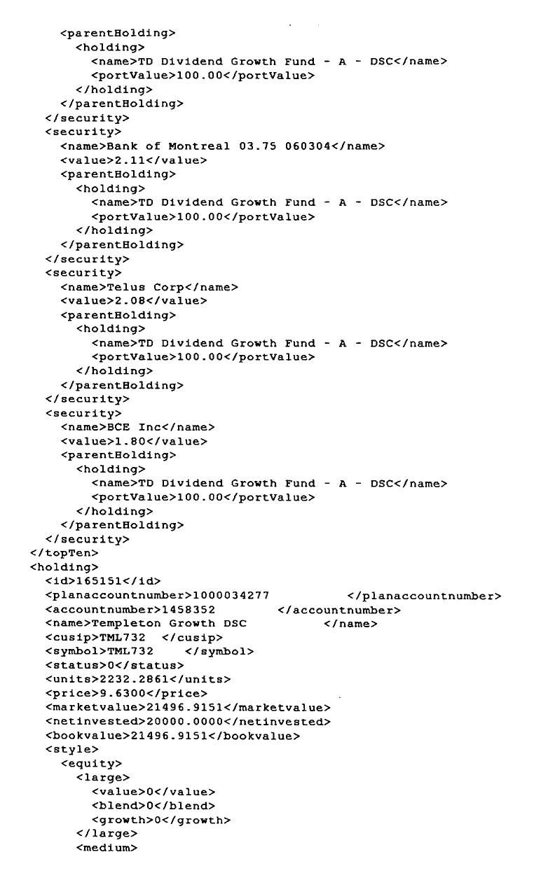

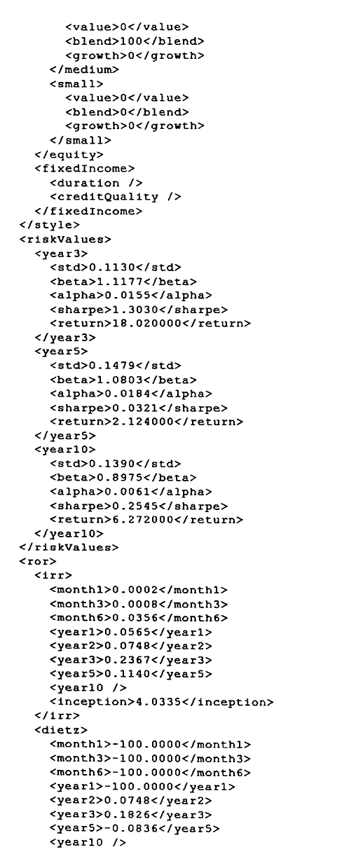

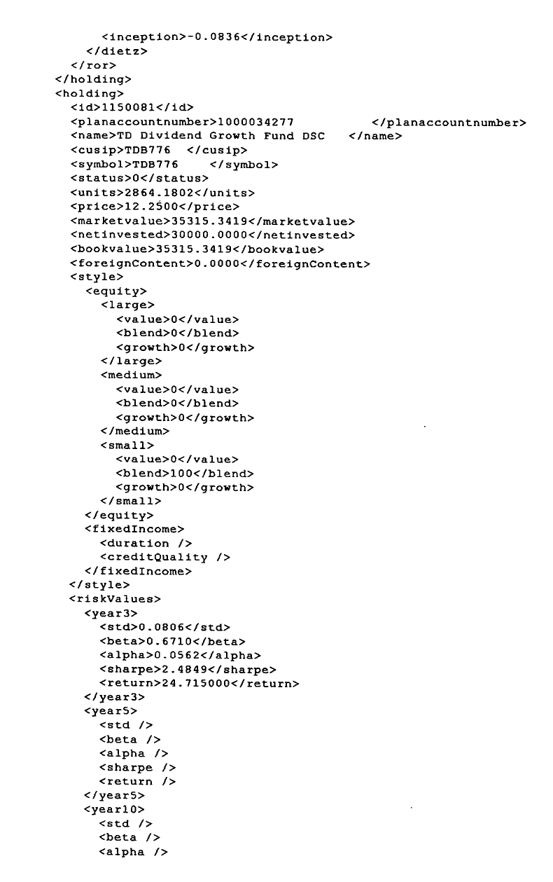

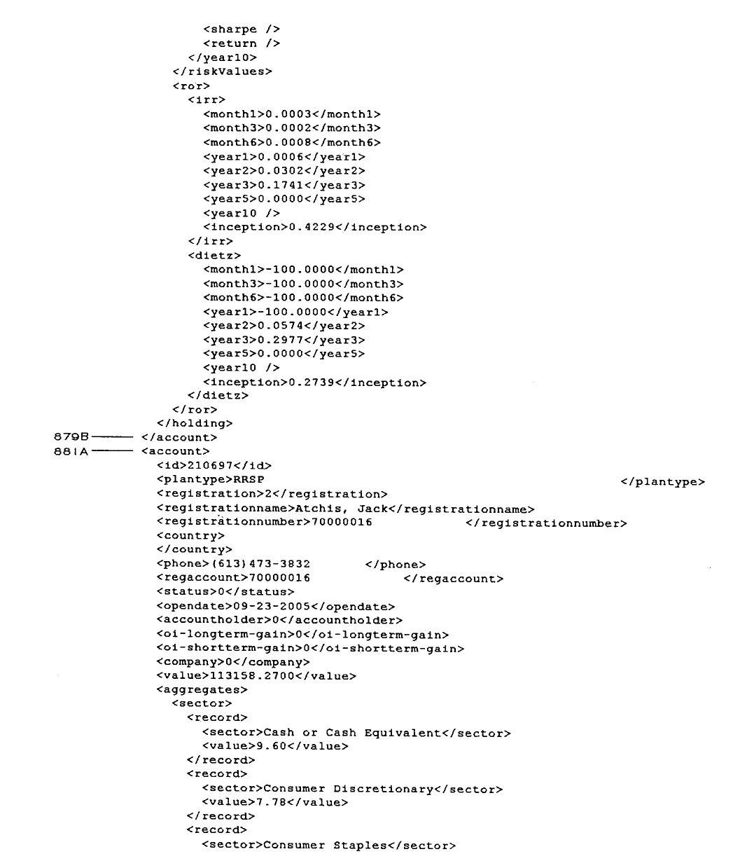

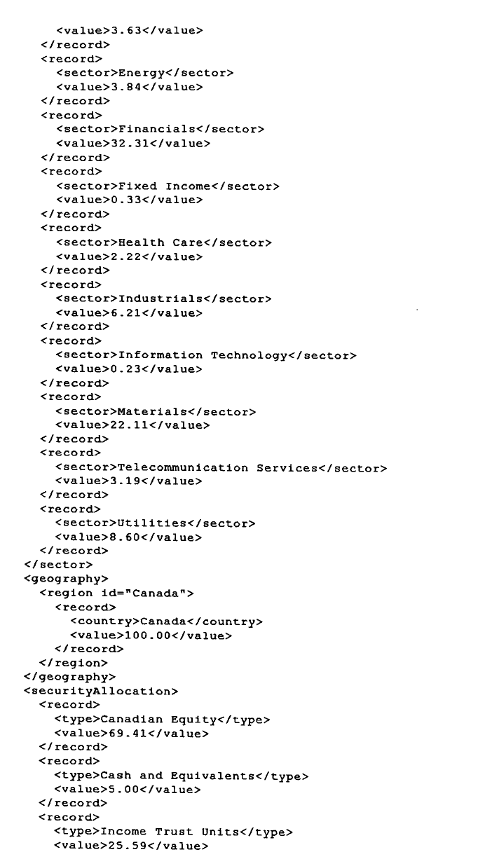

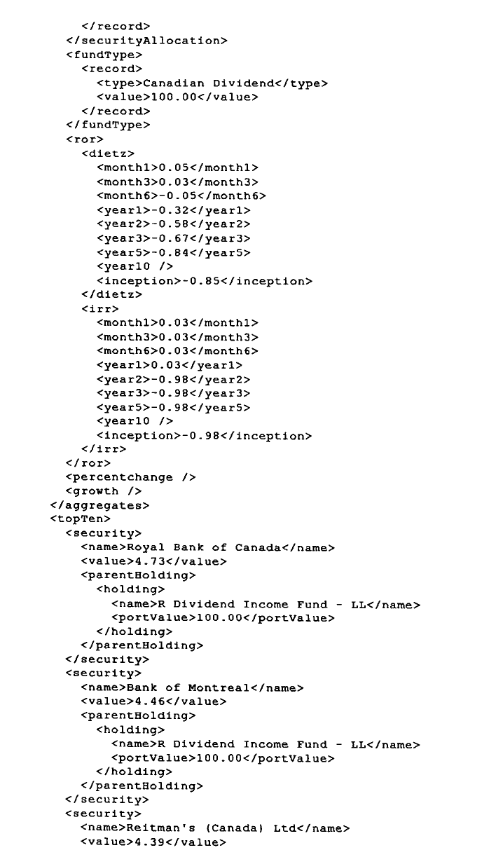

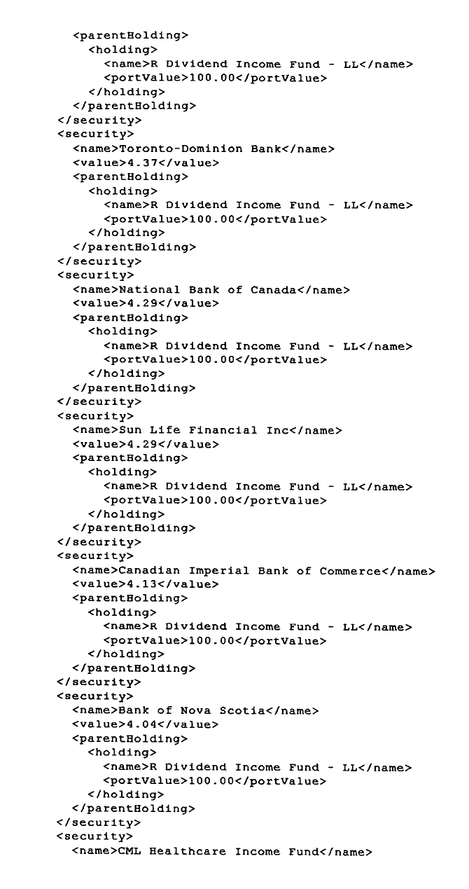

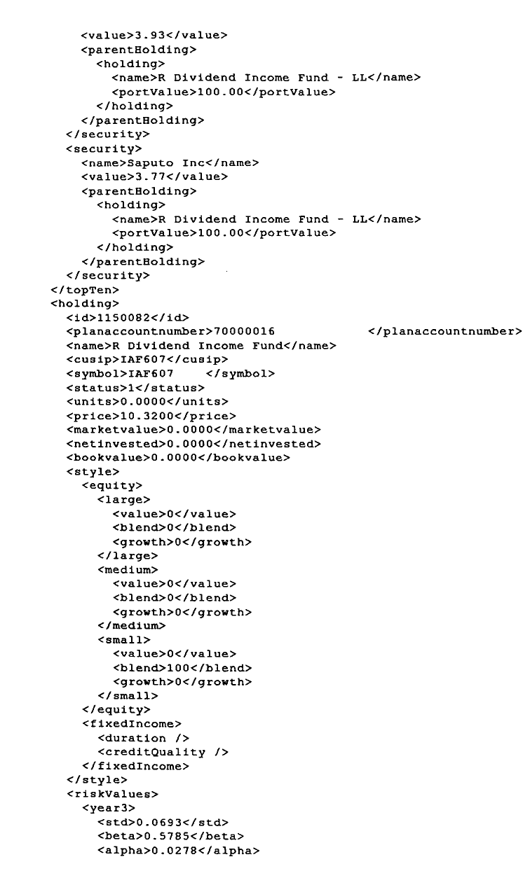

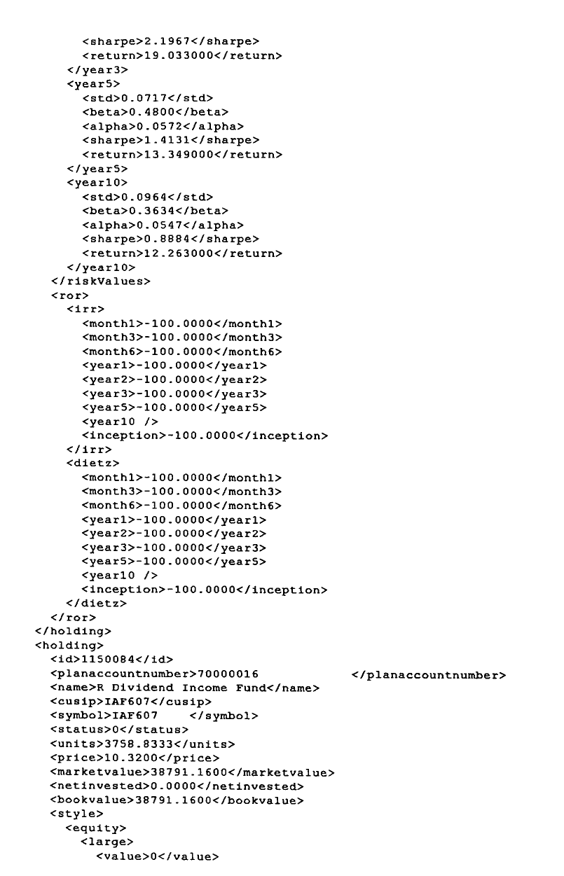

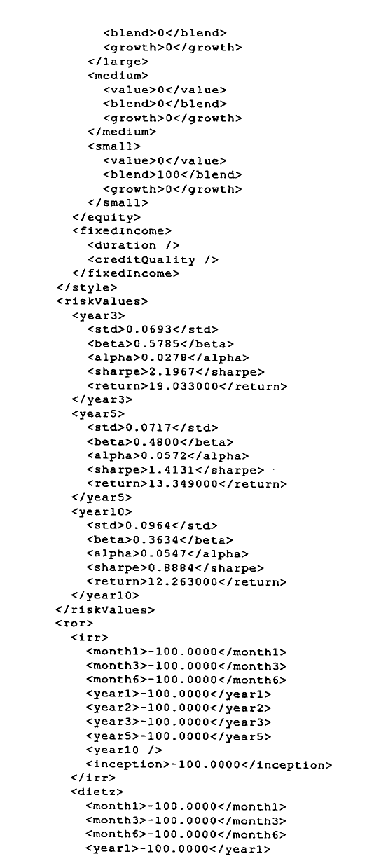

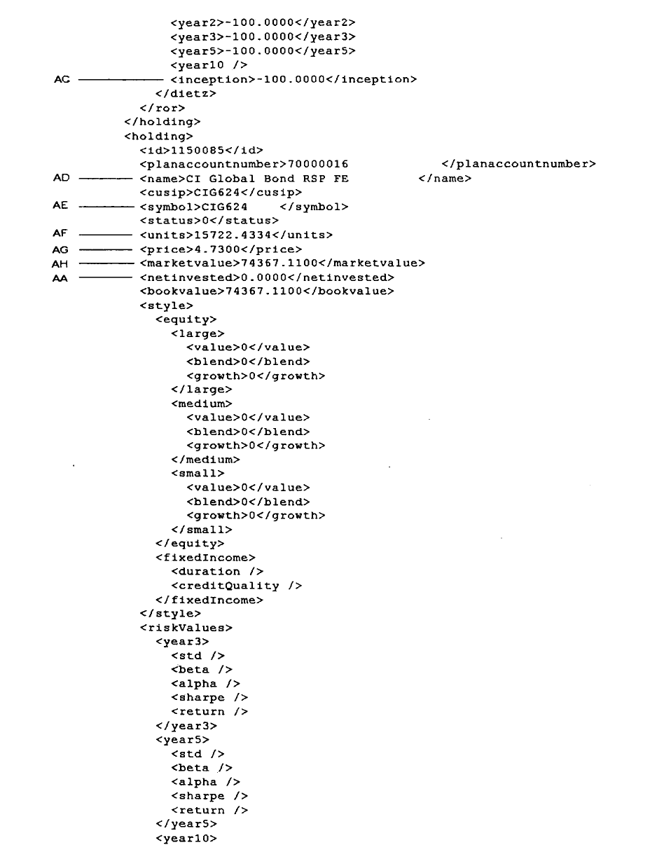

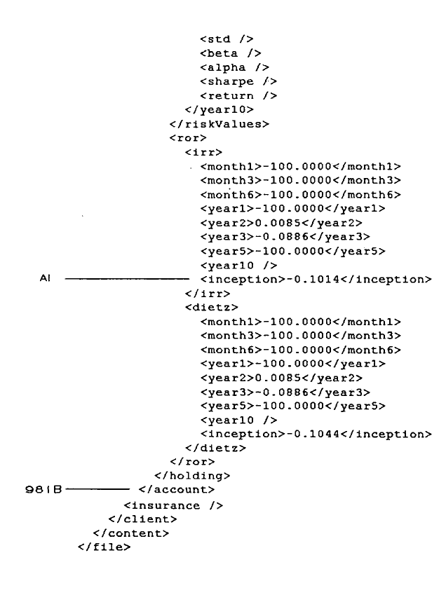

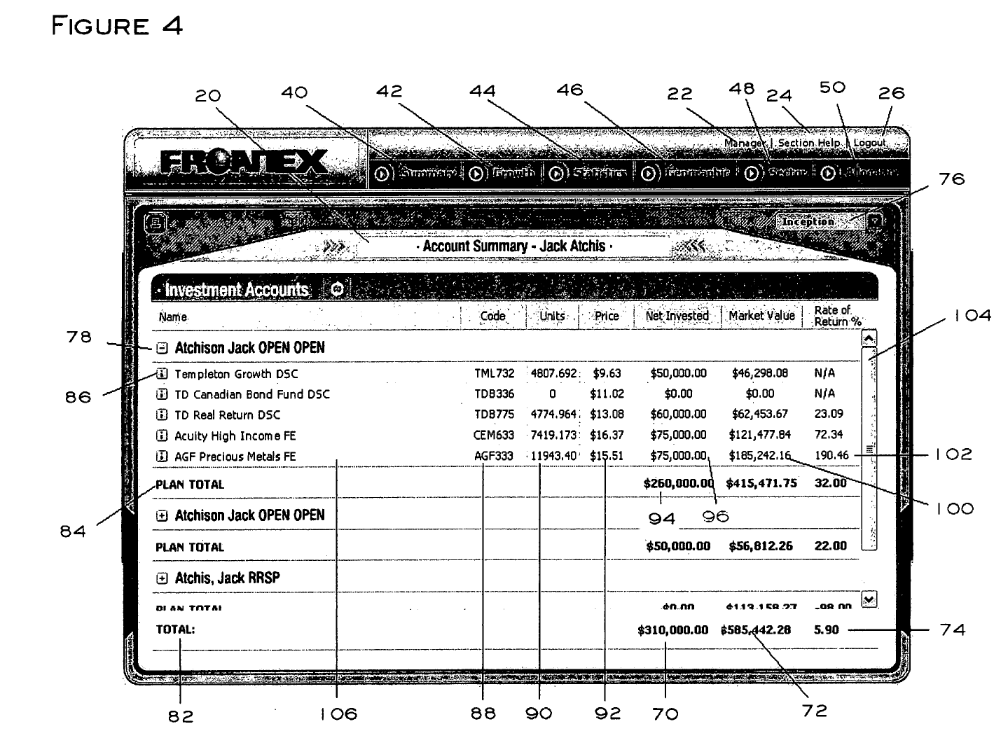

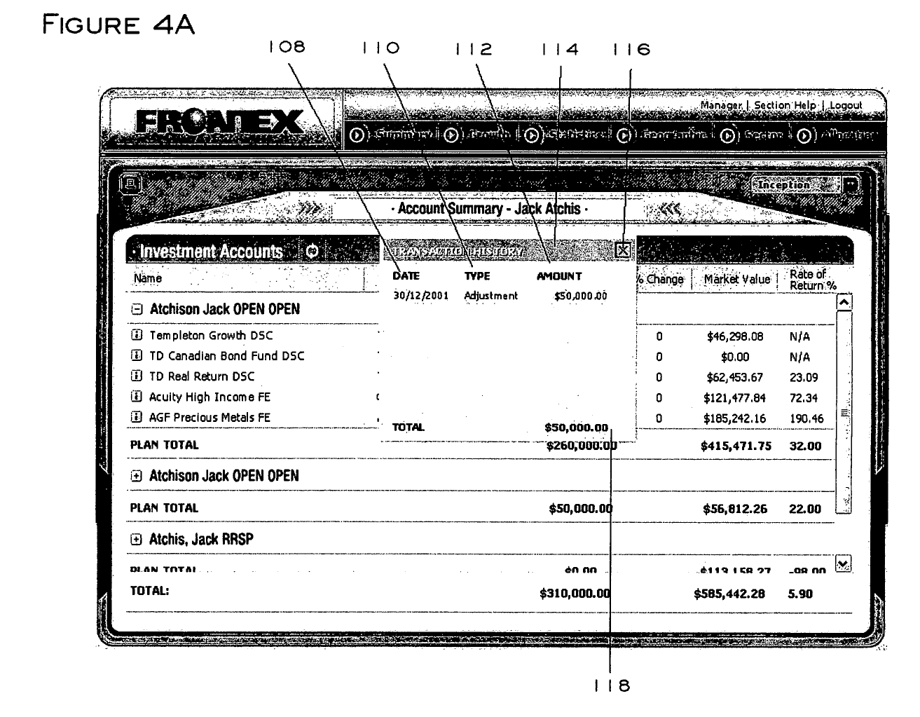

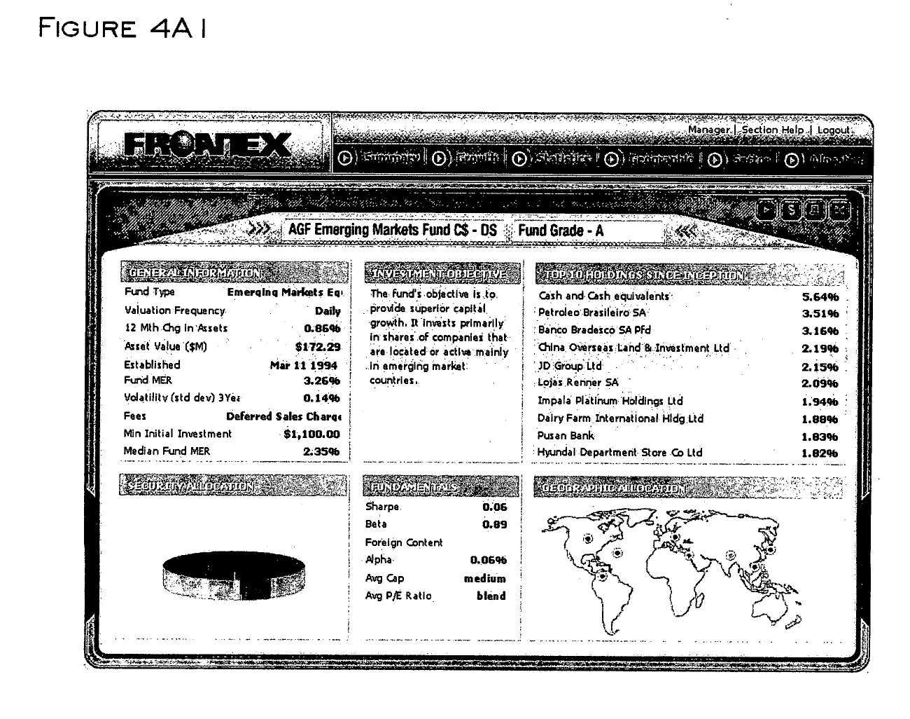

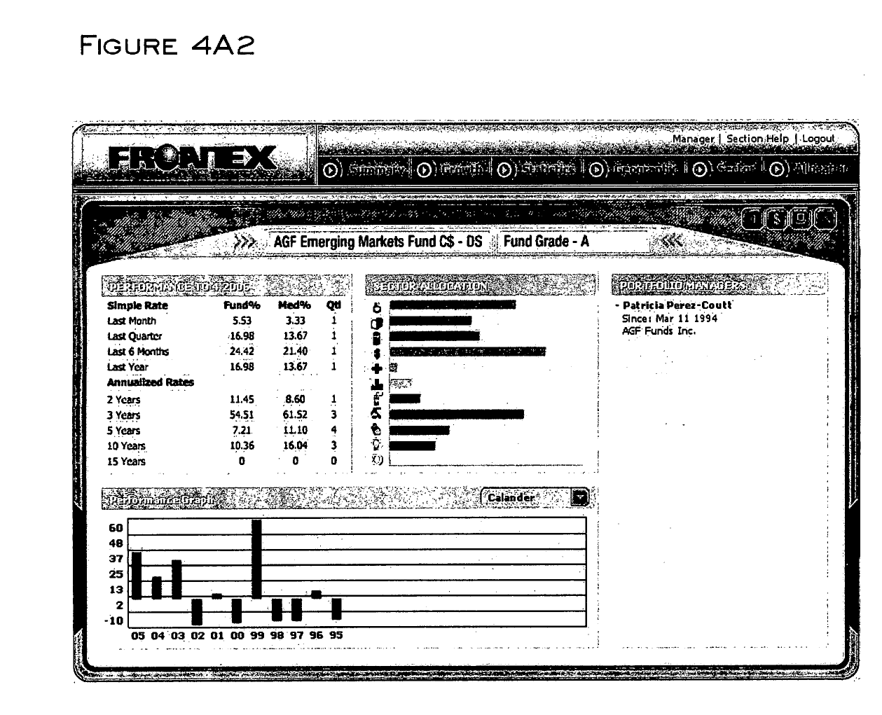

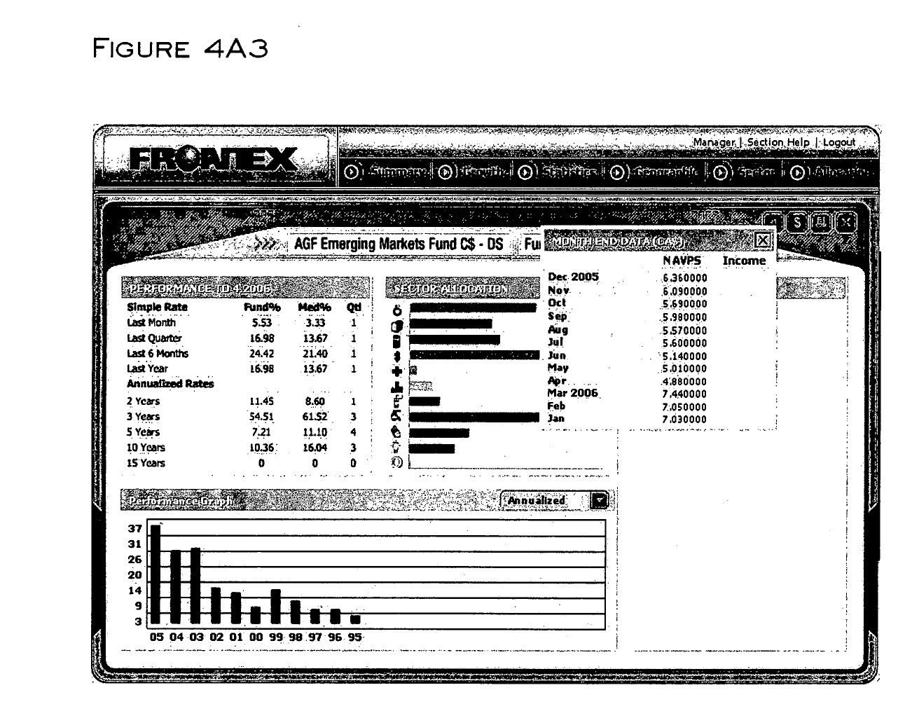

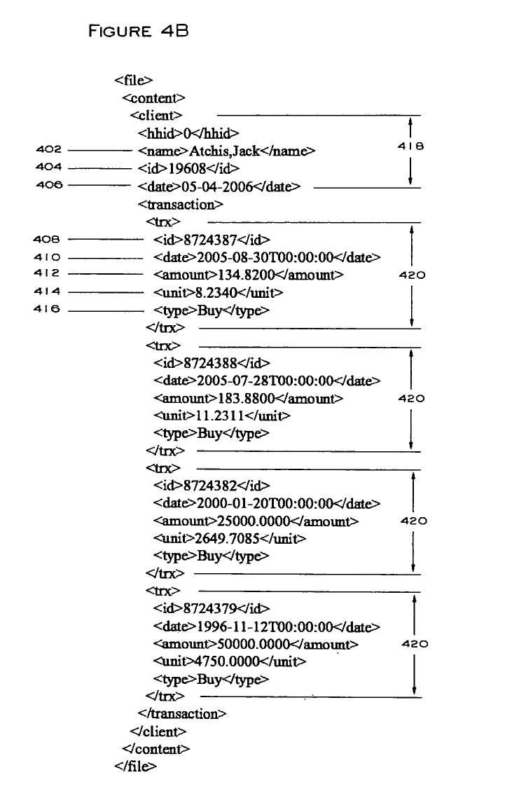

Referring again to the Account Summary screens of FIGS. 3 and 4, utilizing the data provided from the XML data file such as is illustrated in FIG. 3A, each investment account of the selected client is set out in a row in the table and the following table columns in FIG. 3 are filled with the following data (when the drop down box “Since Inception” is selected): Account Name 68 (from data in the “plantype” field 880 of the datafile), Plan Total Net Invested 58 (which is the calculated sum of the <netinvested> fields AA for each <holding>), Plan Total Market Value 62 (a precalculated <value> field AB of the datafile) and Plan Total (Rate of Return) 64 (a precalculated <inception> AC of the datafile). In respect of the TOTALS ROW 82, the Total Net Invested 70 is calculated by the Application and is the sum of Plan Total Net Invested 58 for the client, Total Market Value 72 is calculated by the Application and is sum of the Market Values 62 for the client, and the Total Rate of Return is calculated by the Application and is the weighted average of the Plan Total Rate of Returns. When the “One Month” selection is chosen from the drop down box, each value in the Rate of Return column is modified as follows: the Plan Total Rate of Returns are repopulated from data in the <month1> field in the XML and the Total Rate of Return is recalculated by the Application. When any other selection is chosen from the drop down box, a corresponding revision is made to the table.

In the preferred embodiment, data is not presented in the “code” 52, “units” 54, and “price” 56 columns unless the individual investments in a selected account are being presented, as described below.

Additional information in relation to a selected client's particular account presented in the Account Summary screen may be obtained by selecting/activating the detail button 78 or by selecting/activating the row corresponding to the account for which additional detail is sought, in a manner known to a person skilled in the art, which when selected/activated presents the user with the detailed account summary screen for that selected client's account as illustrated in FIG. 4. With reference to FIG. 4, detailed information in relation to the current holdings in each of the client's accounts is provided in table form, each row 106 in the table providing data in relation to each specific investment holding within the selected the client's identified investment account. For example, in the fifth row 106, the mutual fund (ie. “AGF Precious Metals FE, which data is supplied by the XML of FIG. 3A in field <name> AD”) is identified, along with its unique trading/identification code (ie. “AGF333”) 88 which data is supplied by the XML of FIG. 3A in field <symbol> AE”, the number of units currently held by that client in that account (ie. “11943.40”) 90 which data is supplied by the XML of FIG. 3A in field <units> AF”, the current market price for each unit (i.e. “$15.51”) 92 which data is supplied by the XML of FIG. 3A in field <price> AG”, the net investment of the specific client in that investment (i.e. $75,000.00) 96 which data is supplied by the XML of FIG. 3A in field <netinvested> AA”, the current market value of the client's investment (i.e. $185,242.16) 100 which data is supplied by the XML of FIG. 3A in field <marketvalue> AH” and the rate of return (i.e. 190.46) 102 which data is supplied by the XML of FIG. 3A in field <inception> AI”.

When the “One Month” selection is chosen from the drop down box, each value in the Rate of Return column is modified as follows: the Plan Total Rate of Returns are repopulated from data in the <month1> field in the XML and the Total Rate of Return is recalculated by the Application. When any other selection is chosen from the drop down box, a corresponding revision is made to the table.

In the event that the table length exceeds the available space in the window, the scroll button/arrows 104 may be utilized to view and access the entire table in a manner known to a person skilled in the art.

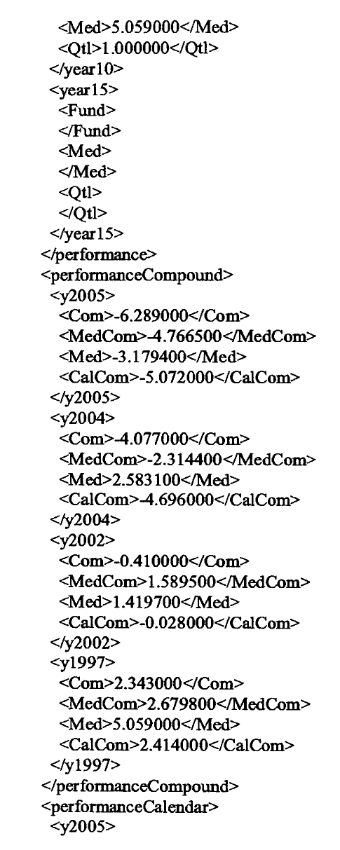

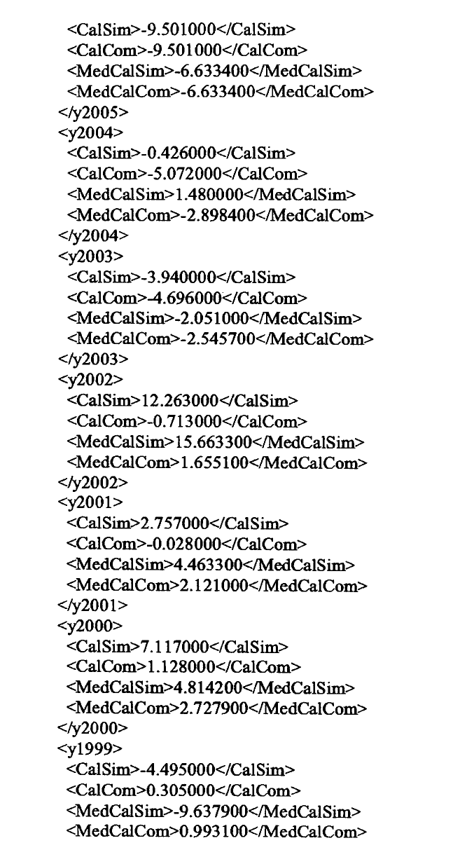

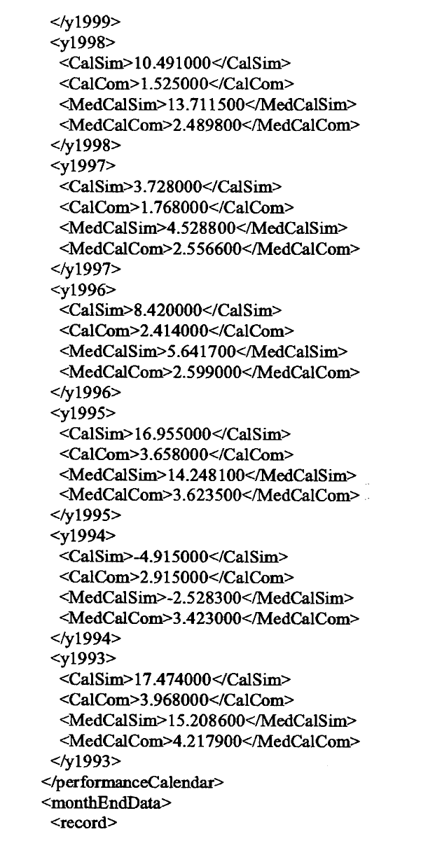

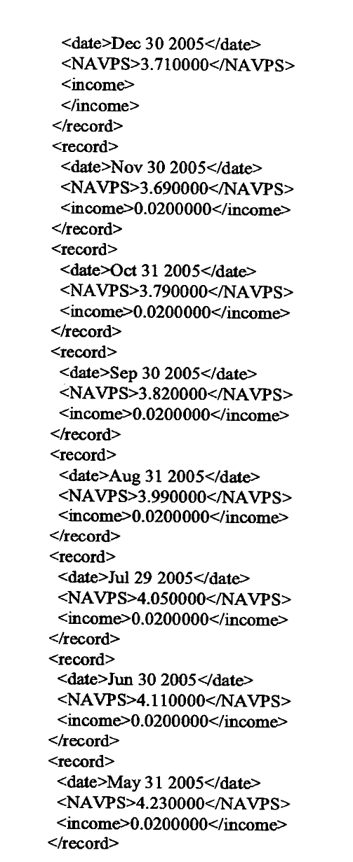

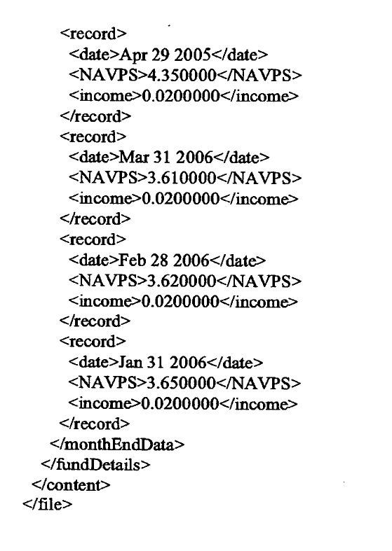

In relation to any particular investment within the account, by selecting/activating the Fund Data button 86, detailed information is provided via the Application, to the user in relation to the investment selected/activated as illustrated in FIGS. 4A1, 4A2 and 4A3 which information/data presented therein is obtained in the following manner: the Application sends a query to the General Investment Database, which database provides the Application with an XML data file in response thereto, the XML data file being such as illustrated in FIG. 10, the data/information being provided in the XML data file being utilized by the Application to generate the tables/charts illustrated in FIGS. 4A1, 4A2 and 4A3 in a manner known to a person skilled in the art.

To obtain data/information relating to the transaction history in respect of a particular investment, in a preferred embodiment, the user, by selecting/activating the row corresponding to the investment in respect of which the transaction history is desired, the Application presents the user with the Transaction History window 114 as illustrated in FIG. 4A in which details of the selected transaction, including the transaction date 108, transaction type 110 and the transaction amount 112 and the total transaction value 118 is presented to the user. The Transaction History window 114 may be closed by selecting/activating the close button 116.

The data presented in the Transaction History window of FIG. 4A is provided to the Application, in the preferred embodiment, in the following manner:
1. Application makes request to Client Investment Database for all transactions by that client for the selected investment;
2. In response to the request, the Application receives an XML data file such as is illustrated in FIG. 4B.

The XML data file of FIG. 4B provides investment transaction particulars of a specific client. With respect to the XML data file of FIG. 4B, the client information is set out in the first portion 418 of the file, followed by a table in which the client's transactions are particularized. The client information portion 418 has fields which contain data relating to a particular client investment, the field bracketed by the codes <name> and </name> containing the name of the client (“Atchis, Jack”), a field bracketed by the codes <date> and </date> containing the date that the XML was provided to the Application. Following the client information portion 418 of the file is a table, bracketed by the codes <transaction> and </transaction> the format of the table being known to persons skilled in the art, each row of the table 420 represents a transaction and is bracketed by the opening code <trx> and closing code </trx>, and each cell in a row is bracketed by the appropriate table column/cell codes. For example, in the first row, the first column/cell 408 is the transaction identification number “8724387”, which appears in the first cell 408 bracketed between the <id> and the </id> codes. Similarly, the second column/cell 410 in the first row is the date and time of the transaction “2005-08-30T00:00:00”, which appears in the second cell 410, bracketed by the codes <date> and </date>.

Similarly, the data in each column/cell in the first row 442 is bracketed by a pair of codes in the form of an opening code, having a format of <code> and a closing code, having a format of </code>, the third column/cell 412 containing data (“134.8200”) of the total dollar amount of the transaction (bracketed by the <amount> and </amount> codes), the fourth column/cell 414 containing data (“8.2340”) of the number of units which were the subject of the transaction, the fifth column/cell 416 containing data (“Buy”) indicating the type of the transaction. The second and following rows in the table are similarly arranged in the table, each row of client data being bracketed by the codes <trx> and </trx>. The data from the XML data file of FIG. 4B is used to prepare and present the data in the Transaction History window in a manner known to a person skilled in the art.

To populate the table in the Transaction History window 114, the date data 108 is supplied by the XML of FIG. 4B in field <date>410, the type data 110 is supplied by the XML of FIG. 4B in field <type>416, the amount data 112 is supplied by the XML of FIG. 4B in field <amount>412, and the total 118 is calculated by the Application as the sum of each of the client's transactions in respect of that investment.

### Portfolio Growth

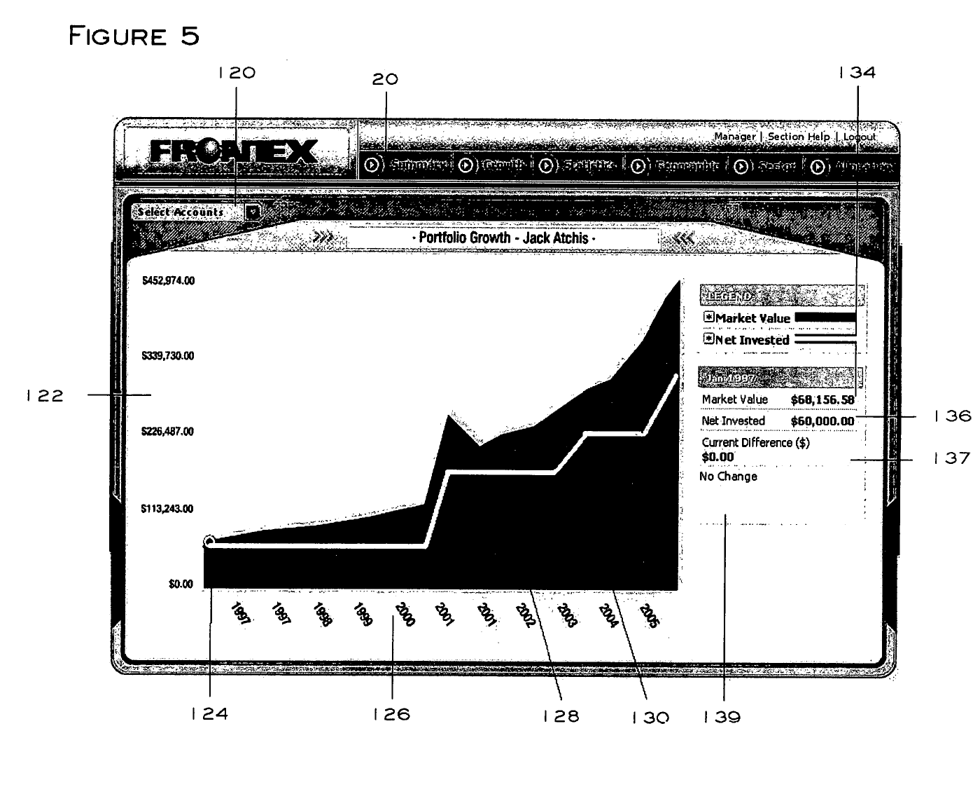

When a particular client's account has been selected, by thereafter selecting/activating the GROWTH BUTTON 42, a graphical representation of the client's historical data in relation to the account is presented as illustrated in FIGS. 5 and 5A, including the account's market value over time and net investment over time, with dollars amounts along the y-axis 122 and years/months along the x-axis 126. The data utilized to prepare the graphs and presented in the data fields 134, 136, 137 and 139 is obtained by the Application from the XML of FIG. 3A, in a manner known to a person skilled in the art. Specifically, the graphed market value data is obtained by the Application from the <market> fields in the <growth> node AJ of the XML of FIG. 3A and the net invested data is obtained by the Application from the <netinvested> fields in the <growth> node AJ. From these sets of data, the graphs of FIGS. 5 and 5A are generated by the Application in a manner known to a person skilled in the art. The data in the box 134 and 136 is obtained by the Application from the XML of FIG. 3A by selecting from the XML that data corresponding to that point 124 on the graph chosen by the user utilizing a computer mouse or other pointer device, whereupon the data in fields 134 and 136 are populated from such data, the field 137 is calculated by the Application as the difference between the amount in the box 134 and 136, and the field 139 is calculated by the Application as follows:

[(the current difference as set out in field 137)−(the difference between the “market value” and the “net invested” for that point in time for which data is provided in the XML which is immediately preceding the time for which the current data is provided)]/(the current difference as set out in field 137)

With reference to FIG. 5, the user may select one or more of a selected client's accounts to be graphed using the drop down box 120 (which presents the user with the choice of the client's different accounts (alone or combined with other of the client's accounts) to include in the graph and other data fields presented in this screen), whereupon the corresponding data from the XML is used by the Application to present graphs corresponding to such data and to perform corresponding calculations as previously described.

### Portfolio Statistics

In the preferred embodiment, by selecting the STATISTICS BUTTON 44, a “drop down” menu is presented as illustrated in FIG. 6A, from which the user may select one of the following buttons/options “PORTFOLIO PERFORMANCE” 148, “FUND CORRELATION” 150, “RISK VS. RETURN” 152 and “TOP HOLDINGS” 154.

By selecting the PORTFOLIO PERFORMANCE BUTTON 148, the user is presented with the Portfolio Performance screen as illustrated in FIG. 6A. In the screen window 20, the screen name “Portfolio Performance”, along with the client name is presented. In this screen, a chart is presented in histogram form (with time on the x-axis 140 and return on the y-axis 138) of each selected accounts performance and during the past month, three months, six months, one-year, two years, three years, five years and 10 years and from inception 144. In a preferred embodiment, using the drop down box 146, the user may choose which of the client's different accounts (alone or combined with other of the client's accounts) to include in the graph and other data fields presented in this screen.

As illustrated in FIG. 6A1, when the user passes their computer pointer over an element of the histogram, precise details of the information are provided in the details window 147. Where a single account is selected, the information displayed in the “Portfolio Performance” chart is obtained from the XML of FIG. 3A as follows: for the specific account AK chosen, for each time frame, the Application obtains the corresponding data from the <month1>, <month3>, <month6>, <year1>, <year2>, <year3>, <year5>, <year10> and <inception> fields of the XML. Where multiple accounts are chosen by the user, a weighted average is calculated for each of the corresponding rate of return fields in the accounts and the weighted average of the fields is presented in the graph and other data fields.

If the user selects/activates a particular bar in the bar graph of FIG. 6A, the Application presents a screen as illustrated in FIG. 6A2 in which each of the investments which were held by the client during the time frame to which the selected/activated bar represents, are represented in bar graph form. The data for this bar graph is obtained by the Application from the XML of FIG. 3A from the <irr> sub-sub node of the <ror> sub-node of the <holding> node AL.

By selecting the FUND CORRELATION BUTTON 150, the user is presented with the Fund Correlation screen as illustrated in FIG. 6B. In the screen name window 20, the screen name “Fund Correlation”, along with the client name is presented. In this screen, the user is presented, in partial table form, with the correlation of each of the investments in all of the client's accounts against all of the other investments in the client's accounts (in the partial table form, each of the investments being listed on the y-axis 512 of the table, and also on the x axis 510 of the table, it being understood that to avoid unnecessary information being presented, the correlation of one investment to itself is not presented, and similarly, duplicative correlations are not presented) each of the investments being identified as falling within one of the following categories, namely “highly positive correlation” (for those investments having a positive correlation of between 0.75 and 1.00), “positive correlation” (for those investments having a positive correlation of between 0.25 and 0.75), “low correlation” (for those investments having a correlation of between −0.25 and 0.25), “negative correlation” (for those investments having a correlation of between −0.25 and −0.75) and “highly negative correlation” (for those investments have been correlation of between −0.75 and −1.00). In addition, where no correlation information is available, it is identified as “n/a”. For example, the correlation between the “Acuity High Income FE” investment and the “TD Real Return DSC” is shown to be “−0.035” 506 as displayed in the table cell 506.

To access the Application's definition of “Correlation”, the user may select/activate the information icon 502, whereupon the Application's definition of correlation is provided to the user in a definition window 510, as illustrated in FIG. 6B1 (which window may be closed by selecting/activating the window closure button 512). The fund correlations are color-coded according to the legend 504 appearing at the top of the window, and each of the cells in the table is colored to correspond to the correlation, as provided in the legend 504.

The data/information displayed in the “Fund Correlation” table is obtained by the Application in the following manner:
1. The Application makes a request to Client Investment Database, to provide information as to the investments that the particular client has, which information is provided to the Application;
2. With this information, the Application makes a request to the General Investment Database for the correlation data in respect of these investments, which information is provided to the Application in the form of an XML, such as illustrated in FIG. 6B.

The XML of FIG. 6B provides information, including any correlation information, in relation to each investment of the client. The XML includes data relating to the client's name, 700, identification, 702, date of the creation of the XML, 704, and on a investment by investment basis, specific information, including correlation information, in relation to that investment (for example, in relation to the Templeton Growth DSC investment, the following information is provided: ID number, 706, plan account number, 708, account number, 710, name, 712, CUSIP, 714, symbol, 716, fundata ID 718, status, 720, units, 722, Price, 724, market value, 726, net invested, 728, book value, 730, and correlation data 732 through 744 and thereafter (the correlation data being provided in the XML being each investment of the client, against every other investment of the client). The Application parses the data provided in the XML in a manner known to a person skilled in the art, and generates the graph shown in FIG. 6B in a manner known to a person skilled in the art. The user may select the accounts to be included in the table, which selection will be used by the Application to select and present in the table, the corresponding data from the XML.

By selecting the RISK VS. RETURN BUTTON 152, the user is presented with the Risk vs. Return screen as illustrated in FIG. 6C. In the screen name window 20, the screen name “Risk vs. Return”, along with the client name is presented. In this screen, a graph is presented, with Risk (in percent standard deviation) is presented on the x-axis 154 and percent return on the y-axis 150, with a different colored “X” 152 denoting each of the different investments 158 within the portfolio as listed in the legend 156 (a corresponding colored “X” appearing next to the name of the applicable investment in the legend 156). The user may scroll through the list of investments in the legend utilizing the scrolling button and arrows 160. In a preferred embodiment, using the drop down box 162, the user may choose which of the client's different accounts (alone or combined with other of the client's accounts) to include in the graph and other data fields presented in this screen. As illustrated in FIG. 6C1, when the computer mouse or pointer selects a specific “x” on the graph/chart, a details window 184 opens immediately above the “x” in which the precise coordinates of the “x” are provided, giving the user precise information as to the percentage return and percentage risk, which in the case of the “x” selected in FIG. 6C1 is “18.02%−11.3%”. In addition, the name of the investment is highlighted in the legend 186, and the following additional information in relation to the investment is provided in a supplementary window 188, namely: standard deviation 190, Beta 192, Alpha 194, and Sharpe data 196.

The information displayed in the “Risk vs. Return” table is obtained by the Application in the following manner: From the XML data file of FIG. 3A (which was previously cached by the Application), data from the Risk Values node (for example, AK) for each investment is parsed by the Application, and used by the Application to generate the graph presented in FIGS. 6C and 6C1 in a manner known to a person skilled in the art. The user may select the accounts to be included in the table 162, which selection will be used by the Application to select and present in the table, the corresponding data from the XML.

By selecting the TOP HOLDINGS BUTTON 154, the user is presented with the Top Holdings 154 screen as illustrated in FIG. 6D. In the screen-name window 20, the screen name “Top Holdings”, along with the client name is presented. In addition, the screen presents a table in which the top stocks, bonds, or other holdings 171 in any client's selected account are provided along with the percentage 172, the table being sorted from highest to lowest percentage of stock, bonds or other holdings. In a preferred embodiment, using the drop down box 168, the user may choose which of the client's different accounts (alone or combined with other of the client's accounts) to be taken into account in this screen As illustrated in FIG. 6D1, by selecting/activating the Expand Button 170 adjacent to any particular stock, bond or other holding, the name of the investment fund or funds in which that stock, bond or other holding is held, is/are displayed, along with the percentage 173 of the client's interest in that stock, bond or other holding is held by that/those investment fund/s. In the event that the table length exceeds the available space in the window, the scroll button/arrows 182 may be utilized to view and access the entire table in a manner known to a person skilled in the art. The information displayed in the “Top Holdings” table is obtained by the Application in the following manner: in the preferred embodiment, in response to a query by the Application to a third party organization which has access to both the General Investment Database and the Client Investment Database (which in the case of the preferred embodiment, is the same third-party organization that stores and makes available to the Application data from the Client Investment Database), the third-party organization performs the calculation referred to above as follows:

Σ[(Market value of the investment)/(market value of the account)]×(percentage weighting of the security in the investment)

the results of which calculations are provided to the Application in the form of the XML of FIG. 3A, as illustrated at 992. This information/data is utilized by the Application to generate the table illustrated in FIG. 6D in a manner known to a person skilled in the art. The user may select the accounts in respect of which the Top Holdings are determined, in which case, the Application calculates the Top Holdings across the selected accounts by the following calculation:

Σ[(Market value of the account)/(market value of the combined selected accounts)]×(percentage weighting of the security in the account)

This information/data is utilized by the Application to generate the table illustrated in FIG. 6D in a manner known to a person skilled in the art

To obtain the Total 180 shown in FIG. 6D1, all of weightings of the Top Holdings are summed by the Application in a manner known to a person skilled in the art, and the Application reports this sum in the Total field 180. This figure represents the percentage of the selected account(s) which are held in the Top Holdings.

### Geographic Allocation

In the preferred embodiment, by selecting the GEOGRAPHIC BUTTON 46, a screen such as the one illustrated in FIG. 7 is presented to the user. In the screen window 20, the screen name “Geography”, along with the client name is presented. A stylized map of the world is also presented, with circular markers positioned thereon, denoting the different regions of the world. In the preferred embodiment, the following regions are included, namely North America, South America, European Union, Japan, China, Australia, Africa, other, it being understood that in alternative embodiments, different classifications of the regions of the world may alternatively be utilized. The North American circular marker 202 denotes North America, and the European Union circular marker 208 denotes the European Union. The other regions include Other Europe, Latin America, Africa-Middle East, other Asia, Japan, Pacific Rim and other. Additionally, a color-coded three-dimensional “pie graph” 204 is provided. When the user passes their computer pointer over one of the circular markers, for example the European Union circular marker 208 (or alternatively, passes their computer pointer over that segment of the pie graph 204 corresponding to that region), a detail information window 222 is opened above the pie graph 204 providing detailed information as to the percentage of the client's portfolio held in that region (in the example illustrated in FIG. 7A, the amount is displayed as “European Union 7.46%”). Additionally, a legend window 210 is opened in which the following fields of data are provided to the user: “Geographic Region” 212 (in the example illustrated in FIG. 7A, it is identified as the “European Union”), “Percentage of Portfolio” 214 (in the example illustrated in FIG. 7A, it is identified as “7.46%”) and “Regional Breakdown” 216 (in the example illustrated in FIG. 7A, the first entry is “Belgium” 218 and the percentage of the client's portfolio held in Belgian holdings is identified as “0.16%” 220). Using the drop-down window 200, the user may select one or more of the accounts to the displayed.

The information displayed in the “Geography” screen is obtained by the Application in the following manner: in the preferred embodiment, in response to a query by the Application to a third party organization which has access to both the General Investment Database and the Client Investment Database (which in the case of the preferred embodiment, is the same third-party organization that stores and makes available to the Application data from the Client Investment Database), the third-party organization performs the calculation referred to above as follows:

Σ[(Market value of the investment)/(market value of the account)]×(percentage weighting in the country)
This calculation, which utilizes data from both the Client Investment Database and the General Investment Database gives the percentage weighting of each country in an account of the client.
For each region the following calculation is performed by the third party organization:

Σ[percentage weighting of each country in a region]
This calculation gives the percentage weighting in a region in an account of the client.
This information is used to generate the diagram data shown in FIG. 7 and FIG. 7A.
   the results of which calculations are provided to the Application in the form of the XML of FIG. 3A, as illustrated at 926 through 960. This information/data is utilized by the Application to generate the table illustrated in FIGS. 7 and 7A in a manner known to a person skilled in the art. The user may select the accounts in respect of which the Geographic Allocations are determined, in which case, the Application calculates the Geographic Allocations for each country across the selected accounts by the following calculation:

Σ[(Market value of the investment)/(market value of the combine selected account)]×(percentage weighting of the country)
This calculation, which utilizes data from both the Client Investment Database and the General Investment Database gives the percentage weighting of each country in the selected accounts of the client.
For each region the following calculation is performed:

Σ[percentage weighting of each country in a region]
This calculation gives the percentage weighting in a region in the selected accounts of the client.

This information/data is utilized by the Application to generate the table illustrated in FIGS. 7 and 7A in a manner known to a person skilled in the art.

### Sector Allocation

In the preferred embodiment, by selecting the SECTOR BUTTON 48, a screen such as the one illustrated in FIG. 8 is presented to the user. In the screen name window 20, the screen name “Sector Allocation”, along with the client name is presented. Additionally, a chart in the form of a histogram is presented, different investment sectors being presented the long the y-axis 230, such as consumer discretionary 226, consumer staples, energy, financials, healthcare, industrials, information technology, materials, telecommunication services, utilities and other, and the percentage of the client's investments held in each of these sectors is presented on the x-axis 232. In addition, a legend window 234 is presented, in which each of these sectors is listed, along with the percentage of the value of the client's investments presently being held in that sector. For example is illustrated in FIG. 8, the percentage of the value of the client's investments presently being held in the “Consumer Discretionary” sector 236 is shown in the legend window 234 to be “4.6%” 238. Additionally, the total percentage 240 of the value of the client's investments in all of the sectors is displayed (to the extent that this totally is other than 100% is a result of imprecise or rounded data being provided by the data suppliers). As illustrated in FIG. 8A, if the user passes their computer pointer over one of the bars in the bar chart, a detail window 242 is opened, in which precise information relating to that sector is provided, which in the example illustrated in FIG. 8A is “Energy 11.7%” 242. Using the drop-down window 224, the user may select one or more of the accounts to the displayed.

The information displayed in the “Sector Allocation” screen is obtained by the Application in the following manner: in the preferred embodiment, in response to a query by the Application to a third party organization which has access to both the General Investment Database and the Client Investment Database (which in the case of the preferred embodiment, is the same third-party organization that stores and makes available to the Application data from the Client Investment Database), the third-party organization performs the calculation referred to above as follows:

Σ[(Market value of the investment)/(market value of the account)]×(percentage weighting of the sector)
This calculation, which utilizes data from both the Client Investment Database and the General Investment Database gives the percentage weighting of each Sector in an account of the client.

The results of these calculations are provided to the Application in the form of the XML of FIG. 3A, as illustrated at 900 through 924. This information/data is utilized by the Application to generate the table illustrated in FIGS. 8 and 8A in a manner known to a person skilled in the art. The user may select the accounts in respect of which the Sector Allocations are determined, in which case, the Application calculates the Sector Allocations for each sector across the selected accounts by the following calculation:

Σ[(Market value of the account)/(market value of the combined selected accounts)]×(percentage weighting of the sector)

This information/data is utilized by the Application to generate the table illustrated in FIGS. 8 and 8A in a manner known to a person skilled in the art.

### Allocations

In the preferred embodiment, by selecting the ALLOCATION BUTTON 50, a “drop down” menu is presented as illustrated in FIG. 9, from which one of the buttons and options “Security Allocation”, “Equity Style”, “Fixed Income Style”, and “Fund Allocation” may be selected.

By selecting the “Security Allocation” 244 button, the user is presented with the Security Allocation screen as illustrated in FIG. 9A. In the screen name window 20, the screen name “Security Allocation”, along with the client name is presented. Additionally, a “pie chart” 254 is presented, the pie graph 254 providing a visual representation of the client's investments broken down into the type of holding, namely “Cash and Equivalent”, “Canadian Equity”, US Equity”, “International Equity”, “Domestic Bonds”, “Income Trust Units”, and “Other”. In addition, a legend window 256 is provided, which lists the different types of holdings, along with the percentage of the client's investments which are held in such holdings. For example, as illustrated in the legend window 256, the client's International Equities 260 account for 12.69% 258 of the client's overall investment portfolio, and is represented in the pie graph as segment 262. Additionally, referring to FIG. 9B, if the user passes their computer pointer over one of the segments in the pie chart 262, a detail window 264 is opened, in which precise information relating to that segment is provided, which in the example illustrated in FIG. 9B is “International Equity 12.69%” 264. Using the drop-down window 252, the user may select one or more of the accounts to the displayed.

The information displayed in the “Security Allocation” screen is obtained by the Application in the following manner: in the preferred embodiment, in response to a query by the Application to a third party organization which has access to both the General Investment Database and the Client Investment Database (which in the case of the preferred embodiment, is the same third-party organization that stores and makes available to the Application data from the Client Investment Database), the third-party organization performs the calculation referred to above as follows:
For each security type the following calculation is performed by the third party organization:

Σ[(Market value of the investment)/(market value of the account)]×(percentage weighting of the security type)
This calculation gives the percentage weighting of each security type in an account of the client and is provided to the application in the form of the XML of FIG. 3A as illustrated at 962 through 976. This information is used to generate the diagram and table shown in FIG. 9A and FIG. 9B in a manner known to a person skilled in art.

The user may select the accounts in respect of which the Security Allocations are determined, in which case, the Application calculates the Security Allocations for each security type across the selected accounts by the following calculation:

Σ[(Market value of the investment)/(market value of the combined selected accounts)]×(percentage weighting of the security type)

This information/data is utilized by the Application to generate the diagram and table illustrated in FIGS. 9A and 9B in a manner known to a person skilled in the art.

By selecting the EQUITY STYLE BUTTON 246 the user is presented with the Equity Style screen as illustrated in FIG. 9C. In the screen window 20, the screen name “Equity Style”, along with the client name is presented. This screen is used to help analyze the types or styles of equity investments that are held in the selected accounts, there being two main styles “Market Capitalization” style and “Management or Equity Style”, and within the Market Capitalization style, there are three sub-styles namely, “small”, “medium”, and “large”, and within the Management or Equity style, there are also three sub styles, namely “value”, “blend” and “growth”. The user may obtain a definition of these styles by selecting/activating the definition icon 281 next to the relevant term, whereupon a definition window 287 will be opened and the Application's definition of the terminology will be provided, as illustrated in FIG. 9C1, the window being closed by the user activating/selecting the close button 289. Referring to FIG. 9C, the user is presented with a table, in which the rows 283 labeled “large”, “medium”, and “small” represent Market Capitalization and the columns 285 represent labeled “value”, “blend” and “growth” represent Equity Style, so that, for example, in the example illustrated in FIG. 9C, 32.33% 282 of the investors investments have been identified by the Application to be medium capitalization investments with a blended equity style. Additionally, a “Market Capitalization” window 266 is presented in which an assessment of the investor's selected investments in relation to Market Capitalization is provided in accordance with the previously discussed sub-styles namely, “small”, “medium”, and “large” 268 along with the percentage 270 of the investor's selected investments which fall within that style. Additionally, a “Equity Style” window 272 is presented in which an assessment of the investor's selected investments in relation to Equity Style is provided in accordance with the previously discussed sub-styles namely “value”, “blend” and “growth along with the percentage of the investor's selected investments which fall within that style. A “Not Reported” window 276 is also presented in which the percentage of the investor's selected investments which are not reported is provided. Utilizing the drop down menu 264, the user may select those investments which are to be subject to the analysis provided on this screen.

The information displayed in the “Equity Style” screen is obtained by the Application in the following manner: using the data provided by the XML of FIG. 3A such as illustrated at 1024, the following calculations are performed by the Application:
For large capitalization:

(ΣMarket value of the investments biased to large capitalization)/(total market value of the account)
This calculation gives the percentage weighting of the market capitalization weighted to large capitalization.
Corresponding calculations are performed by the Application for medium capitalization and small capitalization.
This information is used to generate the data shown in table 266 of FIG. 9C and Figure
In the case of Management of Equity Style:
For value:

(ΣMarket value of the investments biased to value)/(total market value of the account)
This calculation gives the percentage weighting of the investments to value.
Corresponding calculations are performed for growth and blend.
This information is used to generate the data shown in table 272 of FIG. 9C and FIG. 9C1.
Additionally, the following calculation is performed:

(Σ(market values of the investments biased toward large cap and value)/(market value of the account)
This calculation gives the percentage weighting of the investments biased toward large cap and value.
Corresponding calculations are performed for each of the eight other combinations of capitalization and equity style.
This information is used to generate the data shown in table 280 of FIG. 9C and FIG. 9C1.
In the event that there is no bias reported for the investment, a “Not Reported” category would be assigned to that assessment and its calculation is reported in the box 276.

If the user selects more than one account using the drop down window 264, the Application performs the following additional calculations:
For large capitalization:

(ΣMarket value of the investments biased to large capitalization)/(total market value of the combined accounts selected)
This calculation gives the percentage weighting of the market capitalization weighted to large capitalization.
Corresponding calculations are performed by the Application for medium capitalization and small capitalization.
This information is used to generate the data shown in table 266 of FIG. 9C and FIG. 9D.
In the case of Management of Equity Style:
For value:

(ΣMarket value of the investments biased to value)/(total market value of the combined selected accounts)
This calculation gives the percentage weighting of the investments to value.
Corresponding calculations are performed for growth and blend.
This information is used to generate the data shown in table 272 of FIG. 9C and FIG. 9C1.
Additionally, the following calculation is performed:

(Σ(market values of the investments biased toward large cap and value)/(market value of the combined selected accounts)
This calculation gives the percentage weighting of the investments biased toward large cap and value.
Corresponding calculations are performed for each of the eight other combinations of capitalization and equity style.
This information is used to generate the data shown in table 280 of FIG. 9C and FIG. 9C1.

By selecting the FIXED INCOME STYLE button 248, the user is presented with the Fixed Income Style screen as illustrated in FIG. 9D. In the screen-name window 20, the screen name “Fixed Income Style”, along with the client name is presented. This screen is used to help analyze the types of fixed income investments held in the client's selected accounts, there being two main styles “Credit Quality” style and “Duration”, and within the Market Capitalization style, there are three sub-styles namely, “high”, “medium”, and “low”, and within the Duration style, there are also three sub styles, namely “short”, “medium” and “long”. The user may obtain a definition of these styles by selecting/activating the definition icon 301 or 303 next to the relevant term, whereupon a definition window 305 will be opened and the Application's definition of the terminology will be provided, as illustrated in FIG. 9D1, the window being closed by the user activating/selecting the close button 307. Utilizing the drop down menu 264, the user may select those investments which are to be subject to the analysis provided on this screen. Referring to FIG. 9D, the user is presented with a table, in which the rows 308 labeled “low”, “medium”, and “high” represent Credit Quality and the columns 302 labeled “short”, “medium” and “long” represent Duration, so that, for example, in the example illustrated in FIG. 9D, 0% 304 of the investors investments have been identified by the Application to be of medium duration and medium credit style. Additionally, a “Credit Quality” window 288 is presented in which an assessment of the investor's selected investments in relation to Credit Quality is provided in accordance with the previously discussed sub-styles namely, “low”, “medium”, and “high” 290 along with the percentage 292 of the investor's selected investments which fall within that style. Additionally, a “Duration” window 294 is presented in which an assessment of the investor's selected investments in relation to Duration is provided in accordance with the previously discussed sub-styles namely “short”, “medium” and “long” along with the percentage of the investor's selected investments which fall within that style. Utilizing the drop down menu 286, the user may select those investments which are to be subject to the analysis provided on this screen.

The information displayed in the “Fixed Income Style” screen is obtained by the Application in the following manner:

using the data provided by the XML of FIG. 3A such as illustrated at 1026, the following calculations are performed by the Application:
In the case of Credit Quality:
   For high credit quality:

(ΣMarket value of the investments biased to high credit quality)/(total market value of the account)
This calculation gives the percentage weighting of the credit quality biased to high quality credit.
Corresponding calculations are performed for medium and low credit quality.
This information is used to generate the data shown in table 288 of FIG. 9D.
In the case of Duration:
   For long term duration:

(ΣMarket value of the investments biased to long term duration)/(total market value of the account)
This calculation gives the percentage weighting of the investments to long term duration.
Corresponding calculations are performed for medium term and short term.
This information is used to generate the data shown in table 294 of FIG. 9D.
Additionally, the following calculation is performed:

(Σ(market values of the investments biased toward long term and high quality)/(market value of the account)
This calculation gives the percentage weighting of the investments biased toward long term and high quality.
Corresponding calculations are performed for each of the eight other combinations of quality and duration.
This information is used to generate the data shown in table 302 of FIG. 9D.
In the event that there is no bias reported for the investment, a “Not Reported” category would be assigned to that assessment and its calculation is reported in the box 298.

If the user selects more than one account using the drop down window 286, the Application performs the following additional calculations:
In the case of Credit Quality:
   For high credit quality:

(ΣMarket value of the investments biased to high credit quality)/(total market value of the combined selected accounts)
This calculation gives the percentage weighting of the credit quality biased to high quality credit.
Corresponding calculations are performed for medium and low credit quality.
This information is used to generate the data shown in table 288 of FIG. 9D.
In the case of Duration:
   For long term duration:

(ΣMarket value of the investments biased to long term duration)/(total market value of the combined selected accounts)
This calculation gives the percentage weighting of the investments to long term duration.
Corresponding calculations are performed for medium term and short term.
This information is used to generate the data shown in table 294 of FIG. 9D.
Additionally, the following calculation is performed:

(Σ(market values of the investments biased toward long term and high quality)/(market value of the selected combined accounts)
This calculation gives the percentage weighting of the investments biased toward long term and high quality.
Corresponding calculations are performed for each of the eight other combinations of quality and duration.
This information is used to generate the data shown in table 302 of FIG. 9D.
In the event that there is no bias reported for the investment, a “Not Reported” category would be assigned to that assessment and its calculation is reported in the box 298.

By selecting the “Fund Allocation” 250 button, the user is presented with the Fund Allocation screen as illustrated in FIG. 9E. In the screen-name window 20, the screen name “Fund Allocation”, along with the client name is presented. This screen is used to help analyze the investments held by category. A detail window 323 as illustrated in FIG. 9F is provided when the user's computer pointer passes over an element in the chart 324, and the corresponding entry in the legend is highlighted. Utilizing the drop down menu 310, the user may select those investments which are to be subject to the analysis provided on this screen.

The information displayed in the “Fund Allocation” screen is obtained by the Application in the following manner: in the preferred embodiment, in response to a query by the Application to a third party organization which has access to both the General Investment Database and the Client Investment Database (which in the case of the preferred embodiment, is the same third-party organization that stores and makes available to the Application data from the Client Investment Database), the third-party organization performs the calculation referred to above as follows:
For each fund type the following calculation is performed by the third party organization:

Σ[(Market value of the investment)/(market value of the account)]×(percentage weighting of the fund type)
This calculation gives the percentage weighting of each fund type in an account of the client and is provided to the application in the form of the XML of FIG. 3A as illustrated at 978 through 984. This information is used to generate the diagram and table shown in FIG. 9E and FIG. 9F in a manner known to a person skilled in art.

The user may select the accounts in respect of which the Fund Allocations are determined, in which case, the Application calculates the Fund Allocations for each fund type across the selected accounts by the following calculation:

Σ[(Market value of the investment)/(market value of the combined selected accounts)]×(percentage weighting of the fund type)

This information/data is utilized by the Application to generate the diagram and table illustrated in FIGS. 9E and 9F in a manner known to a person skilled in the art.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A method for the reporting of financial data comprising the steps of:
(a) receiving first data from a first data source which contains data relating to a least one investment;
(b) receiving second data from a second data source which contains data relating to at least one client transaction relating to the at least one investment;
(c) calculating at least one element of financial data utilizing first data and second data;
(d) reporting the calculated financial data.
